(19) United States
(12) Patent Application Publication
(10) Pub. No.: US 2017/0156388 A1
(43) Pub. Date: Jun. 8, 2017

(54) NUTRIENT DELIVERY SYSTEM

(71) Applicant: ABBOTT LABORATORIES, Abbott Park, IL (US)

(72) Inventors: CHRISTINE L. GALLARDO, New Albany, OH (US); GARY M. GORDON, Plain City, OH (US); PAUL W. JOHNS, Columbus, OH (US); GARY E. KATZ, Columbus, OH (US); SANDRA E. WEIDA, Delaware, OH (US)

(73) Assignee: ABBOTT LABORATORIES, Abbott Park, IL (US)

(21) Appl. No.: 15/327,594

(22) PCT Filed: Jul. 21, 2015
(86) PCT No.: PCT/US2015/041315

§ 371 Date: Jan. 19, 2017

Related U.S. Application Data
(60) Provisional application No. 62/026,959, filed on Jul. 21, 2014.

(51) Int. Cl. A23L 33/00; A23L 33/185; A23L 33/16; A23L 33/105; A23L 33/115

(52) U.S. Cl. CPC A23L 33/40; A23L 33/105; A23L 33/115; A23L 33/16; A23L 33/185; A23V 2002/00

(57) ABSTRACT

Disclosed herein is a nutrient delivery system. The nutrient delivery system includes a pod and a nutritional powder for use in providing a nutritional formula.

### CROSS-REFERENCE TO RELATED APPLICATIONS

This application claims the benefit of U.S. Provisional Patent Application No. 62/026,959, filed Jul. 21, 2014, the contents of which are herein fully incorporated by reference.

### TECHNICAL FIELD

The present invention relates to a nutrient delivery system for providing a nutritional formula and use of the same.

### BACKGROUND

Not all infants are in a position to receive human breast milk. It is therefore desirable to provide nutritional compositions, such as synthetic infant formulas, that can produce nutritional benefits in infants. Typical infant formulas are provided as packaged bulk powders, which a user must reconstitute by measuring out a specified amount of powder and adding it to an appropriate volume of liquid with shaking. This can lead to inconsistent amounts of both powder and liquid being used, and can lead to significant air being introduced into the formula when it is shaken. Furthermore, an infant formula is typically heated prior to consumption by the infant. However, heating infant formula through traditional methods can lead to deactivation of essential nutrients and vitamins. In addition, constant temperature monitoring is required to ensure that the infant formula is at the ideal temperature for easy consumption by the infant, leading to potential delays in providing an infant with formula in a timely manner.

To address the above concerns, it would be beneficial to provide nutritional compositions in an inexpensive and convenient manner, with all of the desirable nutrient deliverables at a proper temperature, and yet to provide the parent or caretaker a decrease in time for preparation. One such system is a single-serving pod system that could provide single bottle infant formulas in minutes with the proper nutrients for the infant, at the proper temperature. Issues related to proper reconstitution of the powder, lack of appropriate mixing in the pod, ensuring water safety, and minimizing or eliminating growth of microorganisms are challenges for current single-use pod systems for any type of liquid deliverable such as coffee or other nutrient formulations. Another issue is the expense and environmental impact of these single-serving pod systems.

Accordingly, there is a need for a single use pod system for providing nutritional compositions, such as infant formulas, which addresses the issues outlined above.

### SUMMARY

The present invention is directed to a nutrient delivery system comprising (a) a pod and (b) an nutritional powder comprising (i) about 10 micrograms to about 2000 micrograms of one or more isoflavones per gram of the nutritional powder; (ii) about 1 milligram to about 1000 milligrams of one or more phytosterols per 100 gram of the nutritional powder; and (iii) about 0.0 milligrams to about 10.0 milligrams of one or more polyphenols per gram of the nutritional powder, wherein the nutrient delivery system provides a nutritional formula that delivers zinc, iron, or a combination thereof to an infant upon ingestion of the nutritional formula by the infant.

The present invention is also directed to a nutrient delivery system comprising (a) a pod and (b) an nutritional powder comprising (i) about 10 micrograms to about 2000 micrograms of one or more isoflavones per gram of the nutritional powder; (ii) about 1 milligram to about 1000 milligrams of one or more phytosterols per 100 gram of the nutritional powder; and (iii) about 0.0 milligrams to about 10.0 milligrams of one or more polyphenols per gram of the nutritional powder, wherein the nutrient delivery system provides a nutritional formula that delivers zinc, iron, or a combination thereof to an infant upon ingestion of the nutritional formula by the infant, and wherein the one or more isoflavones may be selected from the group consisting of: daidzein, daidzin, malonyl-daidzin, acetyl-daidzin, genistein, genistin, malonyl-genistein, glycitein, glycitin, malonyl-glycitin, acetyl-glycitin, and any combination thereof.

The present invention is also directed to a nutrient delivery system comprising (a) a pod and (b) an nutritional powder comprising (i) about 10 micrograms to about 2000 micrograms of one or more isoflavones per gram of the nutritional powder; (ii) about 1 milligram to about 1000 milligrams of one or more phytosterols per 100 gram of the nutritional powder; and (iii) about 0.0 milligrams to about 10.0 milligrams of one or more polyphenols per gram of the nutritional powder, wherein the nutrient delivery system provides a nutritional formula that delivers zinc, iron, or a combination thereof to an infant upon ingestion of the nutritional formula by the infant, wherein the one or more isoflavones may be selected from the group consisting of: daidzein, daidzin, malonyl-daidzin, acetyl-daidzin, genistein, genistin, malonyl-genistein, glycitein, glycitin, malonyl-glycitin, acetyl-glycitin, and any combination thereof, and wherein the one or more isoflavones may comprise about 5% to about 50% daidzein, about 1% to about 50% glycitein, about 10% to about 90% genistein, or any combination thereof.

The present invention is also directed to a nutrient delivery system comprising (a) a pod and (b) an nutritional powder comprising (i) about 10 micrograms to about 2000 micrograms of one or more isoflavones per gram of the nutritional powder; (ii) about 1 milligram to about 1000 milligrams of one or more phytosterols per 100 gram of the nutritional powder; and (iii) about 0.0 milligrams to about 10.0 milligrams of one or more polyphenols per gram of the nutritional powder, wherein the nutrient delivery system provides a nutritional formula that delivers zinc, iron, or a combination thereof to an infant upon ingestion of the nutritional formula by the infant, and wherein the one or more phytosterols may be selected from the group consisting of: β-sitosterol, campesterol, stigmasterol, brassicasterol, δ5-avenasterol, and any combination thereof.

The present invention is also directed to a nutrient delivery system comprising (a) a pod and (b) an nutritional powder comprising (i) about 10 micrograms to about 2000 micrograms of one or more isoflavones per gram of the nutritional powder; (ii) about 1 milligram to about 1000 milligrams of one or more phytosterols per 100 gram of the nutritional powder; and (iii) about 0.0 milligrams to about 10.0 milligrams of one or more polyphenols per gram of the nutritional powder, wherein the nutrient delivery system provides a nutritional formula that delivers zinc, iron, or a combination thereof to an infant upon ingestion of the nutritional formula by the infant, wherein the one or more phytosterols may be selected from the group consisting of: β-sitosterol, campesterol, stigmasterol, brassicasterol, δ5-avenasterol, and any combination thereof, and wherein the one or more phytosterols may comprise about 10% to about 80% β-sitosterol, about 5% to about 50% campesterol, about 5% to about 50% stigmasterol, about 1% to about 30% brassicasterol, about 1% to about 30% δ5-avenasterol, or any combination thereof.

The present invention is also directed to a nutrient delivery system comprising (a) a pod and (b) an nutritional powder comprising (i) about 10 micrograms to about 2000 micrograms of one or more isoflavones per gram of the nutritional powder; (ii) about 1 milligram to about 1000 milligrams of one or more phytosterols per 100 gram of the nutritional powder; and (iii) about 0.0 milligrams to about 10.0 milligrams of one or more polyphenols per gram of the nutritional powder, wherein the nutrient delivery system provides a nutritional formula that delivers zinc, iron, or a combination thereof to an infant upon ingestion of the nutritional formula by the infant, and wherein the one or more polyphenols may be selected from the group consisting of: soy protein isoflavones, cocoa powder polyphenols, green tea catechins, plum polyphenols, and any combination thereof.

The present invention is also directed to a nutrient delivery system comprising (a) a pod and (b) an nutritional powder comprising (i) about 10 micrograms to about 2000 micrograms of one or more isoflavones per gram of the nutritional powder; (ii) about 1 milligram to about 1000 milligrams of one or more phytosterols per 100 gram of the nutritional powder; and (iii) about 0.0 milligrams to about 10.0 milligrams of one or more polyphenols per gram of the nutritional powder, wherein the nutrient delivery system provides a nutritional formula that delivers zinc, iron, or a combination thereof to an infant upon ingestion of the nutritional formula by the infant, and wherein a source of the one or more isoflavones, one or more phytosterols, and one or more polyphenols may be protein selected from the group consisting of: pea protein, soy protein, rice protein, hemp protein, potato protein, and any combination thereof.

The present invention is also directed to a nutrient delivery system comprising (a) a pod and (b) an nutritional powder comprising (i) about 10 micrograms to about 2000 micrograms of one or more isoflavones per gram of the nutritional powder; (ii) about 1 milligram to about 1000 milligrams of one or more phytosterols per 100 gram of the nutritional powder; and (iii) about 0.0 milligrams to about 10.0 milligrams of one or more polyphenols per gram of the nutritional powder, wherein the nutrient delivery system provides a nutritional formula that delivers zinc, iron, or a combination thereof to an infant upon ingestion of the nutritional formula by the infant, wherein a source of the one or more isoflavones, one or more phytosterols, and one or more polyphenols may be protein selected from the group consisting of: pea protein, soy protein, rice protein, hemp protein, potato protein, and any combination thereof, and wherein the protein may be pea protein.

The present invention is also directed to a nutrient delivery system comprising (a) a pod and (b) an nutritional powder comprising (i) about 10 micrograms to about 2000 micrograms of one or more isoflavones per gram of the nutritional powder; (ii) about 1 milligram to about 1000 milligrams of one or more phytosterols per 100 gram of the nutritional powder; and (iii) about 0.0 milligrams to about 10.0 milligrams of one or more polyphenols per gram of the nutritional powder, wherein the nutrient delivery system provides a nutritional formula that delivers zinc, iron, or a combination thereof to an infant upon ingestion of the nutritional formula by the infant, wherein a source of the one or more isoflavones, one or more phytosterols, and one or more polyphenols may be protein selected from the group consisting of: pea protein, soy protein, rice protein, hemp protein, potato protein, and any combination thereof, and wherein the protein may be rice protein.

The present invention is also directed to a nutrient delivery system comprising (a) a pod and (b) an nutritional powder comprising (i) about 10 micrograms to about 2000 micrograms of one or more isoflavones per gram of the nutritional powder; (ii) about 1 milligram to about 1000 milligrams of one or more phytosterols per 100 gram of the nutritional powder; and (iii) about 0.0 milligrams to about 10.0 milligrams of one or more polyphenols per gram of the nutritional powder, wherein the nutrient delivery system provides a nutritional formula that delivers zinc, iron, or a combination thereof to an infant upon ingestion of the nutritional formula by the infant, wherein a source of the one or more isoflavones, one or more phytosterols, and one or more polyphenols may be protein selected from the group consisting of: pea protein, soy protein, rice protein, hemp protein, potato protein, and any combination thereof, and wherein the protein may be potato protein.

The present invention is also directed to a nutrient delivery system comprising (a) a pod and (b) an nutritional powder comprising (i) about 10 micrograms to about 2000 micrograms of one or more isoflavones per gram of the nutritional powder; (ii) about 1 milligram to about 1000 milligrams of one or more phytosterols per 100 gram of the nutritional powder; and (iii) about 0.0 milligrams to about 10.0 milligrams of one or more polyphenols per gram of the nutritional powder, wherein the nutrient delivery system provides a nutritional formula that delivers zinc, iron, or a combination thereof to an infant upon ingestion of the nutritional formula by the infant, wherein a source of the one or more isoflavones, one or more phytosterols, and one or more polyphenols may be protein selected from the group consisting of: pea protein, soy protein, rice protein, hemp protein, potato protein, and any combination thereof, and wherein the protein may be soy protein.

The present invention is also directed to a nutrient delivery system comprising (a) a pod and (b) an nutritional powder comprising (i) about 10 micrograms to about 2000 micrograms of one or more isoflavones per gram of the nutritional powder; (ii) about 1 milligram to about 1000 milligrams of one or more phytosterols per 100 gram of the nutritional powder; and (iii) about 0.0 milligrams to about 10.0 milligrams of one or more polyphenols per gram of the nutritional powder, wherein the nutrient delivery system provides a nutritional formula that delivers zinc, iron, or a combination thereof to an infant upon ingestion of the nutritional formula by the infant, wherein a source of the one or more isoflavones, one or more phytosterols, and one or more polyphenols may be protein selected from the group consisting of: pea protein, soy protein, rice protein, hemp protein, potato protein, and any combination thereof, and wherein the protein may be a hydrolysate, isolate, concentrate, or a combination thereof.

The present invention is also directed to a nutrient delivery system comprising (a) a pod and (b) an nutritional powder comprising (i) about 10 micrograms to about 2000 micrograms of one or more isoflavones per gram of the nutritional powder; (ii) about 1 milligram to about 1000 milligrams of one or more phytosterols per 100 gram of the nutritional powder; and (iii) about 0.0 milligrams to about 10.0 milligrams of one or more polyphenols per gram of the nutritional powder, wherein the nutrient delivery system provides a nutritional formula that delivers zinc, iron, or a combination thereof to an infant upon ingestion of the nutritional formula by the infant, wherein a source of the one or more isoflavones, one or more phytosterols, and one or more polyphenols may be protein selected from the group consisting of: pea protein, soy protein, rice protein, hemp protein, potato protein, and any combination thereof, and wherein the protein may be hydrolyzed.

The present invention is also directed to a nutrient delivery system comprising (a) a pod and (b) an nutritional powder comprising (i) about 10 micrograms to about 2000 micrograms of one or more isoflavones per gram of the nutritional powder; (ii) about 1 milligram to about 1000 milligrams of one or more phytosterols per 100 gram of the nutritional powder; and (iii) about 0.0 milligrams to about 10.0 milligrams of one or more polyphenols per gram of the nutritional powder, wherein the nutrient delivery system provides a nutritional formula that delivers zinc, iron, or a combination thereof to an infant upon ingestion of the nutritional formula by the infant, wherein a source of the one or more isoflavones, one or more phytosterols, and one or more polyphenols may be protein selected from the group consisting of: pea protein, soy protein, rice protein, hemp protein, potato protein, and any combination thereof, wherein the protein may be hydrolyzed, and wherein the protein may have a degree of hydrolysis (DH) of about 0 to about 60.

The present invention is also directed to a nutrient delivery system comprising (a) a pod and (b) an nutritional powder comprising (i) about 10 micrograms to about 2000 micrograms of one or more isoflavones per gram of the nutritional powder; (ii) about 1 milligram to about 1000 milligrams of one or more phytosterols per 100 gram of the nutritional powder; and (iii) about 0.0 milligrams to about 10.0 milligrams of one or more polyphenols per gram of the nutritional powder, wherein the nutrient delivery system provides a nutritional formula that delivers zinc, iron, or a combination thereof to an infant upon ingestion of the nutritional formula by the infant, wherein a source of the one or more isoflavones, one or more phytosterols, and one or more polyphenols may be protein selected from the group consisting of: pea protein, soy protein, rice protein, hemp protein, potato protein, and any combination thereof, wherein the protein may be pea protein, and wherein the nutritional formula may deliver about 1 mg/100 kcal to about 5 mg/100 kcal iron to the infant.

The present invention is also directed to a nutrient delivery system comprising (a) a pod and (b) an nutritional powder comprising (i) about 10 micrograms to about 2000 micrograms of one or more isoflavones per gram of the nutritional powder; (ii) about 1 milligram to about 1000 milligrams of one or more phytosterols per 100 gram of the nutritional powder; and (iii) about 0.0 milligrams to about 10.0 milligrams of one or more polyphenols per gram of the nutritional powder, wherein the nutrient delivery system provides a nutritional formula that delivers zinc, iron, or a combination thereof to an infant upon ingestion of the nutritional formula by the infant, wherein a source of the one or more isoflavones, one or more phytosterols, and one or more polyphenols may be protein selected from the group consisting of: pea protein, soy protein, rice protein, hemp protein, potato protein, and any combination thereof, wherein the protein may be rice protein, and wherein the nutritional formula may deliver about 0.5 mg/100 kcal to about 5 mg/100 kcal zinc to the infant.

The present invention is also directed to a nutrient delivery system comprising (a) a pod and (b) an nutritional powder comprising (i) about 10 micrograms to about 2000 micrograms of one or more isoflavones per gram of the nutritional powder; (ii) about 1 milligram to about 1000 milligrams of one or more phytosterols per 100 gram of the nutritional powder; and (iii) about 0.0 milligrams to about 10.0 milligrams of one or more polyphenols per gram of the nutritional powder, wherein the nutrient delivery system provides a nutritional formula that delivers zinc, iron, or a combination thereof to an infant upon ingestion of the nutritional formula by the infant, wherein a source of the one or more isoflavones, one or more phytosterols, and one or more polyphenols may be protein selected from the group consisting of: pea protein, soy protein, rice protein, hemp protein, potato protein, and any combination thereof, and wherein the source may further comprise an oil selected from the group consisting of: canola oil, soybean oil, vegetable oil, safflower oil, sunflower oil, palm oil, and any combination thereof.

The present invention is also directed to a nutrient delivery system comprising (a) a pod and (b) an nutritional powder comprising (i) about 10 micrograms to about 2000 micrograms of one or more isoflavones per gram of the nutritional powder; (ii) about 1 milligram to about 1000 milligrams of one or more phytosterols per 100 gram of the nutritional powder; and (iii) about 0.0 milligrams to about 10.0 milligrams of one or more polyphenols per gram of the nutritional powder, wherein the nutrient delivery system provides a nutritional formula that delivers zinc, iron, or a combination thereof to an infant upon ingestion of the nutritional formula by the infant, and wherein the nutritional powder may be prepared by spray drying or dry blending.

The present invention is also directed to a nutrient delivery system comprising (a) a pod and (b) an nutritional powder comprising (i) about 10 micrograms to about 2000 micrograms of one or more isoflavones per gram of the nutritional powder; (ii) about 1 milligram to about 1000 milligrams of one or more phytosterols per 100 gram of the nutritional powder; and (iii) about 0.0 milligrams to about 10.0 milligrams of one or more polyphenols per gram of the nutritional powder, wherein the nutrient delivery system provides a nutritional formula that delivers zinc, iron, or a combination thereof to an infant upon ingestion of the nutritional formula by the infant, and wherein the nutritional powder may be located within the pod.

The present invention is also directed to a nutrient delivery system comprising (a) a pod and (b) an nutritional powder comprising (i) about 10 micrograms to about 2000 micrograms of one or more isoflavones per gram of the nutritional powder; (ii) about 1 milligram to about 1000 milligrams of one or more phytosterols per 100 gram of the nutritional powder; and (iii) about 0.0 milligrams to about 10.0 milligrams of one or more polyphenols per gram of the nutritional powder, wherein the nutrient delivery system provides a nutritional formula that delivers zinc, iron, or a combination thereof to an infant upon ingestion of the nutritional formula by the infant, wherein the nutritional powder may be located within the pod, and wherein the nutritional powder may be located within the pod such that a headspace between the nutritional powder and a lid of the pod includes less than about 10% oxygen (O₂).

The present invention is also directed to a nutrient delivery system comprising (a) a pod and (b) an nutritional powder comprising (i) about 10 micrograms to about 2000 micrograms of one or more isoflavones per gram of the nutritional powder; (ii) about 1 milligram to about 1000 milligrams of one or more phytosterols per 100 gram of the nutritional powder; and (iii) about 0.0 milligrams to about 10.0 milligrams of one or more polyphenols per gram of the nutritional powder, wherein the nutrient delivery system provides a nutritional formula that delivers zinc, iron, or a combination thereof to an infant upon ingestion of the nutritional formula by the infant, and wherein the nutritional formula may be a synthetic formula for ingestion by the infant.

The present invention is also directed to a pod comprising (a) a container body and a lid; and (b) a nutritional powder comprising (i) about 1 wt. % to about 85 wt. % protein by weight of the nutritional powder, wherein the protein is selected from the group consisting of: pea protein, soy protein, rice protein, hemp protein, potato protein, and any combination thereof, wherein the nutritional powder and the lid define therebetween a headspace of the pod, and wherein the headspace includes less than about 10% oxygen (O₂).

The present invention is also directed to a pod comprising (a) a container body and a lid; and (b) a nutritional powder comprising (i) about 1 wt. % to about 85 wt. % protein by weight of the nutritional powder, wherein the protein is selected from the group consisting of: pea protein, soy protein, rice protein, hemp protein, potato protein, and any combination thereof, wherein the nutritional powder and the lid define therebetween a headspace of the pod, wherein the headspace includes less than about 10% oxygen (O₂), wherein the protein may be pea protein, and wherein the pea protein may bind about 1 mg to about 200 mg iron per gram pea protein.

The present invention is also directed to a pod comprising (a) a container body and a lid; and (b) a nutritional powder comprising (i) about 1 wt. % to about 85 wt. % protein by weight of the nutritional powder, wherein the protein is selected from the group consisting of: pea protein, soy protein, rice protein, hemp protein, potato protein, and any combination thereof, wherein the nutritional powder and the lid define therebetween a headspace of the pod, wherein the headspace includes less than about 10% oxygen (O₂), wherein the protein may be rice protein, and wherein the rice protein may bind about 1 mg to about 170 mg zinc per gram rice protein.

The present invention is also directed to a pod comprising (a) a container body and a lid; and (b) a nutritional powder comprising (i) about 1 wt. % to about 85 wt. % protein by weight of the nutritional powder, wherein the protein is selected from the group consisting of: pea protein, soy protein, rice protein, hemp protein, potato protein, and any combination thereof, wherein the nutritional powder and the lid define therebetween a headspace of the pod, wherein the headspace includes less than about 10% oxygen (O₂), and wherein the protein may be potato protein.

The present invention is also directed to a pod comprising (a) a container body and a lid; and (b) a nutritional powder comprising (i) about 1 wt. % to about 85 wt. % protein by weight of the nutritional powder, wherein the protein is selected from the group consisting of: pea protein, soy protein, rice protein, hemp protein, potato protein, and any combination thereof, wherein the nutritional powder and the lid define therebetween a headspace of the pod, wherein the headspace includes less than about 10% oxygen (O₂), and wherein the protein may be soy protein.

The present invention is also directed to a pod comprising (a) a container body and a lid; and (b) a nutritional powder comprising (i) about 1 wt. % to about 85 wt. % protein by weight of the nutritional powder, wherein the protein is selected from the group consisting of: pea protein, soy protein, rice protein, hemp protein, potato protein, and any combination thereof, wherein the nutritional powder and the lid define therebetween a headspace of the pod, wherein the headspace includes less than about 10% oxygen (O₂), and wherein the protein may be a source of one or more isoflavones, one or more phytosterols, one or more polyphenols, or any combination thereof.

The present invention is also directed to a pod comprising (a) a container body and a lid; and (b) a nutritional powder comprising (i) about 1 wt. % to about 85 wt. % protein by weight of the nutritional powder, wherein the protein is selected from the group consisting of: pea protein, soy protein, rice protein, hemp protein, potato protein, and any combination thereof, wherein the nutritional powder and the lid define therebetween a headspace of the pod, wherein the headspace includes less than about 10% oxygen (O₂), and wherein a portion of the protein may be hydrolyzed.

The present invention is also directed to a pod comprising (a) a container body and a lid; and (b) a nutritional powder comprising (i) about 1 wt. % to about 85 wt. % protein by weight of the nutritional powder, wherein the protein is selected from the group consisting of: pea protein, soy protein, rice protein, hemp protein, potato protein, and any combination thereof, wherein the nutritional powder and the lid define therebetween a headspace of the pod, wherein the headspace includes less than about 10% oxygen (O₂), wherein a portion of the protein may be hydrolyzed, and wherein the protein may have a degree of hydrolysis (DH) of about 0 to about 60.

The present invention is also directed to a pod comprising (a) a container body and a lid; and (b) a nutritional powder comprising (i) about 1 wt. % to about 85 wt. % protein by weight of the nutritional powder, wherein the protein is selected from the group consisting of: pea protein, soy protein, rice protein, hemp protein, potato protein, and any combination thereof, wherein the nutritional powder and the lid define therebetween a headspace of the pod, wherein the headspace includes less than about 10% oxygen (O₂), and wherein the nutritional powder may further comprise an oil selected from the group consisting of: canola oil, soybean oil, vegetable oil, safflower oil, sunflower oil, palm oil, and any combination thereof.

The present invention is also directed to a pod comprising (a) a container body and a lid; and (b) a nutritional powder comprising (i) about 1 wt. % to about 85 wt. % protein by weight of the nutritional powder, wherein the protein is selected from the group consisting of: pea protein, soy protein, rice protein, hemp protein, potato protein, and any combination thereof, wherein the nutritional powder and the lid define therebetween a headspace of the pod, wherein the headspace includes less than about 10% oxygen (O₂), wherein the container body may comprise a bottom wall and a side wall, and wherein the nutritional powder may be positioned within the pod such that the nutritional powder is fully enclosed by the bottom wall, side wall, and lid.

The present invention is also directed to a method for producing a synthetic formula for consumption by an infant, the method comprising: (A) providing a pod comprising (a) a container body and a lid; and (b) a nutritional powder comprising (i) about 1 wt. % to about 85 wt. % protein by weight of the nutritional powder, wherein the protein is selected from the group consisting of: pea protein, soy protein, rice protein, hemp protein, potato protein, and any combination thereof, wherein the nutritional powder and the lid define therebetween a headspace of the pod, and wherein the headspace includes less than about 10% oxygen (O₂); (B) introducing a fluid into the pod, thereby producing the synthetic formula; and (C) expelling the synthetic formula from the pod.

The present invention is also directed to a method for producing a synthetic formula for consumption by an infant, the method comprising: (A) providing a pod comprising (a) a container body and a lid; and (b) a nutritional powder comprising (i) about 1 wt. % to about 85 wt. % protein by weight of the nutritional powder, wherein the protein is selected from the group consisting of: pea protein, soy protein, rice protein, hemp protein, potato protein, and any combination thereof, wherein the nutritional powder and the lid define therebetween a headspace of the pod, and wherein the headspace includes less than about 10% oxygen (O₂); (B) introducing a fluid into the pod, thereby producing the synthetic formula; and (C) expelling the synthetic formula from the pod, wherein the fluid may comprise water.

### DETAILED DESCRIPTION

The present invention relates to a nutrient delivery system. The nutrient delivery system comprises a pod and a nutritional powder located within the pod. The pod includes a lid and together the lid and nutritional powder define therebetween a headspace of the pod. The headspace may include less than about 10% oxygen, thereby preventing oxidation of the nutritional powder and the presence of undesirable flavors, odors, and textures in a nutritional formula provided by the nutrient delivery system. In particular, the nutrient delivery system provides the nutritional formula when a fluid such as water is introduced into the pod to form a mixture of the fluid and nutritional powder and this mixture is expelled from the pod as the nutritional formula.

The nutritional powder includes protein. The protein may bind a mineral, for example, such as, but not limited to, zinc and iron, such that upon ingestion of the nutritional formula by the subject, the mineral is delivered to the subject. The protein may also lend the nutritional formula improved digestibility relative to a nutritional formula that does not contain the protein in the amounts as described below. In particular, digestibility may be improved when the protein has a degree of hydrolysis of about 0 to about 60. A degree of hydrolysis of about 0 to about 60 may also increase the solubility of the protein in the nutritional formula, which in turn, may increase the emulsion capacity of and mineral delivery by the nutritional formula. This degree of hydrolysis of about 0 to about 60 may not introduce detrimental features into the nutritional formula such as compromised sensory quality and decreased protein functionality.

Additionally, the protein may be a source of one or more isoflavones, one or more phytosterols, one or more polyphenols, or any combination thereof. The one or more isoflavones may provide antioxidant activity, cholesterol lowering activity, radical scavenging, and/or cytoprotection. The one or more phytosterols may reduce serum or plasma total cholesterol and/or low density lipoprotein (LDL) levels in the subject after ingestion and digestion of the nutritional formula by the subject. The one or more phytosterols may exhibit one or more anti-tumor properties in the subject after ingestion and digestion of the nutritional formula.

An additional source of the one or more isoflavones, the one or more phytosterols, and the one or more polyphenols may be a fat such as oil and thus, the nutritional powder may also include oil as described below in more detail.

### 1. DEFINITIONS

Unless otherwise defined, all technical and scientific terms used herein have the same meaning as commonly understood by one of ordinary skill in the art. In case of conflict, the present document, including definitions, will control. Preferred methods and materials are described below, although methods and materials similar or equivalent to those described herein can be used in practice or testing of the present invention. All publications, patent applications, patents and other references mentioned herein are incorporated by reference in their entirety. The materials, methods, and examples disclosed herein are illustrative only and not intended to be limiting.

The terms “comprise(s),” “include(s),” “having,” “has,” “can,” “contain(s),” and variants thereof, as used herein, are intended to be open-ended transitional phrases, terms, or words that do not preclude the possibility of additional acts or structures. The singular forms “a,” “and” and “the” include plural references unless the context clearly dictates otherwise. The present disclosure also contemplates other embodiments “comprising,” “consisting of” and “consisting essentially of,” the embodiments or elements presented herein, whether explicitly set forth or not.

The terms “adult formula” and “adult nutritional product” as used herein are used interchangeably to refer to nutritional compositions for generally maintaining or improving the health of an adult.

The terms “bioavailable” or “bioavailability” as used herein, unless otherwise specified, refer to the amount of a nutrient made available to target tissues in a subject through the systemic circulation in the subject's body. In this context, the terms “bioavailable” or “bioavailability” may specifically refer to the ability of a lipophilic nutrient, such as Vitamin D, to be absorbed from the gastrointestinal tract into lymph which will then enter into the bloodstream of an individual such that the substance can be absorbed into organs and tissues in the body. As the degree of bioavailability of a nutrient increases, the nutrient becomes more likely to enter into and remain in the bloodstream where it can be absorbed and used by the body. As the degree of bioavailability of a nutrient decreases, the nutrient becomes less likely to be absorbed into lymph from the gastrointestinal tract and instead is excreted from the body before entering the bloodstream.

The term “composition” as used herein, unless otherwise specified, refers to mixtures that are suitable for enteral administration to a subject. Compositions may be in the form of powders, solids, semi-solids, liquids, gels, and semi-liquids. Compositions may further comprise vitamins, minerals, and other ingredients.

The term “dry blended” as used herein, unless otherwise specified, refers to the mixing of dry or semi-dry components or ingredients to form a base powder, or to the addition of a dry, powdered or granulated component or ingredient to a base powder, to form a powdered composition.

The terms “enteral administration” or “enterally administering” as used herein refer to providing a composition that is ingested by the subject through the gastrointestinal tract, e.g., orally or through a feeding tube into the stomach. This is in contrast to parenteral administration, which occurs through means other than the gastrointestinal tract, e.g., intravenously.

The terms “fat,” “lipid,” and “oil” as used herein, unless otherwise specified, are used interchangeably to refer to lipid materials derived or processed from plants or animals. These terms also include synthetic lipid materials so long as such synthetic materials are suitable for administration to subjects as defined herein.

The term “fatty acids” as used herein refers generally to carboxylic acids with long lipophilic chains comprising carbon and hydrogen atoms. Specific fatty acids can be identified by counting the number of carbon atoms and determining other chemical properties, such as the presence and location of double bonds between the carbon atoms, any branching of carbon atoms off the main lipophilic chain, and the presence of other atomic species in the chain. Fatty acids may be described as “saturated” (no double bonds between the carbon atoms), “monounsaturated” (one double bond between the carbon atoms), or “polyunsaturated” (more than one double bond between the carbon atoms). For the purpose of this disclosure, “free fatty acids” refer to unbonded fatty acid molecules, while “fatty acid groups” refer to fatty acid moieties bonded to other molecules. For the purpose of this disclosure, fatty acid groups are preferably bonded to glycerol molecules to form glycerides. For the purpose of this disclosure, “fatty acids” refers to both free fatty acids and fatty acid groups in a composition, unless otherwise specified.

The term “glycerides” as used herein refer generally to lipophilic compounds comprising a glycerol molecule bonded to fatty acid groups. Monoglycerides are glycerol molecules bonded to a single fatty acid group; diglycerides are glycerol molecules bonded to two fatty acid groups; and triglycerides are glycerol molecules bonded to three fatty acid groups. Fats and oils comprise glycerides, and typical fats and oils from animal, fish, algae, vegetable, or seed sources are comprised primarily of triglycerides.

The term “human milk fortifier” as used herein, unless otherwise specified, refers to compositions suitable for mixing with breast milk or infant formula for consumption by an infant.

The term “infant,” as used herein, unless otherwise specified, refers to a human about 12 months of age or younger. The term “toddler,” as used herein, unless otherwise specified, refers to a human about 12 months of age to about 3 years of age. The term “child,” as used herein, unless otherwise specified, refers to a human about 3 years of age to about 18 years of age. The term “adult,” as used herein, unless otherwise specified, refers to a human about 18 years of age or older.

The terms “infant formula” or “infant nutritional product” as used herein are used interchangeably to refer to nutritional compositions that have the proper balance of macronutrients, micro-nutrients, and calories to provide sole or supplemental nourishment for and generally maintain or improve the health of infants, toddlers, or both. Infant formulas preferably comprise nutrients in accordance with the relevant infant formula guidelines for the targeted consumer or user population, an example of which would be the Infant Formula Act, 21 U.S.C. Section 350(a).

The term “lipophilic nutrient” as used herein refers to components that have greater solubility in organic solvents such as ethanol, methanol, ethyl ether, acetone, chloroform, benzene, or lipids than they have in water. Vitamin D is one example of a lipophilic nutrient. For the purpose of this disclosure, the term “lipophilic nutrient” may be applied to other lipophilic compounds, including, but not limited to, pharmaceutical compounds.

The term “liquid composition” as used herein refers to compositions in ready-to-consume liquid form or concentrated liquid form.

The terms “liquid nutritional composition” and “nutritional liquid” as used herein are used interchangeably to refer to nutritional products in ready-to-consume liquid form or concentrated liquid form.

The term “nutritional composition” as used herein, unless otherwise specified, refers to nutritional powders, solids, semi-solids, liquids, and semi-liquids that comprise at least one of protein, carbohydrate, and lipid, and are suitable for enteral administration to a subject. Nutritional compositions may further comprise vitamins, minerals, and other ingredients, and represent sole, primary, or supplemental sources of nutrition.

The term “nutritional formula” as used herein, unless otherwise specified, refers to nutritional compositions in ready-to-drink liquid form, concentrated form, and nutritional liquids made by reconstituting the nutritional powders described herein, wherein the powder can be completely dissolved, partially dissolved, mixed, suspended or any combination thereof, prior to use. The formula may be completely homogeneous or partially homogeneous, and may be a solution, a homogeneous suspension, an emulsion, a homogeneous dispersion, or any combination thereof.

The term “nutritional powder” as used herein, unless otherwise specified, refers to nutritional products in flowable or scoopable form that can be reconstituted with water or another aqueous liquid prior to consumption and includes both spray-dried, dry-mixed/dry-blended, and extruded powders.

The terms “pediatric formula” or “pediatric nutritional product,” as used herein, are used interchangeably to refer to nutritional compositions for generally maintaining or improving the health of infants and children.

The term “powder” as used herein describes a physical form of a composition, or portion thereof, that is a finely divided particulate solid that is flowable or scoopable.

The term “reconstitute” as used herein, unless otherwise specified, refers to a process in which a powder such as a nutritional powder is mixed with a liquid, such as water or another aqueous liquid to create a liquid composition that is essentially homogeneous. The reconstituted composition, such as a nutritional formula (e.g., an infant formula) may be completely homogeneous or partially homogeneous. The reconstituted composition may be a solution, a homogeneous suspension, an emulsion, a homogeneous dispersion, or any combination thereof.

The term “serving” as used herein, unless otherwise specified, is any amount of a composition that is intended to be ingested by a subject in one sitting or within less than about one hour. The size of a serving (i.e., “serving size”) may be different for diverse subjects, depending on one or more factors including, but not limited to, age, body mass, gender, species, or health. For a typical human adult, a serving size of the formulas disclosed herein is from about 25 mL to 1,000 mL. For a typical human infant or baby, a serving size of the formulas disclosed herein is from about 5 mL to about 250 mL.

The term “shelf life” as used herein, unless otherwise specified, refers to the time that a nutritional product such as a formula or powder remains commercially stable after being packaged and then stored at 18-30° C. (e.g., 18° C., 19° C., 20° C., 21° C., 22° C., 23° C., 24° C., 25° C., 26° C., 27° C., 28° C., 29° C., or 30° C.). A nutritional product may have a shelf life of at least 1 month, at least 3 months, at least 6 months, at least 12 months, at least 18 months, at least 24 months, or at least 36 months, including from about 1 month to about 36 months, 3 months to about 36 months, 6 months to about 36 months, 12 months to about 36 months, 18 months to about 36 months, 24 months to about 36 months, 1 month to about 24 months, 3 months to about 24 months, 6 months to about 24 months, 12 months to about 24 months, 18 months to about 24 months, 1 month to about 18 months, 3 months to about 18 months, 6 months to about 18 months, 12 months to about 18 months, 1 month to about 12 months, 3 months to about 12 months, 6 months to about 12 months, or up to 36 months.

The term “subject” as used herein refers to a mammal, including, but not limited to, a human (e.g., an infant, toddler, child or adult), a domesticated farm animal (e.g., cow, horse, or pig), or a pet (e.g., dog or cat), who ingests the composition.

“Total protein” and “total amount of protein” are used interchangeably in connection with the amount of protein in a protein system or a particular nutritional composition to mean all the protein in that system or composition.

To the extent that the terms “includes,” “including,” “contains,” or “containing” are used herein, they are intended to be inclusive in a manner similar to the term “comprising” as that term is interpreted when employed as a transitional word in a claim. Furthermore, to the extent that the term “or” is employed (e.g., A or B) it is intended to mean “A or B or both.” When the applicants intend to indicate “only A or B but not both” then the term “only A or B but not both” will be employed. Thus, use of the term “or” herein is the inclusive, and not the exclusive use. Also, to the extent that the terms “in” or “into” are used herein, they are intended to additionally mean “on” or “onto.”

All percentages, parts and ratios as used herein are by weight of the total product, unless specified otherwise. All such weights as they pertain to listed ingredients are based on the active ingredients and, therefore, do not include solvents or by-products that may be included in commercially available materials, unless specified otherwise.

All references to singular characteristics or limitations of the present disclosure shall include the corresponding plural characteristics or limitations, and vice versa, unless otherwise specified or clearly implied to the contrary by the context in which the reference is made.

All combinations of method or process steps as used herein can be performed in any order, unless otherwise specified or clearly implied to the contrary by the context in which the referenced combination is made.

The various embodiments of the powders and formulas of the present disclosure may include trace amounts of any optional or selected essential ingredient or feature described herein, provided that the remaining composition (e.g., powder or formula) still contains all of the required ingredients or features as described herein. In this context, and unless otherwise specified, the term “trace amount” means that the selected composition (e.g., powder or formula) contains no more than 2 wt % of the optional ingredient, typically less than 1 wt %, and also includes zero percent, of such optional or selected essential ingredient, by weight of the composition.

The various embodiments of the powders and formulas of the present disclosure may also be substantially free of any optional ingredient or feature described herein, provided that the remaining composition still contains all of the required ingredients or features as described herein. In this context, and unless otherwise specified, the term “substantially free” means that the selected composition contains less than a functional amount of the optional ingredient, typically less than about 1 wt %, including less than about 0.5 wt %, including less than about 0.1 wt %, and also including zero percent, of such optional ingredient, by weight of the composition.

The powders and formulas may comprise, consist of, or consist essentially of the required elements of the products as described herein, as well as any additional or optional element described herein or otherwise useful in product applications.

For the recitation of numeric ranges herein, each intervening number there between with the same degree of precision is explicitly contemplated. For example, for the range of 6-9, the numbers 7 and 8 are contemplated in addition to 6 and 9, and for the range 6.0-7.0, the number 6.0, 6.1, 6.2, 6.3, 6.4, 6.5, 6.6, 6.7, 6.8, 6.9, and 7.0 are explicitly contemplated.

### 2. NUTRIENT DELIVERY SYSTEM

Provided herein is a nutrient delivery system. This system includes a nutritional powder, and the system provides a nutritional formula for consumption. This nutritional formula may be ingested by an infant and thus, provides the infant nutrients needed for proper development and growth. The nutritional formula may also be ingested by a toddler or child, for proper delivery of nutrients for continued development and growth. The nutritional formula may also be ingested by an adult, as a nutritional supplement. The system also includes a pod, which contains the nutritional powder. The nutritional powder may be contained in the pod such that a headspace in the pod includes a maximum of about 10% O₂ (i.e., less than or equal to about 10% O₂), thereby reducing oxidation of the nutritional powder or formula and preventing the development of undesirable flavors, smells, and textures. Prior to ingestion of the nutritional formula, water is introduced into the pod to form a mixture of the water and the nutritional powder, ultimately providing the nutritional formula. The temperature of the water may be about 5° C. to 60° C., e.g., about 25° C. to about 50° C., to allow reconstitution of the nutritional powder to provide the nutritional formula. For example, the temperature of the water may be about 5° C., 6° C., 7° C., 8° C., 9° C., 10° C., 11° C., 12° C., 13° C., 14° C., 15° C., 16° C., 17° C., 18° C., 19° C., 20° C., 21° C., 22° C., 23° C., 24° C., 25° C., 26° C., 27° C., 28° C., 29° C., 30° C., 31° C., 32° C., 33° C., 34° C., 35° C., 36° C., 37° C., 38° C., 39° C., 40° C., 41° C., 42° C., 43° C., 44° C., 45° C., 46° C., 47° C., 48° C., 49° C., 50° C., 51° C., 52° C., 53° C., 54° C., 55° C., 56° C., 57° C., 58° C., 59° C., or 60° C. The resulting nutritional formula is then discharged from the pod into a container suitable for facilitating consumption of the nutritional formula by an individual (e.g., infant, toddler, child or adult).

a. Nutritional Powder

The nutrient delivery system may comprise a nutritional powder that is within a pod and delivers a nutritional formula. The nutritional powder includes compounds that affect the overall physical characteristics of the nutritional formula. The nutritional powder is sealed in the pod and is measured in an amount that provides the optimal nutritional formula when used in the nutrient delivery system. The physical characteristics that are important for the overall function of the nutritional powder include powder reconstitution characteristics (e.g., wettability), viscosity, foaming, emulsion stability, amino acid profile, mineral delivery, antioxidant capacity, shelf-life stability, odor, flavor, and digestibility.

The nutritional powder includes protein as described below in more detail. The protein may bind a mineral, for example, such as, but not limited to, zinc and iron, such that upon ingestion of the nutritional formula, which is described below in more detail, by the subject, the mineral is delivered to the subject. The protein may also lend the nutritional formula improved digestibility relative to a nutritional formula that does not contain the protein in the amounts described below. In particular, digestibility may be improved when the protein has a degree of hydrolysis of about 0 to about 60. A degree of hydrolysis of about 0 to about 60 may also increase the solubility of the protein in the nutritional formula, which in turn, may increase the emulsion capacity of and mineral delivery by the nutritional formula. This degree of hydrolysis of about 0 to about 60 may not introduce detrimental features into the nutritional formula such as compromised sensory quality and decreased protein functionality.

Additionally, as described below in more detail, the protein may be a source of one or more isoflavones, one or more phytosterols, one or more polyphenols, or any combination thereof. The one or more isoflavones may provide antioxidant activity, cholesterol lowering activity, radical scavenging, and/or cytoprotection. The one or more phytosterols may reduce serum or plasma total cholesterol and/or low density lipoprotein (LDL) levels in the subject after ingestion and digestion of the nutritional formula by the subject. The one or more phytosterols may exhibit one or more anti-tumor properties in the subject after ingestion and digestion of the nutritional formula.

As described below in more detail, an additional source of the one or more isoflavones, the one or more phytosterols, and the one or more polyphenols may be a fat such as oil and thus, the nutritional powder may also include oil as described below in more detail.

(1) Size and Shape

The nutritional powder may comprise a particle size distribution of about 1 μm to about 1000 μm. The particle size of the nutritional powder is a significant factor determining the wettability and flow properties of the nutritional formula. The nutritional powder mean particle size may be measured by particle size analysis techniques that include, but are not limited to, laser diffraction, sieve separation analysis and image analysis (e.g., using a microscopic method such as light microscopy or scanning electron microscopy). The nutritional powder mean particle size may be from about 1 μm to about 1000 μm, about 10 μm to about 700 μm, about 20 μm to about 600 μm, about 30 μm to about 500 μm, about 40 μm to about 400 μm, about 30 μm to about 300 μm, about 60 μm to about 200 μm, about 80 μm to about 200 μm, or about 100 μm to about 190 μm. The nutritional powder mean particle size may be about 1 μm, 5 μm, 10 μm, 20 μm, 30 μm, 40 μm, 50 μm, 60 μm, 70 μm, 80 μm, 90 μm, 100 μm, 110 μm, 120 μm, 130 μm, 140 μm, 150 μm, 160 μm, 170 μm, 180 μm, 190 μm, 200 μm, 225 μm, 250 μm, 275 μm, 300 μm, 325 μm, 350 μm, 375 μm, 400 μm, 425 μm, 450 μm, 475 μm, 500 μm, 525 μm, 550 μm, 575 μm, 600 μm, 625 μm, 650 μm, 675 μm, 700 μm, 725 μm, 750 μm, 775 μm, 800 μm, 825 μm, 850 μm, 875 μm, 900 μm, 925 μm, 950 μm, 975 μm, or 1000 μm.

The nutritional powder may comprise particles of variable shapes. The shape of the particles differs from size of the particles by describing the external boundaries and surface of the particles. The shape and size of the nutritional composition particles can be used together to better characterize the nutritional powder. The shape of the nutritional powder is important in determining the wettability and flow properties of the formula. The nutritional powder particle shape and/or distribution of particle shapes may be determined by laser diffraction, and image analysis (e.g., using a microscopic method such as light microscopy or scanning electron microscopy). For example, size shape and morphology may be ascertained using a Malvern Morphologi G3, or other similar equipment used within the art. Using the above techniques it may be possible to determine statistical numbers for surface roughness, solidity and/or ruggedness. The aspect ratio (length divided by width), circularity, convexity, elongation, high sensitivity (HS) circularity, solidity fiber elongation, and fiber straightness can also be determined. The shape of the nutritional powder may be, but is not limited to, sphere, cube, plate, flake, rod or thread, or any combination thereof. In some embodiments, the nutritional powder may include irregularly shaped particles.

The nutritional powder may comprise particles of an aspect ratio of about 0.1 to about 1.0. The aspect ratio is a value which can aid in the analyzing the particle shapes comprised within the nutritional powder. The aspect ratio of the nutritional powder particles can affect the wettability and flow properties of the formula. The nutritional powder particle aspect ratio may be determined by laser diffraction, and image analysis. For example, particle aspect ratio may be ascertained using a Malvern Morphologi G3, or other similar equipment used within the art. The particles of the nutritional powder may have an aspect ratio of about 0.01, 0.03, 0.05, 0.07, 0.09, 0.11, 0.13, 0.15, 0.17, 0.19, 0.21, 0.23, 0.25, 0.27, 0.29, 0.31, 0.33, 0.35, 0.37, 0.39, 0.41, 0.43, 0.45, 0.47, 0.49, 0.51, 0.53, 0.55, 0.57, 0.59, 0.61, 0.63, 0.65, 0.67, 0.69, 0.71, 0.73, 0.75, 0.77, 0.79, 0.81, 0.83, 0.85, 0.87, 0.89, 0.91, 0.93, 0.95, 0.97, 0.99, or 1.

(2) Density

The nutritional powder may comprise a loose bulk density of about 0.2 g/mL to about 1.0 g/mL. The loose bulk density of said powder quantifies the density of the powder without vibration. The loose bulk density may be examined by measuring the mass of a known volume of nutritional powder. The loose bulk density of the nutritional powder may be about 0.20 g/mL, 0.205 g/mL, 0.21 g/mL, 0.215 g/mL, 0.22 g/mL, 0.225 g/mL, 0.23 g/mL, 0.235 g/mL, 0.24 g/mL, 0.245 g/mL, 0.25 g/mL, 0.255 g/mL, 0.26 g/mL, 0.265 g/mL, 0.27 g/mL, 0.275 g/mL, 0.28 g/mL, 0.285 g/mL, 0.29 g/mL, 0.295 g/mL, 0.30 g/mL, 0.305 g/mL, 0.31 g/mL, 0.315 g/mL, 0.32 g/mL, 0.325 g/mL, 0.33 g/mL, 0.335 g/mL, 0.34 g/mL, 0.345 g/mL, 0.35 g/mL, 0.355 g/mL, 0.36 g/mL, 0.365 g/mL, 0.37 g/mL, 0.375 g/mL, 0.38 g/mL, 0.385 g/mL, 0.39 g/mL, 0.395 g/mL, 0.40 g/mL, 0.405 g/mL, 0.41 g/mL, 0.415 g/mL, 0.42 g/mL, 0.425 g/mL, 0.43 g/mL, 0.435 g/mL, 0.44 g/mL, 0.445 g/mL, 0.45 g/mL, 0.455 g/mL, 0.46 g/mL, 0.465 g/mL, 0.47 g/mL, 0.475 g/mL, 0.48 g/mL, 0.485 g/mL, 0.49 g/mL, 0.495 g/mL, 0.50 g/mL, 0.505 g/mL, 0.51 g/mL, 0.515 g/mL, 0.52 g/mL, 0.525 g/mL, 0.53 g/mL, 0.535 g/mL, 0.54 g/mL, 0.545 g/mL, 0.55 g/mL, 0.555 g/mL, 0.56 g/mL, 0.565 g/mL, 0.57 g/mL, 0.575 g/mL, 0.58 g/mL, 0.585 g/mL, 0.59 g/mL, 0.595 g/mL, 0.60 g/mL, 0.605 g/mL, 0.61 g/mL, 0.615 g/mL, 0.62 g/mL, 0.625 g/mL, 0.63 g/mL, 0.635 g/mL, 0.64 g/mL, 0.645 g/mL, 0.65 g/mL, 0.655 g/mL, 0.66 g/mL, 0.665 g/mL, 0.67 g/mL, 0.675 g/mL, 0.68 g/mL, 0.685 g/mL, 0.69 g/mL, 0.695 g/mL, 0.70 g/mL, 0.705 g/mL, 0.71 g/mL, 0.715 g/mL, 0.72 g/mL, 0.725 g/mL, 0.73 g/mL, 0.735 g/mL, 0.74 g/mL, 0.745 g/mL, 0.75 g/mL, 0.755 g/mL, 0.76 g/mL, 0.765 g/mL, 0.77 g/mL, 0.775 g/mL, 0.78 g/mL, 0.785 g/mL, 0.79 g/mL, 0.795 g/mL, 0.80 g/mL, 0.805 g/mL, 0.81 g/mL, 0.815 g/mL, 0.82 g/mL, 0.825 g/mL, 0.83 g/mL, 0.835 g/mL, 0.84 g/mL, 0.845 g/mL, 0.85 g/mL, 0.855 g/mL, 0.86 g/mL, 0.865 g/mL, 0.87 g/mL, 0.875 g/mL, 0.88 g/mL, 0.885 g/mL, 0.89 g/mL, 0.895 g/mL, 0.90 g/mL, 0.905 g/mL, 0.91 g/mL, 0.915 g/mL, 0.92 g/mL, 0.925 g/mL, 0.93 g/mL, 0.935 g/mL, 0.94 g/mL, 0.945 g/mL, 0.95 g/mL, 0.955 g/mL, 0.96 g/mL, 0.965 g/mL, 0.97 g/mL, 0.975 g/mL, 0.98 g/mL, 0.985 g/mL, 0.99 g/mL, 0.995 g/mL or 1.0 g/mL.

The nutritional powder may comprise a vibrated bulk density of 0.2 g/mL to 1.0 g/mL. The vibrated bulk density quantifies the density of a powder that has been subjected to vibration over a period of a time. The vibrated bulk density may be examined by measuring the mass of a known volume of nutritional powder, after undergoing at least once vibrational cycle. The vibrated bulk density of the nutritional powder may be about 0.20 g/mL, 0.205 g/mL, 0.21 g/mL, 0.215 g/mL, 0.22 g/mL, 0.225 g/mL, 0.23 g/mL, 0.235 g/mL, 0.24 g/mL, 0.245 g/mL, 0.25 g/mL, 0.255 g/mL, 0.26 g/mL, 0.265 g/mL, 0.27 g/mL, 0.275 g/mL, 0.28 g/mL, 0.285 g/mL, 0.29 g/mL, 0.295 g/mL, 0.30 g/mL, 0.305 g/mL, 0.31 g/mL, 0.315 g/mL, 0.32 g/mL, 0.325 g/mL, 0.33 g/mL, 0.335 g/mL, 0.34 g/mL, 0.345 g/mL, 0.35 g/mL, 0.355 g/mL, 0.36 g/mL, 0.365 g/mL, 0.37 g/mL, 0.375 g/mL, 0.38 g/mL, 0.385 g/mL, 0.39 g/mL, 0.395 g/mL, 0.40 g/mL, 0.405 g/mL, 0.41 g/mL, 0.415 g/mL, 0.42 g/mL, 0.425 g/mL, 0.43 g/mL, 0.435 g/mL, 0.44 g/mL, 0.445 g/mL, 0.45 g/mL, 0.455 g/mL, 0.46 g/mL, 0.465 g/mL, 0.47 g/mL, 0.475 g/mL, 0.48 g/mL, 0.485 g/mL, 0.49 g/mL, 0.495 g/mL, 0.50 g/mL, 0.505 g/mL, 0.51 g/mL, 0.515 g/mL, 0.52 g/mL, 0.525 g/mL, 0.53 g/mL, 0.535 g/mL, 0.54 g/mL, 0.545 g/mL, 0.55 g/mL, 0.555 g/mL, 0.56 g/mL, 0.565 g/mL, 0.57 g/mL, 0.575 g/mL, 0.58 g/mL, 0.585 g/mL, 0.59 g/mL, 0.595 g/mL, 0.60 g/mL, 0.605 g/mL, 0.61 g/mL, 0.615 g/mL, 0.62 g/mL, 0.625 g/mL, 0.63 g/mL, 0.635 g/mL, 0.64 g/mL, 0.645 g/mL, 0.65 g/mL, 0.655 g/mL, 0.66 g/mL, 0.665 g/mL, 0.67 g/mL, 0.675 g/mL, 0.68 g/mL, 0.685 g/mL, 0.69 g/mL, 0.695 g/mL, 0.70 g/mL, 0.705 g/mL, 0.71 g/mL, 0.715 g/mL, 0.72 g/mL, 0.725 g/mL, 0.73 g/mL, 0.735 g/mL, 0.74 g/mL, 0.745 g/mL, 0.75 g/mL, 0.755 g/mL, 0.76 g/mL, 0.765 g/mL, 0.77 g/mL, 0.775 g/mL, 0.78 g/mL, 0.785 g/mL, 0.79 g/mL, 0.795 g/mL, 0.80 g/mL, 0.805 g/mL, 0.81 g/mL, 0.815 g/mL, 0.82 g/mL, 0.825 g/mL, 0.83 g/mL, 0.835 g/mL, 0.84 g/mL, 0.845 g/mL, 0.85 g/mL, 0.855 g/mL, 0.86 g/mL, 0.865 g/mL, 0.87 g/mL, 0.875 g/mL, 0.88 g/mL, 0.885 g/mL, 0.89 g/mL, 0.895 g/mL, 0.90 g/mL, 0.905 g/mL, 0.91 g/mL, 0.915 g/mL, 0.92 g/mL, 0.925 g/mL, 0.93 g/mL, 0.935 g/mL, 0.94 g/mL, 0.945 g/mL, 0.95 g/mL, 0.955 g/mL, 0.96 g/mL, 0.965 g/mL, 0.97 g/mL, 0.975 g/mL, 0.98 g/mL, 0.985 g/mL, 0.99 g/mL, 0.995 g/mL, or 1.0 g/mL.

(3) Surface Area

The nutritional powder may comprise particles with a surface of about 0.02 m²/g to about 3.0 m²/g. The surface area of the particles within the nutritional powder is dependent on the size, shape and porosity of said particles, and is important in determining properties of the nutritional formula, such as dispersibility and rate of reconstitution. The particle porosity of the nutritional powder may be examined by the intrusion of a non-wetting liquid (e.g., mercury) at high pressure into the powder through the use of a porosimeter. The pore size can be determined based on the external pressure needed to force the liquid into a pore against the opposing force of the liquid's surface tension. The particles of the nutritional powder may have a surface area of about 0.02 m²/g, 0.04 m²/g, 0.06 m²/g, 0.08 m²/g, 0.10 m²/g, 0.15 m²/g, 0.20 m²/g, 0.25 m²/g, 0.30 m²/g, 0.35 m²/g, 0.40 m²/g, 0.45 m²/g, 0.50 m²/g, 0.55 m²/g, 0.60 m²/g, 0.65 m²/g, 0.70 m²/g, 0.75 m²/g, 0.80 m²/g, 0.85 m²/g, 0.90 m²/g, 0.95 m²/g, 1.0 m²/g, 1.05 m²/g, 1.1 m²/g, 1.15 m²/g, 1.2 m²/g, 1.25 m²/g, 1.3 m²/g, 1.35 m²/g, 1.4 m²/g, 1.45 m²/g, 1.5 m²/g, 1.55 m²/g, 1.6 m²/g, 1.65 m²/g, 1.7 m²/g, 1.75 m²/g, 1.8 m²/g, 1.85 m²/g, 1.9 m²/g, 1.95 m²/g, 2.0 m²/g, 2.05 m²/g, 2.1 m²/g, 2.15 m²/g, 2.2 m²/g, 2.25 m²/g, 2.3 m²/g, 2.35 m²/g, 2.4 m²/g, 2.45 m²/g, 2.5 m²/g, 2.55 m²/g, 2.6 m²/g, 2.65 m²/g, 2.7 m²/g, 2.75 m²/g, 2.8 m²/g, 2.85 m²/g, 2.9 m²/g, 2.95 m²/g, or 3.0 m²/g.

(4) Glass and Melt Transition Temperatures

The nutritional powder may comprise a glass transition temperature of about 30° C. to about 90° C. The glass transition temperature of the nutritional powder describes the liquification of said powder. Upon heating, the amorphous domain in a material will change from a glassy state to a rubbery state, while the crystalline domain will liquefy from a solid to a liquid. Glass transition analysis is useful as a comparison for a new product at standard moisture range. The glass transition temperature of a nutritional powder may be investigated via Differential Scanning calorimetry. The glass transition temperature of the nutritional powder may be about 30° C., 31° C., 32° C., 33° C., 34° C., 35° C., 36° C., 37° C., 38° C., 39° C., 40° C., 41° C., 42° C., 43° C., 44° C., 45° C., 46° C., 47° C., 48° C., 49° C., 50° C., 51° C., 52° C., 53° C., 54° C., 55° C., 56° C., 57° C., 58° C., 59° C., 60° C., 61° C., 62° C., 63° C., 64° C., 65° C., 66° C., 67° C., 68° C., 69° C., 70° C., 71° C., 72° C., 73° C., 74° C., 75° C., 76° C., 77° C., 78° C., 79° C., 80° C., 81° C., 82° C., 83° C., 84° C., 85° C., 86° C., 87° C., 88° C., 89° C., or 90° C.

The nutritional powder may comprise a melt transition temperature of about 40° C. to about 100° C. The melting temperature of the nutritional powder describes the liquification of said powder upon heating the powder, which has the ability to form crystalline domains, in a solid state to one in the fluid state. The nutritional powder may comprise a melting point when it is composed of solid fats versus liquid fats, which are more likely to instill some crystallinity within the powder. Melting temperature analysis is useful as a comparison for a new product at standard moisture range. The melting temperature of a nutritional powder may be investigated via Differential Scanning calorimetry. The melting temperature of the nutritional powder may be about 40° C., 41° C., 42° C., 43° C., 44° C., 45° C., 46° C., 47° C., 48° C., 49° C., 50° C., 51° C., 52° C., 53° C., 54° C., 55° C., 56° C., 57° C., 58° C., 59° C., 60° C., 61° C., 62° C., 63° C., 64° C., 65° C., 66° C., 67° C., 68° C., 69° C., 70° C., 71° C., 72° C., 73° C., 74° C., 75° C., 76° C., 77° C., 78° C., 79° C., 80° C., 81° C., 82° C., 83° C., 84° C., 85° C., 86° C., 87° C., 88° C., 89° C., 90° C., 91° C., 92° C., 93° C., 94° C., 95° C., 96° C., 97° C., 98° C., 99° C., or 100° C.

(5) Flowability

The nutritional powder may comprise a flow factor of about 1 to about 10. The flowability of the nutritional powder is important in determining flow properties of the nutritional formula, such as rate of reconstitution and dispersibility. The flowability of the nutritional powder is a function of the nutritional powder particle characteristics, as well as the compounds within the powder, and is a measurement of the cohesion property of the nutritional powder. Flowability may be measured by a Brookfield powder flow tester, and is reported as a value of the flow factor and flow index. Flow factor is defined as the ratio of major principal consolidating stress (y-axis) to unconfined failure strength (x-axis) to 10 kPa to x-axis. Flow index is the inverse of flow factor. The flow factor of the nutritional powder may be about 1 to 10 or 1 to 8; for example, the flow factor may be about 1, 1.1, 1.2, 1.3, 1.4, 1.5, 1.6, 1.7, 1.8, 1.9, 2, 2.1, 2.2, 2.3, 2.4, 2.5, 2.6, 2.7, 2.8, 2.9, 3, 3.1, 3.2, 3.3, 3.4, 3.5, 3.6, 3.7, 3.8, 3.9, 4, 4.1, 4.2, 4.3, 4.4, 4.5, 4.6, 4.7, 4.8, 4.9, 5, 5.1, 5.2, 5.3, 5.4, 5.5, 5.6, 5.7, 5.8, 5.9, 6, 6.1, 6.2, 6.3, 6.4, 6.5, 6.6, 6.7, 6.8, 6.9, 7, 7.1, 7.2, 7.3, 7.4, 7.5, 7.6, 7.7, 7.8, 7.9, 8, 8.1, 8.2, 8.3, 8.4, 8.5, 8.6, 8.7, 8.8, 8.9, 9, 9.1, 9.2, 9.3, 9.4, 9.5, 9.6, 9.7, 9.8, 9.9, or 10.

(6) Particle Porosity

The nutritional powder may comprise a particle porosity of about 5% to about 80%. The porosity of nutritional powder particles is important in determining the wettability and flow properties of the composition. The porosity of the nutritional powder particles may be measured by determining the volume of the open pores and interstitial void divided by the envelope powder volume, providing values in units of percent (from 0-100%). For example, the porosity of the nutritional powder particles may be about 5 to 80%, about 10% to about 80%, about 15% to about 80%, about 20% to about 80%, about 25% to about 80%, about 30% to about 80%, about 35% to about 80%, or about 40% to about 75%. The porosity of the nutritional powder particles may be about 5%, 6%, 7%, 8%, 9%, 10%, 11%, 12%, 13%, 14%, 15%, 16%, 17%, 18%, 19%, 20%, 21%, 22%, 23%, 24%, 25%, 26%, 27%, 28%, 29%, 30%, 31%, 32%, 33%, 34%, 35%, 36%, 37%, 38%, 39%, 40%, 41%, 42%, 43%, 44%, 45%, 46%, 47%, 48%, 49%, 50%, 51%, 52%, 53%, 54%, 55%, 56%, 57%, 58%, 59%, 60%, 61%, 62%, 63%, 64%, 65%, 66%, 67%, 68%, 69%, 70%, 71%, 72%, 73%, 74%, 75%, 76%, 77%, 78%, 79%, or 80%.

(7) Wettability

The nutritional powder may comprise a wettability of about 1 second to about 180 seconds, or about 1 second to about 30 seconds. The wettability of the nutritional powder is important on the overall flow performance of the nutritional formula through the nutrient delivery system. The wettability of the nutritional powder may be measured indirectly by adding a powder to the surface of water in a container (e.g., a beaker) and recording the time it takes for the powder to fall below the surface. The wettability may be about 1 second to about 20 seconds, or about 2 seconds to about 10 seconds. For example, the wettability may be about 1, 2, 3, 4, 5, 6, 7, 8, 9, 10, 11, 12, 13, 14, 15, 16, 17, 18, 19, 20, 21, 22, 23, 24, 25, 26, 27, 28, 29, 30, 31, 32, 33, 34, 35, 36, 37, 38, 39, 40, 41, 42, 43, 44, 45, 46, 47, 48, 49, 50, 51, 52, 53, 54, 55, 56, 57, 58, 59, 60, 61, 62, 63, 64, 65, 66, 67, 68, 69, 70, 71, 72, 73, 74, 75, 76, 77, 78, 79, 80, 81, 82, 83, 84, 85, 86, 87, 88, 89, 90, 91, 92, 93, 94, 95, 96, 97, 98, 99, 100, 101, 102, 103, 104, 105, 106, 107, 108, 109, 110, 111, 112, 113, 114, 115, 116, 117, 118, 119, or 120 seconds.

(8) Free Fat

The nutritional powder may comprise free fat of about 0.1 g/100 g powder to about 12 g/100 g powder. High levels of free fat in the nutritional powder can be detrimental to the flowability of the powder, and potentially lead to difficulties in providing the nutritional formula. The free fat within the nutritional powder may be determined by performing a hexane (or other suitable non-polar solvents, for example, petroleum ether) extraction, followed by filtration (e.g., Whatman No. 41 filter paper) of the solvent extract (to remove suspended powder particles), drying oven evaporation of the solvent from the filtrate (e.g., at 60° C. for 2 hours) and weighing of the non-volatile residue (i.e., the extracted free fat) from the filtrate. The nutritional powder may comprise a free fat of about 0.1 g/100 g powder, 0.3 g/100 g powder, 0.5 g/100 g powder, 0.7 g/100 g powder, 0.9 g/100 g powder, 1.1 g/100 g powder, 1.3 g/100 g powder, 1.5 g/100 g powder, 1.7 g/100 g powder, 1.9 g/100 g powder, 2.1 g/100 g powder, 2.3 g/100 g powder, 2.5 g/100 g powder, 2.7 g/100 g powder, 2.9 g/100 g powder, 3.1 g/100 g powder, 3.3 g/100 g powder, 3.5 g/100 g powder, 3.7 g/100 g powder, 3.9 g/100 g powder, 4.1 g/100 g powder, 4.3 g/100 g powder, 4.5 g/100 g powder, 4.7 g/100 g powder, 4.9 g/100 g powder, 5.1 g/100 g powder, 5.3 g/100 g powder, 5.5 g/100 g powder, 5.7 g/100 g powder, 5.9 g/100 g powder, 6.1 g/100 g powder, 6.3 g/100 g powder, 6.5 g/100 g powder, 6.7 g/100 g powder, 6.9 g/100 g powder, 7.1 g/100 g powder, 7.3 g/100 g powder, 7.5 g/100 g powder, 7.7 g/100 g powder, 7.9 g/100 g powder, 8.1 g/100 g powder, 8.3 g/100 g powder, 8.5 g/100 g powder, 8.7 g/100 g powder, 8.9 g/100 g powder, 9.1 g/100 g powder, 9.3 g/100 g powder, 9.5 g/100 g powder, 9.7 g/100 g powder, 9.9 g/100 g powder, 10.1 g/100 g powder, 10.3 g/100 g powder, 10.5 g/100 g powder, 10.7 g/100 g powder, 10.9 g/100 g powder, 11.1 g/100 g powder, 11.3 g/100 g powder, 11.5 g/100 g powder, 11.7 g/100 g powder, 11.9 g/100 g powder, 12.1 g/100 g powder, 12.3 g/100 g powder, 12.5 g/100 g powder, 12.7 g/100 g powder, 12.9 g/100 g powder, 13.1 g/100 g powder, 13.3 g/100 g powder, 13.5 g/100 g powder, 13.7 g/100 g powder, 13.9 g/100 g powder, 14.1 g/100 g powder, 14.3 g/100 g powder, 14.5 g/100 g powder, 14.7 g/100 g powder, 14.9 g/100 g powder, or 15 g/100 g powder.

(9) Reconstitution

The nutritional powder may comprise a percent of reconstitution of about 75% to about 100%. The percent of reconstitution is important in determining the flow characteristics of the formula through the nutrient delivery system. The percent of reconstitution of the nutritional powder is dependent on properties of the nutritional powder such as, powder particle size, porosity and shape. The percent of reconstitution of the nutritional powder may be examined by measuring the percentage of the nutritional powder that is reconstituted when contacted by the liquid (e.g., does not remain in the pod following contact with the liquid, but is incorporated into the nutritional formula). The percent of reconstitution may be about 75%, 76%, 77%, 78%, 79%, 80%, 81%, 82%, 83%, 84%, 85%, 86%, 87%, 88%, 89%, 90%, 91%, 92%, 93%, 94%, 95%, 96%, 97%, 98%, 99%, or 100%.

The nutritional powder may be reconstituted in an amount of time from about 10 seconds to about 5 minutes. The reconstitution time is the time it takes for the 75% to 100% of the powder to be reconstituted to provide the nutritional formula, by the nutrient delivery system as described above. The reconstitution time is important in determining the flow characteristics of the formula through the nutrient delivery system. The reconstitution time is dependent on properties of the nutritional powder such as, powder particle size, porosity and shape. The reconstitution time may be determined by examining aliquots of the nutritional formula as it is produced by the nutrient delivery system (e.g., at intervals of time such as about every 5 seconds or about every 10 seconds), and calculating the total solids delivered over time using the interval samples. The reconstitution time may be about 10 seconds, 15 seconds, 20 seconds, 25 seconds, 30 seconds, 35 seconds, 40 seconds, 45 seconds, 50 seconds, 55 seconds, 1 minute, 1.5 minutes, 2 minutes, 2.5 minutes, 3 minutes, 3.5 minutes, 4 minutes, 4.5 minutes, 5 minutes, 5.5 minutes, 6 minutes, 6.5 minutes, 7 minutes, 7.5 minutes, 8 minutes, 8.5 minutes, 9 minutes, 9.5 minutes, or 10 minutes.

Techniques used in the analysis of reconstitution may vary in regards to temperatures and pressures used to remove the liquid. The liquid may be removed at temperatures of about 20° C., 22° C., 24° C., 26° C., 28° C., 30° C., 32° C., 34° C., 36° C., 38° C., 40° C., 42° C., 44° C., 46° C., 48° C., 50° C., 52° C., 54° C., 56° C., 58° C., 60° C., 62° C., 64° C., 66° C., 68° C., 70° C., 72° C., 74° C., 76° C., 78° C., 80° C., 82° C., 84° C., 86° C., 88° C., 90° C., 92° C., 94° C., 96° C., 98° C., 100° C., 102° C., 104° C., 106° C., 108° C., or 110° C. The pressure may be lowered by techniques known within the art, such as a vacuum pump. Pressures that may be used to remove the liquid in the analysis of reconstitution may be about 1 mbar, 10 mbar, 20 mbar, 40 mbar, 60 mbar, 80 mbar, 100 mbar, 120 mbar, 140 mbar, 160 mbar, 180 mbar, 200 mbar, 220 mbar, 240 mbar, 260 mbar, 280 mbar, 300 mbar, 320 mbar, 340 mbar, 360 mbar, 380 mbar, 400 mbar, 420 mbar, 440 mbar, 460 mbar, 480 mbar, 500 mbar, 520 mbar, 540 mbar, 560 mbar, 580 mbar, 600 mbar, 620 mbar, 640 mbar, 660 mbar, 680 mbar, 700 mbar, 720 mbar, 740 mbar, 760 mbar, 780 mbar, 800 mbar, 820 mbar, 840 mbar, 860 mbar, 880 mbar, 900 mbar, 920 mbar, 940 mbar, 960 mbar, 980 mbar, 1.0 bar, 1.5 bar, 2.0 bar, 2.5 bar, 3.0 bar, 3.5 bar, 4.0 bar, 4.5 bar, 5.0 bar, 5.5 bar, 6.0 bar, 6.5 bar, 7.0 bar, 7.5 bar, 8.0 bar, 8.5 bar, 9.0 bar, 10 bar, 10.5 bar, 11 bar, 11.5 bar, 12 bar, 12.5 bar, 13 bar, 13.5 bar, 14 bar, 14.5 bar or 15 bar.

(10) Color Scale Values

The nutritional powder may comprise a Hunter Lab “L” value between about 20 and about 100. The Hunter Lab “L” value is a measurement of the lightness of the formula. The lightness of the nutritional powder is dependent on, but not limited to, the wettability, emulsion stability, and emulsion homogeneity. The Hunter Lab “L” value of the nutritional powder can be measured by a spectrophotometer, which allows quantitative measurement of the reflection or transmission properties of the powder as a function of wavelength. The Hunter Lab “L” value of the nutritional powder may be about 20.00, 25.00, 30.00, 35.00, 40.00, 45.00, 50.00, 55.00, 60.00, 65.00, 70.00, 75.00, 80.00, 80.10, 80.15, 80.20, 80.25, 80.30, 80.35, 80.40, 80.45, 80.50, 80.55, 80.60, 80.65, 80.70, 80.75, 80.80, 80.85, 80.90, 80.95, 81.00, 81.10, 81.15, 81.20, 81.25, 81.30, 81.35, 81.40, 81.45, 81.50, 81.55, 81.60, 81.65, 81.70, 81.75, 81.80, 81.85, 81.90, 81.95, 82.00, 82.10, 82.15, 82.20, 82.25, 82.30, 82.35, 82.40, 82.45, 82.50, 82.55, 82.60, 82.65, 82.70, 82.75, 82.80, 82.85, 82.90, 82.95, 83.00, 83.10, 83.15, 83.20, 83.25, 83.30, 83.35, 83.40, 83.45, 83.50, 83.55, 83.60, 83.65, 83.70, 83.75, 83.80, 83.85, 83.90, 83.95, 84.00, 86.00, 88.00, 90.00, 95.00 or 100.00.

The nutritional powder may comprise a Hunter Lab “a” value between about −5.00 and about 1.00. The Hunter Lab “a” value is a measurement of the color-opponent dimension of a formula. The “a” value of the nutritional powder is dependent on, but not limited to, the wettability, emulsion stability, and emulsion homogeneity. The Hunter Lab “a” value of the nutritional powder can be measured by a spectrophotometer, which allows quantitative measurement of the reflection or transmission properties of the powder as a function of wavelength. The Hunter Lab “a” value of the nutritional powder may be about −5.00, −4.50, −4.00, −3.50, −3.00, −2.50, −2.00, −1.50, −1.00, −0.50, −0.10, −0.09, −0.08, −0.07, −0.06, −0.05, −0.04, −0.03, −0.02, −0.01, 0, 0.01, 0.02, 0.03, 0.04, 0.05, 0.06, 0.07, 0.08, 0.09, 0.10, 0.11, 0.12, 0.13, 0.14, 0.15, 0.16, 0.17, 0.18, 0.19, 0.20, 0.22, 0.24, 0.26, 0.28, 0.3, 0.35, 0.40, 0.45, 0.50, 0.55, 0.60, 0.65, 0.70, 0.75, 0.80, 0.85, 0.90, or 1.00.

The nutritional powder may comprise a Hunter Lab “b” value between about 1 and about 30. The Hunter Lab “b” value is a measurement of the color-opponent dimension of a formula. The “b” value of the nutritional powder is dependent on, but not limited to, the wettability, emulsion stability, and emulsion homogeneity. The Hunter Lab “b” value of the nutritional powder can be measured by a spectrophotometer, which allows quantitative measurement of the reflection or transmission properties of the powder as a function of wavelength. The Hunter Lab “b” value of the nutritional powder may be about 1.00, 2.00, 3.00, 4.00, 5.00, 6.00, 7.00, 8.00, 9.00, 10.00, 11.00, 12.00, 13.00, 13.10, 13.20, 13.30, 13.31, 13.32, 13.33, 13.34, 13.35, 13.36, 13.37, 13.38, 13.39, 13.40, 13.41, 13.42, 13.43, 13.44, 13.45, 13.46, 13.47, 13.48, 13.49, 13.50, 13.51, 13.52, 13.53, 13.54, 13.55, 13.56, 13.57, 13.58, 13.59, 13.60, 13.61, 13.62, 13.63, 13.64, 13.65, 13.66, 13.67, 13.68, 13.69, 13.70, 13.71, 13.72, 13.73, 13.74, 13.75, 13.76, 13.77, 13.78, 13.79, 13.80, 13.81, 13.82, 13.83, 13.84, 13.85, 13.86, 13.87, 13.88, 13.89, 13.90, 13.91, 13.92, 13.93, 13.94, 13.95, 13.96, 13.97, 13.98, 13.99, 14.00, 15.00, 16.00, 17.00, 18.00, 19.00, 20.00, 25.00, or 30.00.

(11) Macronutrients

Nutritional powders (e.g., infant nutritional powders) according to the present disclosure may comprise one or more macronutrients selected from the group of fat, protein, carbohydrate, and mixtures thereof. Generally, any source of fat, carbohydrate, or protein that is suitable for use in nutritional products is also suitable for use herein, provided that such macronutrients are also compatible with the essential elements of the nutritional powders, nutritional formulas and nutrient delivery systems as defined herein.

Although total concentrations or amounts of fat, protein, and carbohydrates may vary depending upon the nutritional needs of the subject, such concentrations or amounts most typically fall within one of the following embodied ranges, inclusive of any other essential fat, protein, and or carbohydrate ingredients as described herein.

Ranges for carbohydrates, fats, and proteins, in those embodiments where the nutritional powder is formulated to provide an infant formula, based on percent of calories of the nutritional powder, are set forth in Table 1. Note: each numerical value in Table 1 is preceded by the term “about.”

TABLE 1

| | Embodiment | Embodiment | Embodiment | Embodiment |
|---|---|---|---|---|
| | A | B | C | D |
| Macronutrient | (% Calories) | (% Calories) | (% Calories) | (% Calories) |
| Carbohydrate | 1-85 | 30-75 | 35-65 | 30-50 |
| Fat | 5-70 | 20-60 | 25-50 | 40-60 |
| Protein | 2-75 | 5-50 | 7-40 | 5-15 |

Additional ranges for carbohydrates, fats, and proteins, in those embodiments where the nutritional powder is formulated to provide an adult formula, based on percent of calories of the nutritional powder, are set forth in Table 2. Note: each numerical value in Table 2 is preceded by the term “about.”

TABLE 2

| | Embodiment A | Embodiment B | Embodiment C |
|---|---|---|---|
| Macronutrient | (% Calories) | (% Calories) | (% Calories) |
| Protein | 1-98 | 5-80 | 15-55 |
| Carbohydrate | 1-98 | 0-75 | 20-50 |
| Fat | 1-98 | 20-70 | 25-40 |

For example, in some embodiments, the nutritional powder may include: about 30%, 31%, 32%, 33%, 34%, 35%, 36%, 37%, 38%, 39%, 40%, 41%, 42%, 43%, 44%, 45%, 46%, 47%, 48%, 49%, 50%, 51%, 52%, 53%, 54%, 55%, 56%, 57%, 58%, 59%, 60%, 61%, 62%, 63%, 64%, 65%, 66%, 67%, 68%, 69% or 70% carbohydrate as a percentage of total calories; about 40%, 41%, 42%, 43%, 44%, 45%, 46%, 47%, 48%, 49%, 50%, 51%, 52%, 53%, 54%, 55%, 56%, 57%, 58%, 59%, 60%, 61%, 62%, 63%, 64%, 65%, 66%, 67%, 68%, 69%, 70%, 71%, 72%, 73%, 74%, 75%, 76%, 77%, 78%, 79% or 80% fat as a percentage of total calories; and about 5%, 6%, 7%, 8%, 9%, 10%, 11%, 12%, 13%, 14% or 15% protein as a percentage of total calories.

Additional ranges of amounts for carbohydrates, fats, and proteins are also described below in more detail.

(a) Protein

The nutritional powder includes protein. The nutritional powder may include protein in an amount of about 1 wt % to about 85 wt %, about 1 wt % to about 80 wt %, about 1 wt % to about 75 wt %, about 1 wt % to about 70 wt %, about 1 wt % to about 65 wt %, about 1 wt % to about 60 wt %, about 1 wt % to about 55 wt %, about 1 wt % to about 50 wt %, about 1 wt % to about 45 wt %, about 1 wt % to about 40 wt %, about 1 wt % to about 35 wt %, about 1 wt % to about 30 wt %, about 5 wt % to about 85 wt %, about 10 wt % to about 85 wt %, about 15 wt % to about 85 wt %, about 20 wt % to about 85 wt %, about 25 wt % to about 85 wt %, about 30 wt % to about 85 wt %, about 35 wt % to about 85 wt %, about 40 wt % to about 85 wt %, about 45 wt % to about 85 wt %, about 50 wt % to about 85 wt %, about 5 wt % to about 40 wt %, about 5 wt % to about 50 wt %, about 7 wt % to about 30 wt %, about 7 wt % to about 32 wt %, about 8 wt % to about 30 wt %, about 8 wt % to about 20 wt %, about 8 wt % to about 19 wt %, about 8 wt % to about 18 wt %, about 8 wt % to about 17 wt %, about 8 wt % to about 16 wt %, about 8 wt % to about 15 wt %, about 8 wt % to about 14 wt %, about 8 wt % to about 13 wt %, about 8 wt % to about 12 wt %, about 8 wt % to about 11 wt %, about 8 wt % to about 10 wt %, about 8 wt % to about 9 wt %, about 9 wt % to about 20 wt %, about 10 wt % to about 20 wt %, about 11 wt % to about 20 wt %, about 12 wt % to about 20 wt %, about 13 wt % to about 20 wt %, about 14 wt % to about 20 wt %, about 15 wt % to about 20 wt %, about 16 wt % to about 20 wt %, about 17 wt % to about 20 wt %, about 18 wt % to about 20 wt %, about 19 wt % to about 20 wt %, about 9 wt % to about 19 wt %, about 10 wt % to about 18 wt %, about 11 wt % to about 17 wt %, about 12 wt % to about 16 wt %, about 13 wt % to about 15 wt %, about 8 wt % to about 30 wt %, about 8 wt % to about 20 wt %, or 1 wt %, 2 wt %, 3 wt %, 4 wt %, 5 wt %, 6 wt %, 7 wt %, 8 wt %, 9 wt %, 10 wt %, 11 wt %, 12 wt %, 13 wt %, 14 wt %, 15 wt %, 16 wt %, 17 wt %, 18 wt %, 19 wt %, 20 wt %, 21 wt %, 22 wt %, 23 wt %, 24 wt %, 25 wt %, 26 wt %, 27 wt %, 28 wt %, 29 wt %, 30 wt %, 31 wt %, 32 wt %, 33 wt %, 34 wt %, 35 wt %, 36 wt %, 37 wt %, 38 wt %, 39 wt %, 40 wt %, 41 wt %, 42 wt %, 43 wt %, 44 wt %, 45 wt %, 46 wt %, 47 wt %, 48 wt %, 49 wt %, 50 wt %, 51 wt %, 52 wt %, 53 wt %, 54 wt %, 55 wt %, 56 wt %, 57 wt %, 58 wt %, 59 wt %, 60 wt %, 61 wt %, 62 wt %, 63 wt %, 64 wt %, 65 wt %, 66 wt %, 67 wt %, 68 wt %, 69 wt %, 70 wt %, 71 wt %, 72 wt %, 73 wt %, 74 wt %, 75 wt %, 76 wt %, 77 wt %, 78 wt %, 79 wt %, 80 wt %, 81 wt %, 82 wt %, 83 wt %, 84 wt %, or 85 wt %, by weight of the nutritional powders.

The protein may include one or more of animal protein (e.g., meat, fish), milk protein (e.g., casein, whey protein), cereal protein (e.g., rice, corn), vegetable protein (e.g., soy, rice, pea, potato), or any combination thereof. The protein may include one or more of whey protein, acid caseins, sodium caseinates, calcium caseinates, potassium caseinates, casein, milk protein, nonfat dry milk, condensed skim milk, soy protein, pea protein, collagen protein, potato protein, rice protein, hemp protein, fungal protein, protein expressed by microorganisms, lentil protein, black bean protein, spirulina protein, wheat protein, corn protein, chickpea protein, sesame protein, sunflower protein, canola protein, peanut protein, algal protein, lupine protein, and combinations thereof. In other embodiments, the protein may include pea protein, rice protein, potato protein, hemp protein, soy protein, or any combination thereof, each of which is described below in more detail.

In still other embodiments, the protein may be a combination of milk protein (e.g., casein and whey protein) and soy protein. The protein may be a combination of milk protein and partially hydrolyzed soy protein. Partial hydrolysis is described below in more detail. In other embodiments, the protein may be a combination of about 80%, 81%, 82%, 83%, 84%, 85%, 86%, 87%, 88%, 89%, 90%, 91%, 92%, 93%, 94%, or 95% milk protein and about 20%, 19%, 18%, 17%, 16%, 15%, 14%, 13%, 12%, 11%, 10%, 9%, 8%, 7%, 6%, or 5%, respectively, soy protein. In still other embodiments, the protein may be a combination of about 80%, 81%, 82%, 83%, 84%, 85%, 86%, 87%, 88%, 89%, 90%, 91%, 92%, 93%, 94%, or 95% casein and about 20%, 19%, 18%, 17%, 16%, 15%, 14%, 13%, 12%, 11%, 10%, 9%, 8%, 7%, 6%, or 5%, respectively, soy protein. In other embodiments, the protein may be a combination of about 80%, 81%, 82%, 83%, 84%, 85%, 86%, 87%, 88%, 89%, 90%, 91%, 92%, 93%, 94%, or 95% whey protein and about 20%, 19%, 18%, 17%, 16%, 15%, 14%, 13%, 12%, 11%, 10%, 9%, 8%, 7%, 6%, or 5%, respectively, soy protein.

The protein may bind a mineral, for example, but not limited to, zinc and iron. Accordingly, the protein may facilitate delivery of the mineral to the subject upon formation and subsequent ingestion of the nutritional formula by the subject. The protein may be present in the nutritional powder in any amount that allows the subject to make effective use of the mineral (e.g., zinc and iron) upon ingestion and digestion of the nutritional formula, which is described below in more detail. Effective use may include, but is not limited to, promoting uptake of the mineral by the subject.

In some embodiments, the protein may a protein that binds iron (e.g., pea protein), a protein that binds zinc (e.g., rice protein), or a combination of the protein that binds iron (e.g., pea protein) and the protein that binds zinc (e.g., rice protein). The protein may be pea protein, and thus, promotes the uptake of iron by the subject upon ingestion and digestion of the nutritional formula, which is described below in more detail, by the subject. The protein may be pea protein, and thus, facilitates delivery of iron to the subject upon formation and subsequent ingestion of the nutritional formula by the subject. The protein may be rice protein, and thus, promotes the uptake of zinc by the subject upon ingestion and digestion of the nutritional formula by the subject. The protein may be rice protein, and thus, facilitates delivery of zinc to the subject upon formation and subsequent ingestion of the nutritional formula by the subject. The protein may be a combination of pea protein and rice protein, and thus, promotes the uptake of iron and zinc by the subject upon ingestion and digestion of the nutritional formula by the subject. The protein may be a combination of pea protein and rice protein, and thus, facilitates delivery of iron and zinc to the subject upon formation and subsequent ingestion of the nutritional formula by the subject.

The protein may be a source of the one or more isoflavones, the one or more phytosterols, the one or more polyphenols, or any combination thereof. The one or more isoflavones, the one or more phytosterols, and the one or more polyphenols are described below in more detail.

The protein may also be a source of amino acids. The protein may be a source of essential amino acids. The protein may be a complete source of essential amino acids. The protein may be a source of amino acids such that essential amino acids do not need to be added individually to the nutritional powder. The protein may meet all of the requirements of the Food and Agriculture Organization (FAO), the Food and Nutrition Board (FNB), and/or the World Health Organization (WHO) in connection with the minimum amounts of indispensable amino acids for the subject. The protein may further be a source of one or more free amino acids that are antioxidants (e.g., tryptophan, cysteine, cystine, lysine, lysine acetate, histidine, tyrosine, valine, leucine, isoleucine, methionine, norleucine, phenylalanine, arginine, threonine, glutamic acid, proline, ornithine, aspartic acid, and serine).

The protein may be in the form of a hydrolysate, an isolate, a concentrate, or any combination thereof. In some embodiments, the protein may not be hydrolyzed (i.e., the protein is intact). In other embodiments, the protein may be hydrolyzed, for example, partially hydrolyzed. In still other embodiments, the protein may be a combination of intact protein (i.e., not hydrolyzed) and partially hydrolyzed protein.

As described in more detail below, modification (e.g., hydrolysis) of the protein may increase the solubility of the protein in the nutritional formula. The emulsion capacity of, the digestibility of, and the mineral delivery by the nutritional formula may increase with protein solubility. However, with increased hydrolysis, protein functionality and/or sensory qualities of the nutritional powder and/or nutritional formula are diminished, and therefore, as described in more detail below, a balance may be struck between these favorable and unfavorable features when hydrolyzing the protein.

### (a) Pea Protein

The nutritional powder may include pea protein. The pea protein may be a source of amino acids such that essential amino acids do not need to be added individually to the nutritional powder. The pea protein may be intact pea protein or may be provided in a partially hydrolyzed form as described above. The pea protein may bind iron, thereby facilitating delivery of iron to the subject upon formation and subsequent ingestion of the nutritional formula. The pea protein may bind about 1 mg to about 200 mg iron per gram of pea protein such that the nutritional formula, which is described below in more detail, may deliver about 1 mg/100 kcal to about 5 mg/100 kcal iron to the subject.

In some embodiments, the pea protein may bind about 0.1 mg to about 200.0 mg, about 0.2 mg to about 200.0 mg, about 0.3 mg to about 200.0 mg, about 0.4 mg to about 200.0 mg, about 0.5 mg to about 200.0 mg, about 0.6 mg to about 200.0 mg, about 0.7 mg to about 200.0 mg, about 0.8 mg to about 200.0 mg, about 0.9 mg to about 200.0 mg, about 1.0 mg to about 200.0 mg, about 2.0 mg to about 200.0 mg, about 3.0 mg to about 200.0 mg, about 4.0 mg to about 200.0 mg, about 5.0 mg to about 200.0 mg, about 6.0 mg to about 200.0 mg, about 7.0 mg to about 200.0 mg, about 8.0 mg to about 200.0 mg, about 9.0 mg to about 200.0 mg, about 10.0 mg to about 200.0 mg, about 15.0 mg to about 200.0 mg, about 20.0 mg to about 200.0 mg, about 25.0 mg to about 200.0 mg, about 30.0 mg to about 200.0 mg, about 35.0 mg to about 200.0 mg, about 40.0 mg to about 200.0 mg, about 45.0 mg to about 200.0 mg, about 50.0 mg to about 200.0 mg, about 55.0 mg to about 200.0 mg, about 60.0 mg to about 200.0 mg, about 65.0 mg to about 200.0 mg, about 70.0 mg to about 200.0 mg, about 75.0 mg to about 200.0 mg, about 80.0 mg to about 200.0 mg, about 85.0 mg to about 200.0 mg, about 90.0 mg to about 200.0 mg, about 95.0 mg to about 200.0 mg, about 100.0 mg to about 200.0 mg, about 105.0 mg to about 200.0 mg, about 110.0 mg to about 200.0 mg, about 115.0 mg to about 200.0 mg, about 120.0 mg to about 200.0 mg, about 125.0 mg to about 200.0 mg, about 130.0 mg to about 200.0 mg, about 135.0 mg to about 200.0 mg, about 140.0 mg to about 200.0 mg, about 145.0 mg to about 200.0 mg, about 150.0 mg to about 200.0 mg, about 155.0 mg to about 200.0 mg, about 160.0 mg to about 200.0 mg, about 165.0 mg to about 200.0 mg, about 170.0 mg to about 200.0 mg, about 175.0 mg to about 200.0 mg, about 180.0 mg to about 200.0 mg, about 185.0 mg to about 200.0 mg, about 190.0 mg to about 200.0 mg, about 0.1 mg to about 195.0 mg, about 0.1 mg to about 190.0 mg, about 0.1 mg to about 185.0 mg, about 0.1 mg to about 180.0 mg, about 0.1 mg to about 175.0 mg, about 0.1 mg to about 170.0 mg, about 0.1 mg to about 165.0 mg, about 0.1 mg to about 160.0 mg, about 0.1 mg to about 155.0 mg, about 0.1 mg to about 150.0 mg, about 0.1 mg to about 145.0 mg, about 0.1 mg to about 140.0 mg, about 0.1 mg to about 135.0 mg, about 0.1 mg to about 130.0 mg, about 0.1 mg to about 125.0 mg, about 0.1 mg to about 120.0 mg, about 0.1 mg to about 115.0 mg, about 0.1 mg to about 110.0 mg, about 0.1 mg to about 105.0 mg, about 0.1 mg to about 100.0 mg, about 0.1 mg to about 95.0 mg, about 0.1 mg to about 90.0 mg, about 0.1 mg to about 85.0 mg, about 0.1 mg to about 80.0 mg, about 0.1 mg to about 75.0 mg, about 0.1 mg to about 70.0 mg, about 0.1 mg to about 65.0 mg, about 0.1 mg to about 60.0 mg, about 0.1 mg to about 55.0 mg, about 0.1 mg to about 50.0 mg, about 0.1 mg to about 45.0 mg, about 0.1 mg to about 40.0 mg, about 0.1 mg to about 35.0 mg, about 0.1 mg to about 30.0 mg, about 0.1 mg to about 25.0 mg, about 0.1 mg to about 20.0 mg, about 0.1 mg to about 15.0 mg, about 0.1 mg to about 10.0 mg, about 0.1 mg to about 9.0 mg, about 0.1 mg to about 8.0 mg, about 0.1 mg to about 7.0 mg, about 0.1 mg to about 6.0 mg, about 0.1 mg to about 5.0 mg, about 0.1 mg to about 4.0 mg, about 0.1 mg to about 3.0 mg, about 0.1 mg to about 2.0 mg, about 0.1 mg to about 1.0 mg, about 0.1 mg to about 0.9 mg, about 0.5 mg to about 190.0 mg, about 1.0 mg to about 180.0 mg, about 5.0 mg to about 170.0 mg, about 10.0 mg to about 160.0 mg, about 20.0 mg to about 150.0 mg, about 30.0 mg to about 140.0 mg, about 40.0 mg to about 130.0 mg, about 50.0 mg to about 120.0 mg, about 60.0 mg to about 110.0 mg, or about 70.0 mg to about 100.0 mg, or about 0.1 mg, about 0.2 mg, about 0.3 mg, about 0.4 mg, about 0.5 mg, about 0.6 mg, about 0.7 mg, about 0.8 mg, about 0.9 mg, about 1.0 mg, about 2.0 mg, about 3.0 mg, about 4.0 mg, about 5.0 mg, about 6.0 mg, about 7.0 mg, about 8.0 mg, about 9.0 mg, about 10.0 mg, about 15.0 mg, about 20.0 mg, about 25.0 mg, about 30.0 mg, about 35.0 mg, about 40.0 mg, about 45.0 mg, about 50.0 mg, about 55.0 mg, about 60.0 mg, about 65.0 mg, about 70.0 mg, about 75.0 mg, about 80.0 mg, about 85.0 mg, about 90.0 mg, about 95.0 mg, about 100.0 mg, about 105.0 mg, about 110.0 mg, about 115.0 mg, about 120.0 mg, about 125.0 mg, about 130.0 mg, about 135.0 mg, about 140.0 mg, about 145.0 mg, about 150.0 mg, about 155.0 mg, about 160.0 mg, about 165.0 mg, about 170.0 mg, about 175.0 mg, about 180.0 mg, about 185.0 mg, about 190.0 mg, about 195.0 mg, or about 200.0 mg iron per gram of pea protein such that the nutritional formula may deliver about 0.1 mg/100 kcal to about 10.0 mg/100 kcal, about 0.2 mg/100 kcal to about 10.0 mg/100 kcal, 0.3 mg/100 kcal to about 10.0 mg/100 kcal, about 0.4 mg/100 kcal to about 10.0 mg/100 kcal, about 0.5 mg/100 kcal to about 10.0 mg/100 kcal, about 0.6 mg/100 kcal to about 10.0 mg/100 kcal, about 0.7 mg/100 kcal to about 10.0 mg/100 kcal, about 0.8 mg/100 kcal to about 10.0 mg/100 kcal, about 0.9 mg/100 kcal to about 10.0 mg/100 kcal, about 1.0 mg/100 kcal to about 10.0 mg/100 kcal, about 0.1 mg/100 kcal to about 9.5 mg/100 kcal, about 0.1 mg/100 kcal to about 9.0 mg/100 kcal, about 0.1 mg/100 kcal to about 8.5 mg/100 kcal, about 0.1 mg/100 kcal to about 8.0 mg/100 kcal, about 0.1 mg/100 kcal to about 7.5 mg/100 kcal, about 0.1 mg/100 kcal to about 7.0 mg/100 kcal, about 0.1 mg/100 kcal to about 6.5 mg/100 kcal, about 0.1 mg/100 kcal to about 6.0 mg/100 kcal, about 0.1 mg/100 kcal to about 5.5 mg/100 kcal, about 0.1 mg/100 kcal to about 5.0 mg/100 kcal, about 0.1 mg/100 kcal to about 4.5 mg/100 kcal, about 0.1 mg/100 kcal to about 4.0 mg/100 kcal, about 0.1 mg/100 kcal to about 3.5 mg/100 kcal, about 0.1 mg/100 kcal to about 3.0 mg/100 kcal, about 0.1 mg/100 kcal to about 2.5 mg/100 kcal, about 0.1 mg/100 kcal to about 2.0 mg/100 kcal, about 0.1 mg/100 kcal to about 1.5 mg/100 kcal, about 0.1 mg/100 kcal to about 1.0 mg/100 kcal, about 0.2 mg/100 kcal to about 9.5 mg/100 kcal, about 0.3 mg/100 kcal to about 9.0 mg/100 kcal, about 0.4 mg/100 kcal to about 8.5 mg/100 kcal, about 0.5 mg/100 kcal to about 8.0 mg/100 kcal, about 0.6 mg/100 kcal to about 7.5 mg/100 kcal, about 0.7 mg/100 kcal to about 7.0 mg/100 kcal, about 0.8 mg/100 kcal to about 6.5 mg/100 kcal, about 0.9 mg/100 kcal to about 6.0 mg/100 kcal, or about 1.0 mg/100 kcal to about 5.0 mg/100 kcal or about 0.1 mg/100 kcal, about 0.2 mg/100 kcal, about 0.3 mg/100 kcal, about 0.4 mg/100 kcal, about 0.5 mg/100 kcal, about 0.6 mg/100 kcal, about 0.7 mg/100 kcal, about 0.8 mg/100 kcal, about 0.9 mg/100 kcal, about 1.0 mg/100 kcal, about 1.5 mg/100 kcal, about 2.0 mg/100 kcal, about 2.5 mg/100 kcal, about 3.0 mg/100 kcal, about 3.5 mg/100 kcal, about 4.0 mg/100 kcal, about 4.5 mg/100 kcal, about 5.0 mg/100 kcal, about 5.5 mg/100 kcal, about 6.0 mg/100 kcal, about 6.5 mg/100 kcal, about 7.0 mg/100 kcal, about 7.5 mg/100 kcal, about 8.0 mg/100 kcal, about 8.5 mg/100 kcal, about 9.0 mg/100 kcal, about 9.5 mg/100 kcal, or about 10.0 mg/100 kcal iron to the subject.

In other embodiments, the pea protein may bind about 0.1 mg to about 200.0 mg, about 0.2 mg to about 200.0 mg, about 0.3 mg to about 200.0 mg, about 0.4 mg to about 200.0 mg, about 0.5 mg to about 200.0 mg, about 0.6 mg to about 200.0 mg, about 0.7 mg to about 200.0 mg, about 0.8 mg to about 200.0 mg, about 0.9 mg to about 200.0 mg, about 1.0 mg to about 200.0 mg, about 2.0 mg to about 200.0 mg, about 3.0 mg to about 200.0 mg, about 4.0 mg to about 200.0 mg, about 5.0 mg to about 200.0 mg, about 6.0 mg to about 200.0 mg, about 7.0 mg to about 200.0 mg, about 8.0 mg to about 200.0 mg, about 9.0 mg to about 200.0 mg, about 10.0 mg to about 200.0 mg, about 15.0 mg to about 200.0 mg, about 20.0 mg to about 200.0 mg, about 25.0 mg to about 200.0 mg, about 30.0 mg to about 200.0 mg, about 35.0 mg to about 200.0 mg, about 40.0 mg to about 200.0 mg, about 45.0 mg to about 200.0 mg, about 50.0 mg to about 200.0 mg, about 55.0 mg to about 200.0 mg, about 60.0 mg to about 200.0 mg, about 65.0 mg to about 200.0 mg, about 70.0 mg to about 200.0 mg, about 75.0 mg to about 200.0 mg, about 80.0 mg to about 200.0 mg, about 85.0 mg to about 200.0 mg, about 90.0 mg to about 200.0 mg, about 95.0 mg to about 200.0 mg, about 100.0 mg to about 200.0 mg, about 105.0 mg to about 200.0 mg, about 110.0 mg to about 200.0 mg, about 115.0 mg to about 200.0 mg, about 120.0 mg to about 200.0 mg, about 125.0 mg to about 200.0 mg, about 130.0 mg to about 200.0 mg, about 135.0 mg to about 200.0 mg, about 140.0 mg to about 200.0 mg, about 145.0 mg to about 200.0 mg, about 150.0 mg to about 200.0 mg, about 155.0 mg to about 200.0 mg, about 160.0 mg to about 200.0 mg, about 165.0 mg to about 200.0 mg, about 170.0 mg to about 200.0 mg, about 175.0 mg to about 200.0 mg, about 180.0 mg to about 200.0 mg, about 185.0 mg to about 200.0 mg, about 190.0 mg to about 200.0 mg, about 0.1 mg to about 195.0 mg, about 0.1 mg to about 190.0 mg, about 0.1 mg to about 185.0 mg, about 0.1 mg to about 180.0 mg, about 0.1 mg to about 175.0 mg, about 0.1 mg to about 170.0 mg, about 0.1 mg to about 165.0 mg, about 0.1 mg to about 160.0 mg, about 0.1 mg to about 155.0 mg, about 0.1 mg to about 150.0 mg, about 0.1 mg to about 145.0 mg, about 0.1 mg to about 140.0 mg, about 0.1 mg to about 135.0 mg, about 0.1 mg to about 130.0 mg, about 0.1 mg to about 125.0 mg, about 0.1 mg to about 120.0 mg, about 0.1 mg to about 115.0 mg, about 0.1 mg to about 110.0 mg, about 0.1 mg to about 105.0 mg, about 0.1 mg to about 100.0 mg, about 0.1 mg to about 95.0 mg, about 0.1 mg to about 90.0 mg, about 0.1 mg to about 85.0 mg, about 0.1 mg to about 80.0 mg, about 0.1 mg to about 75.0 mg, about 0.1 mg to about 70.0 mg, about 0.1 mg to about 65.0 mg, about 0.1 mg to about 60.0 mg, about 0.1 mg to about 55.0 mg, about 0.1 mg to about 50.0 mg, about 0.1 mg to about 45.0 mg, about 0.1 mg to about 40.0 mg, about 0.1 mg to about 35.0 mg, about 0.1 mg to about 30.0 mg, about 0.1 mg to about 25.0 mg, about 0.1 mg to about 20.0 mg, about 0.1 mg to about 15.0 mg, about 0.1 mg to about 10.0 mg, about 0.1 mg to about 9.0 mg, about 0.1 mg to about 8.0 mg, about 0.1 mg to about 7.0 mg, about 0.1 mg to about 6.0 mg, about 0.1 mg to about 5.0 mg, about 0.1 mg to about 4.0 mg, about 0.1 mg to about 3.0 mg, about 0.1 mg to about 2.0 mg, about 0.1 mg to about 1.0 mg, about 0.1 mg to about 0.9 mg, about 0.5 mg to about 190.0 mg, about 1.0 mg to about 180.0 mg, about 5.0 mg to about 170.0 mg, about 10.0 mg to about 160.0 mg, about 20.0 mg to about 150.0 mg, about 30.0 mg to about 140.0 mg, about 40.0 mg to about 130.0 mg, about 50.0 mg to about 120.0 mg, about 60.0 mg to about 110.0 mg, or about 70.0 mg to about 100.0 mg, or about 0.1 mg, about 0.2 mg, about 0.3 mg, about 0.4 mg, about 0.5 mg, about 0.6 mg, about 0.7 mg, about 0.8 mg, about 0.9 mg, about 1.0 mg, about 2.0 mg, about 3.0 mg, about 4.0 mg, about 5.0 mg, about 6.0 mg, about 7.0 mg, about 8.0 mg, about 9.0 mg, about 10.0 mg, about 15.0 mg, about 20.0 mg, about 25.0 mg, about 30.0 mg, about 35.0 mg, about 40.0 mg, about 45.0 mg, about 50.0 mg, about 55.0 mg, about 60.0 mg, about 65.0 mg, about 70.0 mg, about 75.0 mg, about 80.0 mg, about 85.0 mg, about 90.0 mg, about 95.0 mg, about 100.0 mg, about 105.0 mg, about 110.0 mg, about 115.0 mg, about 120.0 mg, about 125.0 mg, about 130.0 mg, about 135.0 mg, about 140.0 mg, about 145.0 mg, about 150.0 mg, about 155.0 mg, about 160.0 mg, about 165.0 mg, about 170.0 mg, about 175.0 mg, about 180.0 mg, about 185.0 mg, about 190.0 mg, about 195.0 mg, or about 200.0 mg iron per gram of pea protein.

In still other embodiments, the nutritional formula, which is described below in more detail, may deliver about 0.1 mg/100 kcal to about 10.0 mg/100 kcal, about 0.2 mg/100 kcal to about 10.0 mg/100 kcal, 0.3 mg/100 kcal to about 10.0 mg/100 kcal, about 0.4 mg/100 kcal to about 10.0 mg/100 kcal, about 0.5 mg/100 kcal to about 10.0 mg/100 kcal, about 0.6 mg/100 kcal to about 10.0 mg/100 kcal, about 0.7 mg/100 kcal to about 10.0 mg/100 kcal, about 0.8 mg/100 kcal to about 10.0 mg/100 kcal, about 0.9 mg/100 kcal to about 10.0 mg/100 kcal, about 1.0 mg/100 kcal to about 10.0 mg/100 kcal, about 0.1 mg/100 kcal to about 9.5 mg/100 kcal, about 0.1 mg/100 kcal to about 9.0 mg/100 kcal, about 0.1 mg/100 kcal to about 8.5 mg/100 kcal, about 0.1 mg/100 kcal to about 8.0 mg/100 kcal, about 0.1 mg/100 kcal to about 7.5 mg/100 kcal, about 0.1 mg/100 kcal to about 7.0 mg/100 kcal, about 0.1 mg/100 kcal to about 6.5 mg/100 kcal, about 0.1 mg/100 kcal to about 6.0 mg/100 kcal, about 0.1 mg/100 kcal to about 5.5 mg/100 kcal, about 0.1 mg/100 kcal to about 5.0 mg/100 kcal, about 0.1 mg/100 kcal to about 4.5 mg/100 kcal, about 0.1 mg/100 kcal to about 4.0 mg/100 kcal, about 0.1 mg/100 kcal to about 3.5 mg/100 kcal, about 0.1 mg/100 kcal to about 3.0 mg/100 kcal, about 0.1 mg/100 kcal to about 2.5 mg/100 kcal, about 0.1 mg/100 kcal to about 2.0 mg/100 kcal, about 0.1 to about 1.5 mg/100 kcal, about 0.1 mg/100 kcal to about 1.0 mg/100 kcal, about 0.2 mg/100 kcal to about 9.5 mg/100 kcal, about 0.3 mg/100 kcal to about 9.0 mg/100 kcal, about 0.4 mg/100 kcal to about 8.5 mg/100 kcal, about 0.5 mg/100 kcal to about 8.0 mg/100 kcal, about 0.6 mg/100 kcal to about 7.5 mg/100 kcal, about 0.7 mg/100 kcal to about 7.0 mg/100 kcal, about 0.8 mg/100 kcal to about 6.5 mg/100 kcal, about 0.9 mg/100 kcal to about 6.0 mg/100 kcal, or about 1.0 mg/100 kcal to about 5.0 mg/100 kcal or about 0.1 mg/100 kcal, about 0.2 mg/100 kcal, about 0.3 mg/100 kcal, about 0.4 mg/100 kcal, about 0.5 mg/100 kcal, about 0.6 mg/100 kcal, about 0.7 mg/100 kcal, about 0.8 mg/100 kcal, about 0.9 mg/100 kcal, about 1.0 mg/100 kcal, about 1.5 mg/100 kcal, about 2.0 mg/100 kcal, about 2.5 mg/100 kcal, about 3.0 mg/100 kcal, about 3.5 mg/100 kcal, about 4.0 mg/100 kcal, about 4.5 mg/100 kcal, about 5.0 mg/100 kcal, about 5.5 mg/100 kcal, about 6.0 mg/100 kcal, about 6.5 mg/100 kcal, about 7.0 mg/100 kcal, about 7.5 mg/100 kcal, about 8.0 mg/100 kcal, about 8.5 mg/100 kcal, about 9.0 mg/100 kcal, about 9.5 mg/100 kcal, or about 10.0 mg/100 kcal iron to the subject.

The pea protein and iron may be present in the nutritional powder at a weight ratio (i.e. pea protein:iron) of about 5.4:1 to about 800.0:1, about 6.0:1 to about 800.0:1, about 7.0:1 to about 800.0:1, about 8.0:1 to about 800.0:1, about 9.0:1 to about 800.0:1, about 10.0:1 to about 800.0:1, about 15.0:1 to about 800.0:1, about 20.0:1 to about 800.0:1, about 25.0:1 to about 800.0:1, about 30.0:1 to about 800.0:1, about 35.0:1 to about 800.0:1, about 40.0:1 to about 800.0:1, about 45.0:1 to about 800.0:1, about 50.0:1 to about 800.0:1, about 55.0:1 to about 800.0:1, about 55.0:1 to about 800.0:1, about 60.0:1 to about 800.0:1, about 65.0:1 to about 800.0:1, about 70.0:1 to about 800.0:1, about 75.0:1 to about 800.0:1, about 80.0:1 to about 800.0:1, about 85.0:1 to about 800.0:1, about 90.0:1 to about 800.0:1, about 95.0:1 to about 800.0:1, about 100.0:1 to about 800.0:1, about 150.0:1 to about 800.0:1, about 200.0:1 to about 800.0:1, about 250.0:1 to about 800.0:1, about 300.0:1 to about 800.0:1, about 350.0:1 to about 800.0:1, about 400.0:1 to about 800.0:1, about 450.0:1 to about 800.0:1, about 500.0:1 to about 800.0:1, about 550.0:1 to about 800.0:1, about 600.0:1 to about 800.0:1, about 650.0:1 to about 800.0:1, about 700.0:1 to about 800.0:1, about 750.0:1 to about 800.0:1, about 5.4:1 to about 750.0:1, about 5.4:1 to about 700.0:1, about 5.4:1 to about 650.0:1, about 5.4:1 to about 600.0:1, about 5.4:1 to about 550.0:1, about 5.4:1 to about 500.0:1, about 5.4:1 to about 450.0:1, about 5.4:1 to about 300.0:1, about 5.4:1 to about 250.0:1, about 5.4:1 to about 200.0:1, about 5.4:1 to about 150.0:1, about 5.4:1 to about 100.0:1, about 5.4:1 to about 95.0:1, about 5.4:1 to about 90.0:1, about 5.4:1 to about 85.0:1, about 5.4:1 to about 80.0:1, about 5.4:1 to about 75.0:1, about 5.4:1 to about 70.0:1, about 5.4:1 to about 65.0:1, about 5.4:1 to about 60.0:1, about 5.4:1 to about 55.0:1, about 5.4:1 to about 50.0:1, about 5.4:1 to about 45.0:1, about 5.4:1 to about 40.0:1, about 5.4:1 to about 35.0:1, about 5.4:1 to about 30.0:1, about 5.4:1 to about 25.0:1, about 5.4:1 to about 20.0:1, about 5.4:1 to about 15.0:1, about 5.4:1 to about 10.0:1, about 10.0:1 to about 750.0:1, about 15.0:1 to about 700.0:1, about 20.0:1 to about 650.0:1, about 25.0:1 to about 600.0:1, about 30.0:1 to about 550.0:1, about 35.0:1 to about 500.0:1, about 40.0:1 to about 450.0:1, about 45.0:1 to about 400.0:1, about 50.0:1 to about 350.0:1, about 55.0:1 to about 300.0:1, about 60.0:1 to about 250.0:1, about 65.0:1 to about 200.0:1, or about 70.0:1 to about 150.0:1, or about 5.4:1, about 6.0:1, about 7.0:1, about 8.0:1, about 9.0:1, about 10.0:1, about 15.0:1, about 20.0:1, about 25.0:1, about 30.0:1, about 35.0:1, about 40.0:1, about 45.0:1, about 50.0:1, about 55.0:1, about 60.0:1, about 65.0:1, about 70.0:1, about 75.0:1, about 80.0:1, about 85.0:1, about 90.0:1, about 95.0:1, about 100.0:1, about 150.0:1, about 200.0:1, about 250.0:1, about 300.0:1, about 350.0:1, about 400.0:1, about 450.0:1, about 500.0:1, about 550.0:1, about 600.0:1, about 650.0:1, about 700.0:1, about 750.0:1, or about 800.0:1.

The pea protein may be derived from Pisum sativum. In other embodiments, the pea protein may be derived from other species of pea, including, but not limited to, green peas and field peas.

The pea protein may be in the form of a pea protein concentrate (PPC) or a pea protein isolate (PPI). PPC refers to concentrated pea protein sources containing 60 weight percent (wt. %) to 90 wt. % pea protein. PPI refers to a PPC which contains 80 wt. % to 90% pea protein.

One example of a suitable intact pea protein concentrate that may be included in the nutritional powder is the pea protein isolate based upon Pisum sativum available from Roquette Freres, Lestrem, France, and sold under the name NUTRALYS®F85F. This pea protein isolate has about 83 wt. % intact pea protein. Another example of an intact pea protein that may be included in the nutritional powder is the intact pea protein based on Pisum sativum available from Cosucra Groupe Warcoing of Warcoing, Belgium.

### (b) Rice Protein

The nutritional powder may include rice protein. The rice protein may be intact rice protein or may be provided in a partially hydrolyzed form as described above. The rice protein may bind zinc, thereby facilitating delivery of zinc to the subject upon formation and subsequent ingestion of the nutritional formula. The rice protein may bind about 1 mg to about 170 mg zinc per gram of rice protein such that the nutritional formula may deliver about 0.5 mg/100 kcal to about 5 mg/100 kcal zinc to the subject.

In some embodiments, the rice protein may bind about 0.1 mg to about 200.0 mg, about 0.2 mg to about 200.0 mg, about 0.3 mg to about 200.0 mg, about 0.4 mg to about 200.0 mg, about 0.5 mg to about 200.0 mg, about 0.6 mg to about 200.0 mg, about 0.7 mg to about 200.0 mg, about 0.8 mg to about 200.0 mg, about 0.9 mg to about 200.0 mg, about 1.0 mg to about 200.0 mg, about 2.0 mg to about 200.0 mg, about 3.0 mg to about 200.0 mg, about 4.0 mg to about 200.0 mg, about 5.0 mg to about 200.0 mg, about 6.0 mg to about 200.0 mg, about 7.0 mg to about 200.0 mg, about 8.0 mg to about 200.0 mg, about 9.0 mg to about 200.0 mg, about 10.0 mg to about 200.0 mg, about 15.0 mg to about 200.0 mg, about 20.0 mg to about 200.0 mg, about 25.0 mg to about 200.0 mg, about 30.0 mg to about 200.0 mg, about 35.0 mg to about 200.0 mg, about 40.0 mg to about 200.0 mg, about 45.0 mg to about 200.0 mg, about 50.0 mg to about 200.0 mg, about 55.0 mg to about 200.0 mg, about 60.0 mg to about 200.0 mg, about 65.0 mg to about 200.0 mg, about 70.0 mg to about 200.0 mg, about 75.0 mg to about 200.0 mg, about 80.0 mg to about 200.0 mg, about 85.0 mg to about 200.0 mg, about 90.0 mg to about 200.0 mg, about 95.0 mg to about 200.0 mg, about 100.0 mg to about 200.0 mg, about 105.0 mg to about 200.0 mg, about 110.0 mg to about 200.0 mg, about 115.0 mg to about 200.0 mg, about 120.0 mg to about 200.0 mg, about 125.0 mg to about 200.0 mg, about 130.0 mg to about 200.0 mg, about 135.0 mg to about 200.0 mg, about 140.0 mg to about 200.0 mg, about 145.0 mg to about 200.0 mg, about 150.0 mg to about 200.0 mg, about 155.0 mg to about 200.0 mg, about 160.0 mg to about 200.0 mg, about 165.0 mg to about 200.0 mg, about 170.0 mg to about 200.0 mg, about 175.0 mg to about 200.0 mg, about 180.0 mg to about 200.0 mg, about 185.0 mg to about 200.0 mg, about 190.0 mg to about 200.0 mg, about 0.1 mg to about 195.0 mg, about 0.1 mg to about 190.0 mg, about 0.1 mg to about 185.0 mg, about 0.1 mg to about 180.0 mg, about 0.1 mg to about 175.0 mg, about 0.1 mg to about 170.0 mg, about 0.1 mg to about 165.0 mg, about 0.1 mg to about 160.0 mg, about 0.1 mg to about 155.0 mg, about 0.1 mg to about 150.0 mg, about 0.1 mg to about 145.0 mg, about 0.1 mg to about 140.0 mg, about 0.1 mg to about 135.0 mg, about 0.1 mg to about 130.0 mg, about 0.1 mg to about 125.0 mg, about 0.1 mg to about 120.0 mg, about 0.1 mg to about 115.0 mg, about 0.1 mg to about 110.0 mg, about 0.1 mg to about 105.0 mg, about 0.1 mg to about 100.0 mg, about 0.1 mg to about 95.0 mg, about 0.1 mg to about 90.0 mg, about 0.1 mg to about 85.0 mg, about 0.1 mg to about 80.0 mg, about 0.1 mg to about 75.0 mg, about 0.1 mg to about 70.0 mg, about 0.1 mg to about 65.0 mg, about 0.1 mg to about 60.0 mg, about 0.1 mg to about 55.0 mg, about 0.1 mg to about 50.0 mg, about 0.1 mg to about 45.0 mg, about 0.1 mg to about 40.0 mg, about 0.1 mg to about 35.0 mg, about 0.1 mg to about 30.0 mg, about 0.1 mg to about 25.0 mg, about 0.1 mg to about 20.0 mg, about 0.1 mg to about 15.0 mg, about 0.1 mg to about 10.0 mg, about 0.1 mg to about 9.0 mg, about 0.1 mg to about 8.0 mg, about 0.1 mg to about 7.0 mg, about 0.1 mg to about 6.0 mg, about 0.1 mg to about 5.0 mg, about 0.1 mg to about 4.0 mg, about 0.1 mg to about 3.0 mg, about 0.1 mg to about 2.0 mg, about 0.1 mg to about 1.0 mg, about 0.1 mg to about 0.9 mg, about 0.5 mg to about 190.0 mg, about 1.0 mg to about 180.0 mg, about 5.0 mg to about 170.0 mg, about 10.0 mg to about 160.0 mg, about 20.0 mg to about 150.0 mg, about 30.0 mg to about 140.0 mg, about 40.0 mg to about 130.0 mg, about 50.0 mg to about 120.0 mg, about 60.0 mg to about 110.0 mg, about 70.0 mg to about 100.0 mg, about 1.0 mg to about 170.0 mg, or about 0.1 mg, about 0.2 mg, about 0.3 mg, about 0.4 mg, about 0.5 mg, about 0.6 mg, about 0.7 mg, about 0.8 mg, about 0.9 mg, about 1.0 mg, about 2.0 mg, about 3.0 mg, about 4.0 mg, about 5.0 mg, about 6.0 mg, about 7.0 mg, about 8.0 mg, about 9.0 mg, about 10.0 mg, about 15.0 mg, about 20.0 mg, about 25.0 mg, about 30.0 mg, about 35.0 mg, about 40.0 mg, about 45.0 mg, about 50.0 mg, about 55.0 mg, about 60.0 mg, about 65.0 mg, about 70.0 mg, about 75.0 mg, about 80.0 mg, about 85.0 mg, about 90.0 mg, about 95.0 mg, about 100.0 mg, about 105.0 mg, about 110.0 mg, about 115.0 mg, about 120.0 mg, about 125.0 mg, about 130.0 mg, about 135.0 mg, about 140.0 mg, about 145.0 mg, about 150.0 mg, about 155.0 mg, about 160.0 mg, about 165.0 mg, about 170.0 mg, about 175.0 mg, about 180.0 mg, about 185.0 mg, about 190.0 mg, about 195.0 mg, or about 200.0 mg zinc per gram of rice protein such that the nutritional formula may deliver about 0.1 mg/100 kcal to about 10.0 mg/100 kcal, about 0.2 mg/100 kcal to about 10.0 mg/100 kcal, 0.3 mg/100 kcal to about 10.0 mg/100 kcal, about 0.4 mg/100 kcal to about 10.0 mg/100 kcal, about 0.5 mg/100 kcal to about 10.0 mg/100 kcal, about 0.6 mg/100 kcal to about 10.0 mg/100 kcal, about 0.7 mg/100 kcal to about 10.0 mg/100 kcal, about 0.8 mg/100 kcal to about 10.0 mg/100 kcal, about 0.9 mg/100 kcal to about 10.0 mg/100 kcal, about 1.0 mg/100 kcal to about 10.0 mg/100 kcal, about 0.1 mg/100 kcal to about 9.5 mg/100 kcal, about 0.1 mg/100 kcal to about 9.0 mg/100 kcal, about 0.1 mg/100 kcal to about 8.5 mg/100 kcal, about 0.1 mg/100 kcal to about 8.0 mg/100 kcal, about 0.1 mg/100 kcal to about 7.5 mg/100 kcal, about 0.1 mg/100 kcal to about 7.0 mg/100 kcal, about 0.1 mg/100 kcal to about 6.5 mg/100 kcal, about 0.1 mg/100 kcal to about 6.0 mg/100 kcal, about 0.1 mg/100 kcal to about 5.5 mg/100 kcal, about 0.1 mg/100 kcal to about 5.0 mg/100 kcal, about 0.1 mg/100 kcal to about 4.5 mg/100 kcal, about 0.1 mg/100 kcal to about 4.0 mg/100 kcal, about 0.1 mg/100 kcal to about 3.5 mg/100 kcal, about 0.1 mg/100 kcal to about 3.0 mg/100 kcal, about 0.1 mg/100 kcal to about 2.5 mg/100 kcal, about 0.1 mg/100 kcal to about 2.0 mg/100 kcal, about 0.1 mg/100 kcal to about 1.5 mg/100 kcal, about 0.1 mg/100 kcal to about 1.0 mg/100 kcal, about 0.2 mg/100 kcal to about 9.5 mg/100 kcal, about 0.3 mg/100 kcal to about 9.0 mg/100 kcal, about 0.4 mg/100 kcal to about 8.5 mg/100 kcal, about 0.5 mg/100 kcal to about 8.0 mg/100 kcal, about 0.6 mg/100 kcal to about 7.5 mg/100 kcal, about 0.7 mg/100 kcal to about 7.0 mg/100 kcal, about 0.8 mg/100 kcal to about 6.5 mg/100 kcal, about 0.9 mg/100 kcal to about 6.0 mg/100 kcal, about 1.0 mg/100 kcal to about 5.0 mg/100 kcal, or about 0.5 mg/100 kcal to about 5.0 mg/100 kcal, or about 0.1 mg/100 kcal, about 0.2 mg/100 kcal, about 0.3 mg/100 kcal, about 0.4 mg/100 kcal, about 0.5 mg/100 kcal, about 0.6 mg/100 kcal, about 0.7 mg/100 kcal, about 0.8 mg/100 kcal, about 0.9 mg/100 kcal, about 1.0 mg/100 kcal, about 1.5 mg/100 kcal, about 2.0 mg/100 kcal, about 2.5 mg/100 kcal, about 3.0 mg/100 kcal, about 3.5 mg/100 kcal, about 4.0 mg/100 kcal, about 4.5 mg/100 kcal, about 5.0 mg/100 kcal, about 5.5 mg/100 kcal, about 6.0 mg/100 kcal, about 6.5 mg/100 kcal, about 7.0 mg/100 kcal, about 7.5 mg/100 kcal, about 8.0 mg/100 kcal, about 8.5 mg/100 kcal, about 9.0 mg/100 kcal, about 9.5 mg/100 kcal, or about 10.0 mg/100 kcal zinc to the subject.

In other embodiments, the rice protein may bind about 0.1 mg to about 200.0 mg, about 0.2 mg to about 200.0 mg, about 0.3 mg to about 200.0 mg, about 0.4 mg to about 200.0 mg, about 0.5 mg to about 200.0 mg, about 0.6 mg to about 200.0 mg, about 0.7 mg to about 200.0 mg, about 0.8 mg to about 200.0 mg, about 0.9 mg to about 200.0 mg, about 1.0 mg to about 200.0 mg, about 2.0 mg to about 200.0 mg, about 3.0 mg to about 200.0 mg, about 4.0 mg to about 200.0 mg, about 5.0 mg to about 200.0 mg, about 6.0 mg to about 200.0 mg, about 7.0 mg to about 200.0 mg, about 8.0 mg to about 200.0 mg, about 9.0 mg to about 200.0 mg, about 10.0 mg to about 200.0 mg, about 15.0 mg to about 200.0 mg, about 20.0 mg to about 200.0 mg, about 25.0 mg to about 200.0 mg, about 30.0 mg to about 200.0 mg, about 35.0 mg to about 200.0 mg, about 40.0 mg to about 200.0 mg, about 45.0 mg to about 200.0 mg, about 50.0 mg to about 200.0 mg, about 55.0 mg to about 200.0 mg, about 60.0 mg to about 200.0 mg, about 65.0 mg to about 200.0 mg, about 70.0 mg to about 200.0 mg, about 75.0 mg to about 200.0 mg, about 80.0 mg to about 200.0 mg, about 85.0 mg to about 200.0 mg, about 90.0 mg to about 200.0 mg, about 95.0 mg to about 200.0 mg, about 100.0 mg to about 200.0 mg, about 105.0 mg to about 200.0 mg, about 110.0 mg to about 200.0 mg, about 115.0 mg to about 200.0 mg, about 120.0 mg to about 200.0 mg, about 125.0 mg to about 200.0 mg, about 130.0 mg to about 200.0 mg, about 135.0 mg to about 200.0 mg, about 140.0 mg to about 200.0 mg, about 145.0 mg to about 200.0 mg, about 150.0 mg to about 200.0 mg, about 155.0 mg to about 200.0 mg, about 160.0 mg to about 200.0 mg, about 165.0 mg to about 200.0 mg, about 170.0 mg to about 200.0 mg, about 175.0 mg to about 200.0 mg, about 180.0 mg to about 200.0 mg, about 185.0 mg to about 200.0 mg, about 190.0 mg to about 200.0 mg, about 0.1 mg to about 195.0 mg, about 0.1 mg to about 190.0 mg, about 0.1 mg to about 185.0 mg, about 0.1 mg to about 180.0 mg, about 0.1 mg to about 175.0 mg, about 0.1 mg to about 170.0 mg, about 0.1 mg to about 165.0 mg, about 0.1 mg to about 160.0 mg, about 0.1 mg to about 155.0 mg, about 0.1 mg to about 150.0 mg, about 0.1 mg to about 145.0 mg, about 0.1 mg to about 140.0 mg, about 0.1 mg to about 135.0 mg, about 0.1 mg to about 130.0 mg, about 0.1 mg to about 125.0 mg, about 0.1 mg to about 120.0 mg, about 0.1 mg to about 115.0 mg, about 0.1 mg to about 110.0 mg, about 0.1 mg to about 105.0 mg, about 0.1 mg to about 100.0 mg, about 0.1 mg to about 95.0 mg, about 0.1 mg to about 90.0 mg, about 0.1 mg to about 85.0 mg, about 0.1 mg to about 80.0 mg, about 0.1 mg to about 75.0 mg, about 0.1 mg to about 70.0 mg, about 0.1 mg to about 65.0 mg, about 0.1 mg to about 60.0 mg, about 0.1 mg to about 55.0 mg, about 0.1 mg to about 50.0 mg, about 0.1 mg to about 45.0 mg, about 0.1 mg to about 40.0 mg, about 0.1 mg to about 35.0 mg, about 0.1 mg to about 30.0 mg, about 0.1 mg to about 25.0 mg, about 0.1 mg to about 20.0 mg, about 0.1 mg to about 15.0 mg, about 0.1 mg to about 10.0 mg, about 0.1 mg to about 9.0 mg, about 0.1 mg to about 8.0 mg, about 0.1 mg to about 7.0 mg, about 0.1 mg to about 6.0 mg, about 0.1 mg to about 5.0 mg, about 0.1 mg to about 4.0 mg, about 0.1 mg to about 3.0 mg, about 0.1 mg to about 2.0 mg, about 0.1 mg to about 1.0 mg, about 0.1 mg to about 0.9 mg, about 0.5 mg to about 190.0 mg, about 1.0 mg to about 180.0 mg, about 5.0 mg to about 170.0 mg, about 10.0 mg to about 160.0 mg, about 20.0 mg to about 150.0 mg, about 30.0 mg to about 140.0 mg, about 40.0 mg to about 130.0 mg, about 50.0 mg to about 120.0 mg, about 60.0 mg to about 110.0 mg, about 70.0 mg to about 100.0 mg, about 1.0 mg to about 170.0 mg, or about 0.1 mg, about 0.2 mg, about 0.3 mg, about 0.4 mg, about 0.5 mg, about 0.6 mg, about 0.7 mg, about 0.8 mg, about 0.9 mg, about 1.0 mg, about 2.0 mg, about 3.0 mg, about 4.0 mg, about 5.0 mg, about 6.0 mg, about 7.0 mg, about 8.0 mg, about 9.0 mg, about 10.0 mg, about 15.0 mg, about 20.0 mg, about 25.0 mg, about 30.0 mg, about 35.0 mg, about 40.0 mg, about 45.0 mg, about 50.0 mg, about 55.0 mg, about 60.0 mg, about 65.0 mg, about 70.0 mg, about 75.0 mg, about 80.0 mg, about 85.0 mg, about 90.0 mg, about 95.0 mg, about 100.0 mg, about 105.0 mg, about 110.0 mg, about 115.0 mg, about 120.0 mg, about 125.0 mg, about 130.0 mg, about 135.0 mg, about 140.0 mg, about 145.0 mg, about 150.0 mg, about 155.0 mg, about 160.0 mg, about 165.0 mg, about 170.0 mg, about 175.0 mg, about 180.0 mg, about 185.0 mg, about 190.0 mg, about 195.0 mg, or about 200.0 mg zinc per gram of rice protein.

In still other embodiments, the nutritional formula, which is described below in more detail, may deliver about 0.1 mg/100 kcal to about 10.0 mg/100 kcal, about 0.2 mg/100 kcal to about 10.0 mg/100 kcal, about 0.3 mg/100 kcal to about 10.0 mg/100 kcal, about 0.4 mg/100 kcal to about 10.0 mg/100 kcal, about 0.5 mg/100 kcal to about 10.0 mg/100 kcal, about 0.6 mg/100 kcal to about 10.0 mg/100 kcal, about 0.7 mg/100 kcal to about 10.0 mg/100 kcal, about 0.8 mg/100 kcal to about 10.0 mg/100 kcal, about 0.9 mg/100 kcal to about 10.0 mg/100 kcal, about 1.0 mg/100 kcal to about 10.0 mg/100 kcal, about 0.1 mg/100 kcal to about 9.5 mg/100 kcal, about 0.1 mg/100 kcal to about 9.0 mg/100 kcal, about 0.1 mg/100 kcal to about 8.5 mg/100 kcal, about 0.1 mg/100 kcal to about 8.0 mg/100 kcal, about 0.1 mg/100 kcal to about 7.5 mg/100 kcal, about 0.1 mg/100 kcal to about 7.0 mg/100 kcal, about 0.1 mg/100 kcal to about 6.5 mg/100 kcal, about 0.1 mg/100 kcal to about 6.0 mg/100 kcal, about 0.1 mg/100 kcal to about 5.5 mg/100 kcal, about 0.1 mg/100 kcal to about 5.0 mg/100 kcal, about 0.1 mg/100 kcal to about 4.5 mg/100 kcal, about 0.1 mg/100 kcal to about 4.0 mg/100 kcal, about 0.1 mg/100 kcal to about 3.5 mg/100 kcal, about 0.1 mg/100 kcal to about 3.0 mg/100 kcal, about 0.1 mg/100 kcal to about 2.5 mg/100 kcal, about 0.1 mg/100 kcal to about 2.0 mg/100 kcal, about 0.1 mg/100 kcal to about 1.5 mg/100 kcal, about 0.1 mg/100 kcal to about 1.0 mg/100 kcal, about 0.2 mg/100 kcal to about 9.5 mg/100 kcal, about 0.3 mg/100 kcal to about 9.0 mg/100 kcal, about 0.4 mg/100 kcal to about 8.5 mg/100 kcal, about 0.5 mg/100 kcal to about 8.0 mg/100 kcal, about 0.6 mg/100 kcal to about 7.5 mg/100 kcal, about 0.7 mg/100 kcal to about 7.0 mg/100 kcal, about 0.8 mg/100 kcal to about 6.5 mg/100 kcal, about 0.9 mg/100 kcal to about 6.0 mg/100 kcal, about 1.0 mg/100 kcal to about 5.0 mg/100 kcal, or about 0.5 mg/100 kcal to about 5.0 mg/100 kcal, or about 0.1 mg/100 kcal, about 0.2 mg/100 kcal, about 0.3 mg/100 kcal, about 0.4 mg/100 kcal, about 0.5 mg/100 kcal, about 0.6 mg/100 kcal, about 0.7 mg/100 kcal, about 0.8 mg/100 kcal, about 0.9 mg/100 kcal, about 1.0 mg/100 kcal, about 1.5 mg/100 kcal, about 2.0 mg/100 kcal, about 2.5 mg/100 kcal, about 3.0 mg/100 kcal, about 3.5 mg/100 kcal, about 4.0 mg/100 kcal, about 4.5 mg/100 kcal, about 5.0 mg/100 kcal, about 5.5 mg/100 kcal, about 6.0 mg/100 kcal, about 6.5 mg/100 kcal, about 7.0 mg/100 kcal, about 7.5 mg/100 kcal, about 8.0 mg/100 kcal, about 8.5 mg/100 kcal, about 9.0 mg/100 kcal, about 9.5 mg/100 kcal, or about 10.0 mg/100 kcal zinc to the subject.

The rice protein and zinc may be present in the nutritional powder at a weight ratio (i.e. rice protein:zinc) of about 6:1 to about 900:1, about 10:1 to about 900:1, about 15:1 to about 900:1, about 20:1 to about 900:1, about 25:1 to about 900:1, about 30:1 to about 900:1, about 35:1 to about 900:1, about 40:1 to about 900:1, about 45:1 to about 900:1, about 50:1 to about 900:1, about 55:1 to about 900:1, about 60:1 to about 900:1, about 65:1 to about 900:1, about 70:1 to about 900:1, about 75:1 to about 900:1, about 80:1 to about 900:1, about 85:1 to about 900:1, about 90:1 to about 900:1, about 95:1 to about 900:1, about 100:1 to about 900:1, about 150:1 to about 900:1, about 200:1 to about 900:1, about 250:1 to about 900:1, about 300:1 to about 900:1, about 350:1 to about 900:1, about 400:1 to about 900:1, about 450:1 to about 900:1, about 500:1 to about 900:1, about 550:1 to about 900:1, about 600:1 to about 900:1, about 650:1 to about 900:1, about 700:1 to about 900:1, about 750:1 to about 900:1, about 800:1 to about 900:1, about 850:1 to about 900:1, about 6:1 to about 850:1, about 6:1 to about 800:1, about 6:1 to about 750:1, about 6:1 to about 700:1, about 6:1 to about 650:1, about 6:1 to about 600:1, about 6:1 to about 550:1, about 6:1 to about 500:1, about 6:1 to about 450:1, about 6:1 to about 400:1, about 6:1 to about 350:1, about 6:1 to about 300:1, about 6:1 to about 250:1, about 6:1 to about 200:1, about 6:1 to about 150:1, about 6:1 to about 100:1, about 6:1 to about 95:1, about 6:1 to about 90:1, about 6:1 to about 85:1, about 6:1 to about 80:1, about 6:1 to about 75:1, about 6:1 to about 70:1, about 6:1 to about 65:1, about 6:1 to about 60:1, about 6:1 to about 55:1, about 6:1 to about 50:1, about 6:1 to about 45:1, about 6:1 to about 40:1, about 6:1 to about 35:1, about 6:1 to about 30:1, about 6:1 to about 25:1, about 6:1 to about 20:1, about 6:1 to about 15:1, about 6:1 to about 10:1, about 10:1 to about 950:1, about 15:1 to about 900:1, about 20:1 to about 850:1, about 25:1 to about 800:1, about 30:1 to about 750:1, about 35:1 to about 700:1, about 40:1 to about 650:1, about 45:1 to about 600:1, about 50:1 to about 550:1, about 55:1 to about 500:1, about 60:1 to about 450:1, about 65:1 to about 400:1, about 70:1 to about 350:1, about 75:1 to about 300:1, about 80:1 to about 250:1, about 85:1 to about 200:1, or about 90:1 to about 150:1, or about 6:1, about 7:1, about 8:1, about 9:1, about 10:1, about 15:1, about 20:1, about 25:1, about 30:1, about 35:1, about 40:1, about 45:1, about 50:1, about 55:1, about 60:1, about 65:1, about 70:1, about 75:1, about 80:1, about 85:1, about 90:1, about 95:1, about 100:1, about 150:1, about 200:1, about 250:1, about 300:1, about 350:1, about 400:1, about 450:1, about 500:1, about 550:1, about 600:1, about 650:1, about 700:1, about 750:1, about 800:1, about 850:1, or about 900:1.

The rice protein may be derived from Asian rice (Oryza sativa), African rice (Oryza glabemma), or the combination thereof. The rice protein may be in the white rice form, the brown rice form, or the combination thereof. White rice is rice in which the hull, bran, and germ have all been removed from the rice. Brown rice, which is also known as “hulled” or “unmilled” rice, is whole grain rice, i.e., rice in which the hull has been removed, but the bran and germ have not been removed from the rice.

Brown rice protein may be in the form of brown rice protein concentrate, brown rice protein isolate, or the combination thereof. Commercial sources of brown rice protein that may be used in the nutritional powder may include, but are not limited to, the following manufacturers: Nutribiotic, Jarrow Formulas, Vitacost, Sunwarrier, Axiom Foods, and AIDP.

In some embodiments, a source of intact brown rice protein that may be used in the nutritional powder is the brown rice protein powders sold under the name ORYZATEIN™ by Axiom Foods, Inc. of Los Angeles, Calif. and distributed by Prinova, USA of Carol Stream, Ill.

White rice protein, like brown rice protein, may be in the form of a protein concentrate, a protein isolate, or the combination thereof. A commercial source of white rice protein concentrate and white rice protein isolate includes, but is not limited to, the white rice protein products sold under the name Gabioten by Shanghai Freemen Chemicals Company, LLC. of Shanghai, China.

### (c) Potato Protein

The nutritional powder may include potato protein. The potato protein may be intact potato protein or may be provided in a partially hydrolyzed form as described above.

The potato protein may be in the form of a concentrate, an isolate, or the combination thereof. The potato protein may be in the form of a concentrate or isolate that contains 80% to 95% protein and available from Solanic, which is a subsidiary of AVEBE of Veedam, The Netherlands.

### (d) Soy Protein

The nutritional powder may include soy protein. The soy protein may be intact soy protein or may be provided in a partially hydrolyzed form as described above.

The soy protein may be in the form of a concentrate, an isolate, or the combination thereof. A soy protein concentrate (SPC) refers to products which are basically soybean without the water soluble carbohydrates and which contain about 60 wt. % to about 90 wt. % or more soy protein. In some embodiments, the SPC contains about 60 wt. % to about 85 wt. % soy protein or about 70 wt. % to about 80 wt. % soy protein. A soy protein isolate (SPI) refers to a type of SPC that contains about 85 wt. % to about 90 wt. % soy protein. SPI is the most refined form of soy protein.

Commercial sources of soy protein include, but are not limited to, The Solae Company of St. Louis, Mo., USA, and the Arthur Daniels Midland Company of Decatur, Ill., USA.

### (e) Hemp Protein

The nutritional powder may include hemp protein. The hemp protein may be intact hemp protein or may be provided in a partially hydrolyzed form as described above.

The hemp protein may be in the form of a concentrate, an isolate, or the combination thereof. The hemp protein may be in the form of a concentrate or isolate.

### (f) Protein Modification

The protein contained in the nutritional powder may be modified, for example, hydrolyzed. The protein may be partially hydrolyzed.

The degree of hydrolysis is the extent to which peptide bonds are broken by a hydrolysis chemical or enzymatic reaction. To quantify the partially hydrolyzed protein component of the nutritional powder, the degree of protein hydrolysis is determined by quantifying the amino nitrogen to total nitrogen ratio (AN/TN) of the protein component of the selected nutritional powder. The amino nitrogen component is quantified by USP titration methods for determining amino nitrogen content, while the total nitrogen component is determined by the Tecator® Kjeldahl method. Accordingly, another way of referring to the extent of hydrolyzation in hydrolyzed protein is by degree of hydrolysis (DH). A DH value of, for example, 30 refers to protein in which 30% of the total protein is hydrolyzed.

In some embodiments, the protein may have a degree of hydrolysis (DH) of about 0 to about 60, about 1 to about 60, about 2 to about 60, about 3 to about 60, about 4 to about 60, about 5 to about 60, about 6 to about 60, about 7 to about 60, about 8 to about 60, about 9 to about 60, about 10 to about 60, about 15 to about 60, about 20 to about 60, about 25 to about 60, about 30 to about 60, about 35 to about 60, about 40 to about 60, about 45 to about 60, about 50 to about 60, about 55 to about 60, about 0 to about 55, about 0 to about 50, about 0 to about 45, about 0 to about 40, about 0 to about 35, about 0 to about 30, about 0 to about 25, about 0 to about 20, about 0 to about 15, about 0 to about 10, about 0 to about 9, about 0 to about 8, about 0 to about 7, about 0 to about 6, about 0 to about 5, about 1 to about 55, about 2 to about 50, about 3 to about 45, about 4 to about 40, about 5 to about 35, about 6 to about 30, about 7 to about 25, about 8 to about 20, about 9 to about 15, or about 0, about 1, about 2, about 3, about 4, about 5, about 6, about 7, about 8, about 9, about 10, about 11, about 12, about 13, about 14, about 15, about 16, about 17, about 18, about 19, about 20, about 21, about 22, about 23, about 24, about 25, about 26, about 27, about 28, about 29, about 30, about 31, about 32, about 33, about 34, about 35, about 36, about 37, about 38, about 39, about 40, about 41, about 42, about 43, about 44, about 45, about 46, about 47, about 48, about 49, about 50, about 51, about 52, about 53, about 54, about 55, about 56, about 57, about 58, about 59, or about 60.

In some embodiments, the protein may be substantially free of any protein that has a degree of hydrolysis of 61 or more. In other embodiments, the partially hydrolyzed protein may be protein having a degree of hydrolysis (DH) of less than about 61, less than about 60, less than about 55, less than about 50, less than about 45, less than about 40, less than about 35, less than about 30, less than about 25, less than about 20, less than about 15, less than about 10, or less than about 5. In other embodiments, the partially hydrolyzed protein may be protein having a degree of hydrolysis of less than about 61, 60, 59, 58, 57, 56, 55, 54, 53, 52, 51, 50, 49, 48, 47, 46, 45, 44, 43, 42, 41, 40, 39, 38, 37, 36, 35, 34, 33, 32, 31, 30, 29, 28, 27, 26, 25, 24, 23, 22, 21, 20, 19, 18, 17, 16, 15, 14, 13, 12, 11, 10, 9, 8, 7, 6, 5, 4, 3, 2, or 1.

Hydrolysis of the protein that is contained within the nutritional powder may increase the solubility of the protein in the nutritional formula. Soluble protein is protein that does not precipitate (i.e., resides in the supernatant) when a 2% (w/w) suspension of the total protein in water is centrifuged at 31,000×g at 20 degrees Celsius for sixty minutes. In some embodiments, protein solubility may increase as DH increases.

The following favorable features of the protein may increase with solubility: emulsion capacity, digestibility, and mineral delivery. In turn, the following unfavorable features of the protein may increase with the degree of hydrolysis: compromised sensory quality (i.e., deteriorating sensory attributes, which are described below in more detail) and poor protein functionality. Accordingly, a balance may exist between solubility and degree of hydrolysis of the protein with regards to increasing favorable features of the protein and decreasing unfavorable features of the protein.

In some embodiments, when the protein has been modified to have a relatively high solubility and a relatively low degree of hydrolysis, an acceptable balance may be struck between the favorable (e.g., emulsion capacity, digestibility, and mineral delivery) and unfavorable (e.g., compromised sensory quality and poor functionality) features of the protein. This balance may be represented by the value R, which is a ratio of soluble protein (expressed as % of total protein) to the degree of hydrolysis (“DH,” expressed as %). In some embodiments, a value of R greater than about 10, greater than about 12, or greater than about 15 may provide an acceptable balance between favorable and unfavorable features of the protein. In other embodiments, the protein may be modified such that R is between about 10 and about 30, about 12 and about 25, or about 15 and about 20. In still other embodiments, the protein may be modified such that R is about 10, 11, 12, 13, 14, 15, 16, 17, 18, 19, 20, 21, 22, 23, 24, 25, 26, 27, 28, 29, or 30.

The protein may be hydrolyzed enzymatically. The enzyme may be, but is not limited to, plant proteases (e.g., bromelain, papain), animal proteases (e.g., pancreatin, trypsin), and bacterial proteases (e.g., pronase E). Hydrolysis may be controlled, for example, through temperature, time, pH, and enzyme/substrate ratio to yield the desired value of R. The soluble protein concentration and the degree of hydrolysis may be measured by any suitable method, including the chromatographic method (as described in Food. Chem., 125 [2011] 1041-1050, the entire disclosure of which is incorporated herein by reference).

(b) Fat or Oil

The nutritional powder may also include the fat, which may be in the form of oil. “Fat” and “oil” as used herein are used interchangeably to refer to lipid materials derived or processed from vegetables or animals. These terms also include synthetic lipid materials so long as such synthetic materials are suitable for oral administration to humans. Such materials are normally composed of mixtures of fatty acid triglycerides, which mixtures may also contain fatty acid diglycerides and monoglycerides and even some free fatty acids.

The oil may be present in the nutritional powder in about 0.5 wt % to about 70 wt %, about 0.75 wt % to about 70 wt %, about 1 wt % to about 70 wt %, about 5 wt % to about 70 wt %, about 10 wt % to about 70 wt %, about 15 wt % to about 70 wt %, about 20 wt % to about 70 wt %, about 25 wt % to about 70 wt %, about 30 wt % to about 70 wt %, about 35 wt % to about 70 wt %, about 40 wt % to about 70 wt %, about 45 wt % to about 70 wt %, about 50 wt % to about 70 wt %, about 55 wt % to about 70 wt %, about 60 wt % to about 70 wt %, about 0.5 wt % to about 65 wt %, about 0.5 wt % to about 60 wt %, about 0.5 wt % to about 55 wt %, about 0.5 wt % to about 50 wt %, about 0.5 wt % to about 45 wt %, about 0.5 wt % to about 40 wt %, about 0.5 wt % to about 35 wt %, about 0.5 wt % to about 30 wt %, about 0.5 wt % to about 25 wt %, about 0.5 wt % to about 20 wt %, about 0.5 wt % to about 15 wt %, about 0.5 wt % to about 10 wt %, about 0.5 wt % to about 35 wt %, about 0.75 wt % to about 35 wt %, about 0.75 wt % to about 30 wt %, about 1 wt % to about 35 wt %, about 1 wt % to about 28 wt %, about 5 wt % to about 35 wt %, about 10 wt % to about 35 wt %, about 15 wt % to about 35 wt %, about 20 wt % to about 35 wt %, about 0.5 wt % to about 30 wt %, about 0.5 wt % to about 25 wt %, about 0.5 wt % to about 20 wt %, about 0.5 wt % to about 15 wt %, about 0.5 wt % to about 10 wt %, about 0.75 wt % to about 30 wt %, about 1 wt % to about 28 wt %, about 2 wt % to about 5 wt %, about 5 wt % to about 70 wt %, about 10 wt % to about 60 wt %, about 20 wt % to about 55 wt %, about 2 wt % to about 5 wt %, or about 0.5 wt %, 0.6 wt %, 0.7 wt %, 0.8 wt %, 0.9 wt %, 1 wt %, 2 wt %, 3 wt %, 4 wt %, 5 wt %, 6 wt %, 7 wt %, 8 wt %, 9 wt %, 10 wt %, 11 wt %, 12 wt %, 13 wt %, 14 wt %, 15 wt %, 16 wt %, 17 wt %, 18 wt %, 19 wt %, 20 wt %, 21 wt %, 22 wt %, 23 wt %, 24 wt %, 25 wt %, 26 wt %, 27 wt %, 28 wt %, 29 wt %, 30 wt %, 31 wt %, 32 wt %, 33 wt %, 34 wt %, 35 wt %, 36 wt %, 37 wt %, 38 wt %, 39 wt %, 40 wt %, 41 wt %, 42 wt %, 43 wt %, 44 wt %, 45 wt %, 46 wt %, 47 wt %, 48 wt %, 49 wt %, 50 wt %, 51 wt %, 52 wt %, 53 wt %, 54 wt %, 55 wt %, 56 wt %, 57 wt %, 58 wt %, 59 wt %, 60 wt %, 61 wt %, 62 wt %, 63 wt %, 64 wt %, 65 wt %, 66 wt %, 67 wt %, 68 wt %, 69 wt %, or 70 wt %, by weight of the nutritional powders.

The oil may include canola oil, soybean oil, vegetable oil, safflower oil, sunflower oil, palm oil, coconut oil, fractionated coconut oil, soy oil, corn oil, olive oil, high oleic safflower oil, medium chain triglyceride oil, high gamma linolenic safflower oil, high oleic sunflower oil, palm kernel oil, palm olein, marine oils, algal oils, cottonseed oils, interesterified oils, transesterified oils, or any combination thereof.

The oil may be a source of the one or more isoflavones, the one or more phytosterols, the one or more polyphenols, or any combination thereof. The one or more isoflavones, the one or more phytosterols, and the one or more polyphenols are described below in more detail. In those embodiments when the oil is a source of the one or more isoflavones, the one or more phytosterols, and/or the one or more polyphenols, the oil may include, but is not limited to, canola oil, soybean oil, vegetable oil, safflower oil, sunflower oil, palm oil, or any combination thereof.

The oil may also be a source of fat. The fat source may include a fatty acid. The fatty acid may include palmitic acid, myristic acid, stearic acid, linoleic acid, alpha-linoleic acid, and combinations thereof.

In some embodiments, the nutritional powder may include a fatty acid, such as palmitic acid, up to about 5% by weight of the total fat content, including about 0.1% to about 5%, about 0.1% to about 4%, about 0.1% to about 3%, about 0.1% to about 2%, about 0.1% to about 1.0%, about 1% to about 5%, about 1% to about 4%, about 1% to about 3%, about 1% to about 2%, about 2% to about 5%, about 0.2% to about 1.0%, about 0.3% to about 1.0%, about 0.4% to about 1.0%, about 0.5% to about 1.0%, about 0.6% to about 1.0%, about 0.7% to about 1.0%, about 0.8% to about 1.0%, about 0.9% to about 1.0%, about 0.2% to about 1.0%, about 0.2% to about 0.9%, about 0.2% to about 0.8%, about 0.2% to about 0.7%, about 0.2% to about 0.6%, about 0.2% to about 0.5%, about 0.2% to about 0.4%, about 0.2% to about 0.3%, about 0.3% to about 0.9%, about 0.3% to about 0.8%, about 0.3% to about 0.7%, about 0.3% to about 0.7%, about 0.3% to about 0.6%, about 0.3% to about 0.5%, about 0.3% to about 0.4%, about 0.4% to about 0.9%, about 0.4% to about 0.8%, about 0.4% to about 0.7%, about 0.4% to about 0.6%, about 0.4% to about 0.5%, about 0.5% to about 0.9%, about 0.5% to about 0.8%, about 0.5% to about 0.7%, about 0.5% to about 0.6%, about 0.6% to about 0.9%, about 0.6% to about 0.8%, about 0.6% to about 0.7%, about 0.7% to about 0.9%, about 0.7% to about 0.8%, or about 0.8% to about 0.9%, by weight of the total fat content.

The total fat content may include, by weight, at least about 0.1%, at least about 0.2%, at least about 0.3%, at least about 0.4%, at least about 0.5%, at least about 0.6%, at least about 0.7%, at least about 0.8%, at least about 0.9%, at least about 1.0%, at least about 1.1%, at least about 1.2%, at least about 1.3%, at least about 1.4%, at least about 1.5%, at least about 1.6%, at least about 1.7%, at least about 1.8%, at least about 1.9%, at least about 2%, at least about 2.1%, at least about 2.2%, at least about 2.3%, at least about 2.4%, at least about 2.5%, at least about 2.6%, at least about 2.7%, at least about 2.8%, at least about 2.9%, at least about 3%, at least about 3.1%, at least about 3.2%, at least about 3.3%, at least about 3.4%, at least about 3.5%, at least about 3.6%, at least about 3.7%, at least about 3.8%, at least about 3.9%, at least about 4%, at least about 4.1%, at least about 4.2%, at least about 4.3%, at least about 4.4%, at least about 4.5%, at least about 4.6%, at least about 4.7%, at least about 4.8%, at least about 4.9%, or at least about 5% of a fatty acid, such as palmitic acid.

The total fat content may include, by weight, about 0.1%, about 0.2%, about 0.3%, about 0.4%, about 0.5%, about 0.6%, about 0.7%, about 0.8%, about 0.9%, about 1.0%, about 1.1%, about 1.2%, about 1.3%, about 1.4%, about 1.5%, about 1.6%, about 1.7%, about 1.8%, about 1.9%, about 2%, about 2.1%, about 2.2%, about 2.3%, about 2.4%, about 2.5%, about 2.6%, about 2.7%, about 2.8%, about 2.9%, about 3%, about 3.1%, about 3.2%, about 3.3%, about 3.4%, about 3.5%, about 3.6%, about 3.7%, about 3.8%, about 3.9%, about 4%, about 4.1%, about 4.2%, about 4.3%, about 4.4%, about 4.5%, about 4.6%, about 4.7%, about 4.8%, about 4.9%, or about 5% of a fatty acid, such as palmitic acid.

(c) Carbohydrate

The nutritional powder may also include one or more carbohydrates. Carbohydrate concentrations in the nutritional powders may typically range from about 5 wt % to about 70 wt %, including from about 7 wt % to about 60 wt %, or including from about 10 wt % to about 55 wt %, by weight of the nutritional powders.

The one or more carbohydrates may include one or more of maltodextrin; hydrolyzed or modified starch or cornstarch; glucose polymers; corn syrup; corn syrup solids; rice-derived carbohydrates; high fructose corn syrup; honey; sugar alcohols, such as maltitol, erythritol, sorbitol, glycerine; sucrose; glucose; fructose; lactose; isomaltulose, sucromalt, pullulan, potato starch, and other slowly-digested carbohydrates; oligosaccharides such as fructo-oligosaccharides; dietary fibers including, but not limited to, oat fiber, soy fiber, gum arabic, sodium carboxymethylcellulose, methylcellulose, guar gum, gellan gum, locust bean gum, konjac flour, hydroxypropyl methylcellulose, tragacanth gum, karaya gum, gum acacia, chitosan, arabinoglactins, glucomannan, xanthan gum, alginate, pectin, low and high methoxy pectin, cereal beta-glucans, carrageenan and psyllium, soluble dietary fibers such as digestion resistant maltodextrins, resistant modified food starches, other resistant starches; soluble and insoluble fibers derived from fruits or vegetables; and combinations thereof.

(12) Isoflavones

As described above, the protein and/or oil may be the source of the one or more isoflavones in the nutritional powder. The one or more isoflavones may include daidzein, daidzin, malonyl-daidzin, acetyl-daidzin, genistein, genistin, malonyl-genistein, glycitein, glycitin, malonyl-glycitin, acetyl-glycitin, or any combination thereof.

The one or more isoflavones may be present in the nutritional powder at about 10 micrograms (μg) to about 2000 μg, about 10 μg to about 1950 μg, about 10 μg to about 1900 μg, about 10 μg to about 1850 μg, about 10 μg to about 1800 μg, about 10 μg to about 1750 μg, about 10 μg to about 1700 μg, about 10 μg to about 1650 μg, about 10 μg to about 1600 μg, about 10 μg to about 1550 μg, about 10 μg to about 1500 μg, about 10 μg to about 1450 μg, about 10 μg to about 1400 μg, about 10 μg to about 1350 μg, about 10 μg to about 1300 μg, about 10 μg to about 1250 μg, about 10 μg to about 1200 μg, about 10 μg to about 1150 μg, about 10 μg to about 1100 μg, about 10 μg to about 1050 μg, about 10 μg to about 1000 μg, about 10 μg to about 975 μg, about 10 μg to about 950 μg, about 10 μg to about 925 μg, about 10 μg to about 900 μg, about 10 μg to about 875 μg, about 10 μg to about 850 μg, about 10 μg to about 825 μg, about 10 μg to about 800 μg, about 10 μg to about 775 μg, about 10 μg to about 750 μg, about 10 μg to about 725 μg, about 10 μg to about 700 μg, about 10 μg to about 675 μg, about 10 μg to about 650 μg, about 10 μg to about 625 μg, about 10 μg to about 600 μg, about 10 μg to about 575 μg, about 10 μg to about 550 μg, about 10 μg to about 525 μg, about 10 μg to about 500 μg, about 10 μg to about 475 μg, about 10 μg to about 450 μg, about 10 μg to about 425 μg, about 10 μg to about 400 μg, about 10 μg to about 375 μg, about 10 μg to about 350 μg, about 10 μg to about 325 μg, about 10 μg to about 300 μg, about 10 μg to about 275 μg, about 10 μg to about 250 μg, about 10 μg to about 225 μg, about 10 μg to about 200 μg, about 10 μg to about 175 μg, about 10 μg to about 150 μg, about 10 μg to about 125 μg, about 10 μg to about 100 μg, about 10 μg to about 95 μg, about 10 μg to about 90 μg, about 10 μg to about 85 μg, about 10 μg to about 80 μg, about 10 μg to about 75 μg, about 10 μg to about 70 μg, about 10 μg to about 65 μg, about 10 μg to about 60 μg, about 10 μg to about 55 μg, about 10 μg to about 50 μg, about 10 μg to about 45 μg, about 10 μg to about 40 μg, about 10 μg to about 35 μg, about 10 μg to about 30 μg, about 10 μg to about 25 μg, about 10 μg to about 20 μg, about 10 μg to about 15 μg per gram (g) of the nutritional powder.

In other embodiments, the one or more isoflavones may be present in the nutritional powder at about 15 μg to about 2000 μg, about 20 μg to about 2000 μg, about 25 μg to about 2000 μg, about 30 μg to about 2000 μg, about 35 μg to about 2000 μg, about 40 μg to about 2000 μg, about 45 μg to about 2000 μg, about 50 μg to about 2000 μg, about 55 μg to about 2000 μg, about 60 μg to about 2000 μg, about 65 μg to about 2000 μg, about 70 μg to about 2000 μg, about 75 μg to about 2000 μg, about 80 μg to about 2000 μg, about 85 μg to about 2000 μg, about 90 μg to about 2000 μg, about 95 μg to about 2000 μg, about 100 μg to about 2000 μg, about 125 μg to about 2000 μg, about 150 μg to about 2000 μg, about 175 μg to about 2000 μg, about 200 μg to about 2000 μg, about 225 μg to about 2000 μg, about 250 μg to about 2000 μg, about 275 μg to about 2000 μg, about 300 μg to about 2000 μg, about 325 μg to about 2000 μg, about 350 μg to about 2000 μg, about 375 μg to about 2000 μg, about 400 μg to about 2000 μg, about 425 μg to about 2000 μg, about 450 μg to about 2000 μg, about 475 μg to about 2000 μg, about 500 μg to about 2000 μg, about 525 μg to about 2000 μg, about 550 μg to about 2000 μg, about 575 μg to about 2000 μg, about 600 μg to about 2000 μg, about 625 μg to about 2000 μg, about 650 μg to about 2000 μg, about 675 μg to about 2000 μg, about 700 μg to about 2000 μg, about 725 μg to about 2000 μg, about 750 μg to about 2000 μg, about 775 μg to about 2000 μg, about 800 μg to about 2000 μg, about 825 μg to about 2000 μg, about 850 μg to about 2000 μg, about 875 μg to about 2000 μg, about 900 μg to about 2000 μg, about 925 μg to about 2000 μg, about 950 μg to about 2000 μg, about 975 μg to about 2000 μg, 1000 μg to about 2000 μg, about 1050 μg to about 2000 μg, about 1100 μg to about 2000 μg, about 1150 μg to about 2000 μg, about 1200 μg to about 2000 μg, about 1250 μg to about 2000 μg, about 1300 μg to about 2000 μg, about 1350 μg to about 2000 μg, about 1400 μg to about 2000 μg, about 1450 μg to about 2000 μg, about 1500 μg to about 2000 μg, about 1550 μg to about 2000 μg, about 1600 μg to about 2000 μg, about 1650 μg to about 2000 μg, about 1700 μg to about 2000 μg, about 1750 μg to about 2000 μg, about 1800 μg to about 2000 μg, about 1850 μg to about 2000 μg, about 1900 μg to about 2000 μg, or about 1950 μg to about 2000 μg per gram of the nutritional powder.

In still other embodiments, the one or more isoflavones may be present in the nutritional powder at about 15 μg to about 1900 μg, about 20 μg to about 1800 μg, about 25 μg to about 1700 μg, about 30 μg to about 1600 μg, about 35 μg to about 1500 μg, about 40 μg to about 1400 μg, about 45 μg to about 1300 μg, about 50 μg to about 1200 μg, about 55 μg to about 1100 μg, about 60 μg to about 1000 μg, about 65 μg to about 950 μg, about 70 μg to about 900 μg, about 75 μg to about 850 μg, about 80 μg to about 800 μg, about 85 μg to about 750 μg, about 90 μg to about 700 μg, about 95 μg to about 650 μg, or about 100 μg to about 600 μg per gram of nutritional powder.

In some embodiments, the one or more isoflavones may be present in the nutritional powder at about 10 μg to about 50 μg, about 15 μg to about 50 μg, about 20 μg to about 50 μg, about 25 μg to about 50 μg, about 30 μg to about 50 μg, about 35 μg to about 50 μg, about 40 μg to about 50 μg, about 45 μg to about 50 μg, about 10 μg to about 45 μg, about 10 μg to about 40 μg, about 10 μg to about 35 μg, about 10 μg to about 30 μg, about 10 μg to about 25 μg, about 10 μg to about 20 μg, or about 10 μg to about 15 μg, or about 10 μg, about 11 rig, about 12 μg, about 13 μg, about 14 μg, about 15 μg, about 16 μg, about 17 μg, about 18 μg, about 19 μg, about 20 μg, about 21 μg, about 22 μg, about 23 μg, about 24 μg, about 25 μg, about 26 μg, about 27 μg, about 28 μg, about 29 μg, about 30 μg, about 31 μg, about 32 μg, about 33 μg, about 34 μg, about 35 μg, about 36 μg, about 37 μg, about 38 μg, about 39 μg, about 40 μg, about 41 μg, about 42 μg, about 43 μg, about 44 μg, about 45 μg, about 46 μg, about 47 μg, about 48 μg, about 49 μg, or about 50 μg per gram of nutritional powder.

In other embodiments, the one or more isoflavones may be present in the nutritional powder at about 10 μg to about 50 μg, about 15 μg to about 50 μg, about 20 μg to about 50 μg, about 25 μg to about 50 μg, about 30 μg to about 50 μg, about 35 μg to about 50 μg, about 40 μg to about 50 μg, about 45 μg to about 50 μg, about 10 μg to about 45 μg, about 10 μg to about 40 μg, about 10 μg to about 35 μg, about 10 μg to about 30 μg, about 10 μg to about 25 μg, about 10 μg to about 20 μg, or about 10 μg to about 15 μg, or about 10 μg, about 11 rig, about 12 μg, about 13 μg, about 14 μg, about 15 μg, about 16 μg, about 17 μg, about 18 μg, about 19 μg, about 20 μg, about 21 μg, about 22 μg, about 23 μg, about 24 μg, about 25 μg, about 26 μg, about 27 μg, about 28 μg, about 29 μg, about 30 μg, about 31 μg, about 32 μg, about 33 μg, about 34 μg, about 35 μg, about 36 μg, about 37 μg, about 38 μg, about 39 μg, about 40 μg, about 41 μg, about 42 μg, about 43 μg, about 44 μg, about 45 μg, about 46 μg, about 47 μg, about 48 μg, about 49 μg, or about 50 μg per gram of nutritional powder such that these ranges may be associated with a reduced isoflavone soy protein isolate.

The one or more isoflavones may include about 0.5% to about 75%, about 1% to about 60%, or about 5% to about 50% daidzein. The one or more isoflavones may include about 0.1% to about 75%, about 0.5% to about 60%, or about 1% to about 50% glycitein. The one or more isoflavones may include about 5% to about 95%, about 7% to about 93%, or about 10% to about 90% genistein. In other embodiments, the one or more isoflavones may include about 0.5% to about 75%, about 1% to about 60%, or about 5% to about 50% daidzein; about 0.1% to about 75%, about 0.5% to about 60%, or about 1% to about 50% glycitein; or about 5% to about 95%, about 7% to about 93%, or about 10% to about 90% genistein, or any combination thereof.

The isoflavone glycitein may provide antioxidant activity, cholesterol lowering activity, radical scavenging, and/or cytoprotection.

(13) Phytosterols

The protein and/or oil, which are described above, may be the source of the one or more phytosterols in the nutritional powder. The one or more phytosterols may reduce serum or plasma total cholesterol and/or low density lipoprotein (LDL) levels in the subject after ingestion and digestion of the nutritional formula, which is described below in more detail. The one or more phytosterols may exhibit one or more anti-tumor properties in the subject after ingestion and digestion of the nutritional formula.

The one or more phytosterols may be β-sitosterol, campesterol, stigmasterol, brassicasterol, δ5-avenasterol, or any combination thereof.

The one or more phytosterols may be present in the nutritional powder at about 1 milligram (mg) to about 1000 mg, about 1 mg to about 975 mg, about 1 mg to about 950 mg, about 1 mg to about 925 mg, about 1 mg to about 900 mg, about 1 mg to about 875 mg, about 1 mg to about 850 mg, about 1 mg to about 825 mg, about 1 mg to about 800 mg, about 1 mg to about 775 mg, about 1 mg to about 750 mg, about 1 mg to about 725 mg, about 1 mg to about 700 mg, about 1 mg to about 675 mg, about 1 mg to about 650 mg, about 1 mg to about 625 mg, about 1 mg to about 600 mg, about 1 mg to about 575 mg, about 1 mg to about 550 mg, about 1 mg to about 525 mg, about 1 mg to about 500 mg, about 1 mg to about 475 mg, about 1 mg to about 450 mg, about 1 mg to about 425 mg, about 1 mg to about 400 mg, about 1 mg to about 375 mg, about 1 mg to about 350 mg, about 1 mg to about 325 mg, about 1 mg to about 300 mg, about 1 mg to about 275 mg, about 1 mg to about 250 mg, about 1 mg to about 225 mg, about 1 mg to about 200 mg, about 1 mg to about 175 mg, about 1 mg to about 150 mg, about 1 mg to about 125 mg, about 1 mg to about 100 mg, about 1 mg to about 95 mg, about 1 mg to about 90 mg, about 1 mg to about 85 mg, about 1 mg to about 80 mg, about 1 mg to about 75 mg, about 1 mg to about 70 mg, about 1 mg to about 65 mg, about 1 mg to about 60 mg, about 1 mg to about 55 mg, about 1 mg to about 50 mg, about 1 mg to about 45 mg, about 1 mg to about 40 mg, about 1 mg to about 35 mg, about 1 mg to about 30 mg, about 1 mg to about 25 mg, about 1 mg to about 20 mg, about 1 mg to about 15 mg, about 1 mg to about 10 mg, or about 1 mg to about 5 mg per 100 gram (g) of the nutritional powder.

In other embodiments, the one or more phytosterols may be present in nutritional powder at about 5 mg to about 1000 mg, about 10 mg to about 1000 mg, about 15 mg to about 1000 mg, about 20 mg to about 1000 mg, about 25 mg to about 1000 mg, about 25 mg to about 1000 mg, about 30 mg to about 1000 mg, about 35 mg to about 1000 mg, about 40 mg to about 1000 mg, about 45 mg to about 1000 mg, about 50 mg to about 1000 mg, about 55 mg to about 1000 mg, about 60 mg to about 1000 mg, about 65 mg to about 1000 mg, about 70 mg to about 1000 mg, about 75 mg to about 1000 mg, about 80 mg to about 1000 mg, about 85 mg to about 1000 mg, about 90 mg to about 1000 mg, about 95 mg to about 1000 mg, about 100 mg to about 1000 mg, about 125 mg to about 1000 mg, about 150 mg to about 1000 mg, about 175 mg to about 1000 mg, about 200 mg to about 1000 mg, about 225 mg to about 1000 mg, about 250 mg to about 1000 mg, about 275 mg to about 1000 mg, about 300 mg to about 1000 mg, about 325 mg to about 1000 mg, about 350 mg to about 1000 mg, about 375 mg to about 1000 mg, about 400 mg to about 1000 mg, about 425 mg to about 1000 mg, about 450 mg to about 1000 mg, about 475 mg to about 1000 mg, about 500 mg to about 1000 mg, about 525 mg to about 1000 mg, about 550 mg to about 1000 mg, about 575 mg to about 1000 mg, about 600 mg to about 1000 mg, about 625 mg to about 1000 mg, about 650 mg to about 1000 mg, about 675 mg to about 1000 mg, about 700 mg to about 1000 mg, about 725 mg to about 1000 mg, about 750 mg to about 1000 mg, about 775 mg to about 1000 mg, about 800 mg to about 1000 mg, about 825 mg to about 1000 mg, about 850 mg to about 1000 mg, about 875 mg to about 1000 mg, about 900 mg to about 1000 mg, about 925 mg to about 1000 mg, about 950 mg to about 1000 mg, or about 975 mg to about 1000 mg per 100 grams of the nutritional powder.

In still other embodiments, the one or more phytosterols may be present in the nutritional powder at about 5 mg to about 975 mg, about 10 mg to about 950 mg, about 15 mg to about 925 mg, about 20 mg to about 875 mg, about 25 mg to about 850 mg, about 30 mg to about 825 mg, about 35 mg to about 800 mg, about 40 mg to about 775 mg, about 45 mg to about 750 mg, about 50 mg to about 725 mg, about 55 mg to about 700 mg, about 60 mg to about 675 mg, about 65 mg to about 650 mg, about 70 mg to about 625 mg, about 75 mg to about 600 mg, about 80 mg to about 575 mg, about 85 mg to about 550 mg, about 90 mg to about 525 mg, about 95 mg to about 500 mg, about 100 mg to about 475 mg, about 125 mg to about 450 mg, about 150 mg to about 425 mg, about 175 mg to about 400 mg, or about 200 mg to about 375 mg per 100 grams of the nutritional powder.

The one or more phytosterols may include about 2% to about 95% β-sitosterol, about 5% to about 87% β-sitosterol, or about 10% to about 80% β-sitosterol. The one or more phytosterols may include about 0.5% to about 75% campesterol, about 2% to about 60% campesterol, or about 5% to about 50% campesterol. The one or more phytosterols may include about 0.5% to about 75% stigmasterol, about 2% to about 60% stigmasterol, or about 5% to about 50% stigmasterol. The one or more phytosterols may include about 0.1% to about 50% brassicasterol, about 0.5% to about 40% brassicasterol, or about 1% to about 30% brassicasterol. The one or more phytosterols may include about 0.1% to about 50% δ5-avenasterol, about 0.5% to about 40% δ5-avenasterol, or about 1% to about 30% δ5-avenasterol. The one or more phytosterols may include about 2% to about 95% β-sitosterol, about 5% to about 87% β-sitosterol, or about 10% to about 80% β-sitosterol; about 0.5% to about 75% campesterol, about 2% to about 60% campesterol, or about 5% to about 50% campesterol; about 0.5% to about 75% stigmasterol, about 2% to about 60% stigmasterol, or about 5% to about 50% stigmasterol; about 0.1% to about 50% brassicasterol, about 0.5% to about 40% brassicasterol, or about 1% to about 30% brassicasterol; or about 0.1% to about 50% δ5-avenasterol, about 0.5% to about 40% δ5-avenasterol, or about 1% to about 30% δ5-avenasterol, or any combination thereof.

(14) Polyphenols

The protein and/or oil, which are described above, may the source of the one or more polyphenols in the nutritional powder. Additional sources of the one or more polyphenols in the nutritional powder may be, but are not limited to, soy protein (i.e., isoflavones from soy protein), cocoa powder (i.e., cocoa polyphenols), green tea polyphenols (e.g., catechins, EGCg, which is a strong antioxidant), and plum polyphenols (e.g., anthocyanins, chlorogenic acid, rutin, and proanthocyandins). Soy protein may contain about 0.5 mg to about 5 mg of total isoflavones per gram of soy protein. Cocoa powder may contain about 10 mg to about 60 mg of total polyphenols per gram of cocoa powder.

The one or more polyphenols may be present in the nutritional powder at about 0.0 mg to about 20.0 mg, about 0.1 mg to about 20.0 mg, about 0.2 mg to about 20.0 mg, about 0.3 mg to about 20.0 mg, about 0.4 mg to about 20.0 mg, about 0.5 mg to about 20.0 mg, about 0.6 mg to about 20.0 mg, about 0.7 mg to about 20.0 mg, about 0.8 mg to about 20.0 mg, about 0.9 mg to about 20.0 mg, about 1.0 mg to about 20.0 mg, about 1.5 mg to about 20.0 mg, about 2.0 mg to about 20.0 mg, about 2.5 mg to about 20.0 mg, about 3.0 mg to about 20.0 mg, about 3.5 mg to about 20.0 mg, about 4.0 mg to about 20.0 mg, about 4.5 mg to about 20.0 mg, about 5.0 mg to about 20.0 mg, about 5.5 mg to about 20.0 mg, about 6.0 mg to about 20.0 mg, about 6.5 mg to about 20.0 mg, about 7.0 mg to about 20.0 mg, about 7.5 mg to about 20.0 mg, about 8.0 mg to about 20.0 mg, about 8.5 mg to about 20.0 mg, about 9.0 mg to about 20.0 mg, about 9.5 mg to about 20.0 mg, about 10.0 mg to about 20.0 mg, about 10.5 mg to about 20.0 mg, about 11.0 mg to about 20.0 mg, about 11.5 mg to about 20.0 mg, about 12.0 mg to about 20.0 mg, about 12.5 mg to about 20.0 mg, about 13.0 mg to about 20.0 mg, about 13.5 mg to about 20.0 mg, about 14.0 mg to about 20.0 mg, about 14.5 mg to about 20.0 mg, about 15.0 mg to about 20.0 mg, about 15.5 mg to about 20.0 mg, about 16.0 mg to about 20.0 mg, about 16.5 mg to about 20.0 mg, about 17.0 mg to about 20.0 mg, about 17.5 mg to about 20.0 mg, about 18.0 mg to about 20.0 mg, about 18.5 mg to about 20.0 mg, about 19.0 mg to about 20.0 mg, about 0.0 mg to about 19.5 mg, about 0.0 mg to about 19.0 mg, about 0.0 mg to about 18.5 mg, about 0.0 mg to about 18.0 mg, about 0.0 mg to about 17.5 mg, about 0.0 mg to about 17.0 mg, about 0.0 mg to about 16.5 mg, about 0.0 mg to about 16.0 mg, about 0.0 mg to about 15.5 mg, about 0.0 mg to about 15.0 mg, about 0.0 mg to about 14.5 mg, about 0.0 mg to about 14.0 mg, about 0.0 mg to about 13.5 mg, about 0.0 mg to about 13.0 mg, about 0.0 mg to about 12.5 mg, about 0.0 mg to about 12.0 mg, about 0.0 mg to about 11.5 mg, about 0.0 mg to about 11.0 mg, about 0.0 mg to about 10.5 mg, about 0.0 mg to about 10.0 mg, about 0.0 mg to about 9.5 mg, about 0.0 mg to about 9.0 mg, about 0.0 mg to about 8.5 mg, about 0.0 mg to about 8.0 mg, about 0.0 mg to about 7.5 mg, about 0.0 mg to about 7.0 mg, about 0.0 mg to about 6.5 mg, about 0.0 mg to about 6.0 mg, about 0.0 mg to about 5.5 mg, about 0.0 mg to about 5.0 mg, about 0.0 mg to about 4.5 mg, about 0.0 mg to about 4.0 mg, about 0.0 mg to about 3.5 mg, about 0.0 mg to about 3.0 mg, about 0.0 mg to about 2.5 mg, about 0.0 mg to about 2.0 mg, about 0.0 mg to about 1.5 mg, about 0.0 mg to about 1.0 mg, about 0.0 mg to about 0.9 mg, about 0.0 mg to about 0.8 mg, about 0.0 mg to about 0.7 mg, about 0.0 mg to about 0.6 mg, about 0.0 mg to about 0.5 mg, about 0.0 mg to about 0.4 mg, about 0.0 mg to about 0.3 mg, about 0.0 mg to about 0.2 mg, or about 0.0 mg to about 0.1 mg, or about 0.0 mg, about 0.1 mg, about 0.2 mg, about 0.3 mg, about 0.4 mg, about 0.5 mg, about 0.6 mg, about 0.7 mg, about 0.8 mg, about 0.9 mg, about 1.0 mg, about 1.5 mg, about 2.0 mg, about 2.5 mg, about 3.0 mg, about 3.5 mg, about 4.0 mg, about 4.5 mg, about 5.0 mg, about 5.5 mg, about 6.0 mg, about 6.5 mg, about 7.0 mg, about 7.5 mg, about 8.0 mg, about 8.5 mg, about 9.0 mg, about 9.5 mg, about 10.0 mg, about 10.5 mg, about 11.0 mg, about 11.5 mg, about 12.0 mg, about 12.5 mg, about 13.0 mg, about 13.5 mg, about 14.0 mg, about 14.5 mg, about 15.0 mg, about 15.5 mg, about 16.0 mg, about 16.5 mg, about 17.0 mg, about 17.5 mg, about 18.0 mg, about 18.5 mg, about 19.0 mg, about 19.5 mg, or about 20.0 mg per gram of the nutritional powder.

(15) Optional Ingredients in the Nutritional Powder

The nutritional powders described herein may further comprise other optional ingredients that may modify the physical, chemical, hedonic or processing characteristics of the products or serve as additional nutritional components when used for a targeted population. Many such optional ingredients are known or otherwise suitable for use in other nutritional products and may also be used in the nutritional powders described herein, provided that such optional ingredients are safe and effective for oral administration and are compatible with the essential and other ingredients in the selected product form.

Non-limiting examples of such optional ingredients include preservatives, antioxidants, emulsifying agents, buffers, additional nutrients as described herein, colorants, flavors, thickening agents, stabilizers, and so forth.

The nutritional powders may further comprise minerals, non-limiting examples of which include calcium, phosphorus, magnesium, iron, zinc, manganese, copper, sodium, potassium, molybdenum, chromium, selenium, chloride, and combinations thereof.

The nutritional powders may further comprise vitamins or related nutrients, non-limiting examples of which include vitamin A, vitamin D, vitamin E, vitamin K, thiamine, riboflavin, pyridoxine, vitamin B12, other carotenoids, niacin, folic acid, pantothenic acid, biotin, vitamin C, choline, inositol, salts and derivatives thereof, and combinations thereof.

In some embodiments, the nutritional powders may comprise a compound selected from the group of beta-hydroxyl beta-methyl butyrate, L-leucine, beta-alanine, epigallocatechin gallate, human milk oligosaccharides, prebiotics, probiotics, and combinations thereof.

The nutritional powders may also include one or more masking agents to reduce or otherwise obscure bitter flavors and after taste. Suitable masking agents include natural and artificial sweeteners, sodium sources such as sodium chloride, and hydrocolloids, such as guar gum, xanthan gum, carrageenan, gellan gum, and combinations thereof. The amount of masking agent in the nutritional powder may vary depending upon the particular masking agent selected, other ingredients in the nutritional powder, and other nutritional powder or product target variables. Such amounts, however, most typically range from at least 0.1 wt %, including from about 0.15 wt % to about 3.0 wt %, and also including from about 0.18 wt % to about 2.5 wt %, by weight of the nutritional powder.

b. Pod

The nutrient delivery system may comprise a disposable dispenser container or pod having a container body and a flexible lid that collectively define an enclosed volume. The pod contains the nutritional powder. The nutrient delivery system provides water at a particular temperature as indicated above to the pod, to create a mixture of the nutritional powder and water and thereby provide the nutritional formula. The nutritional formula is delivered from the pod to a receptacle such as a cup or baby bottle by the nutrient delivery system. In some embodiments, a stick pack can be used in place of a pod.

A pod is a disposable container having a container body and a flexible lid that collectively define an enclosed volume. The container body includes a generally arcuate bottom wall and a side wall extending from and integrally formed as one piece with the bottom wall and terminating in a generally flat rim or flange at an open upper end of the container. The enclosed volume may range from approximately 60 milliliters (mL) to approximately 500 mL, e.g., from approximately 60 mL to approximately 170 mL, or from approximately 80 mL to approximately 100 mL, in one or more chambers. For example, the volume may be approximately 60 mL, 61 mL, 62 mL, 63 mL, 64 mL, 65 mL, 66 mL, 67 mL, 68 mL, 69 mL, 70 mL, 71 mL, 72 mL, 73 mL, 74 mL, 75 mL, 76 mL, 77 mL, 78 mL, 79 mL, 80 mL, 81 mL, 82 mL, 83 mL, 84 mL, 85 mL, 86 mL, 87 mL, 88 mL, 89 mL, 90 mL, 91 mL, 92 mL, 93 mL, 94 mL, 95 mL, 96 mL, 97 mL, 98 mL, 99 mL, 100 mL, 101 mL, 102 mL, 103 mL, 104 mL, 105 mL, 106 mL, 107 mL, 108 mL, 109 mL, 110 mL, 111 mL, 112 mL, 113 mL, 114 mL, 115 mL, 116 mL, 117 mL, 118 mL, 119 mL, 120 mL, 121 mL, 122 mL, 123 mL, 124 mL, 125 mL, 126 mL, 127 mL, 128 mL, 129 mL, 130 mL, 131 mL, 132 mL, 133 mL, 134 mL, 135 mL, 136 mL, 137 mL, 138 mL, 139 mL, 140 mL, 141 mL, 142 mL, 143 mL, 144 mL, 145 mL, 146 mL, 147 mL, 148 mL, 149 mL, 150 mL, 151 mL, 152 mL, 153 mL, 154 mL, 155 mL, 156 mL, 157 mL, 158 mL, 159 mL, 160 mL, 161 mL, 162 mL, 163 mL, 164 mL, 165 mL, 166 mL, 167 mL, 168 mL, 169 mL, 170 mL, 171 mL, 172 mL, 173 mL, 174 mL, 175 mL, 176 mL, 177 mL, 178 mL, 179 mL, 180 mL, 181 mL, 182 mL, 183 mL, 184 mL, 185 mL, 186 mL, 187 mL, 188 mL, 189 mL, 190 mL, 191 mL, 192 mL, 193 mL, 194 mL, 195 mL, 196 mL, 197 mL, 198 mL, 199 mL, 200 mL, 210 mL, 220 mL, 230 mL, 240 mL, 250 mL, 260 mL, 270 mL, 280 mL, 290 mL, 300 mL, 310 mL, 320 mL, 330 mL, 340 mL, 350 mL, 360 mL, 370 mL, 380 mL, 390 mL, 400 mL, 410 mL, 420 mL, 430 mL, 440 mL, 450 mL, 460 mL, 470 mL, 480 mL, 490 mL, or 500 mL. The bottom wall and side wall together define an internal surface having an area ranging from approximately 20 square centimeters (cm²) to approximately 75 cm², and preferably between approximately 24 cm² and approximately 60 cm². For example, the area may be 20 cm², 21 cm², 22 cm², 23 cm², 24 cm², 25 cm², 26 cm², 27 cm², 28 cm², 29 cm², 30 cm², 31 cm², 32 cm², 33 cm², 34 cm², 35 cm², 36 cm², 37 cm², 38 cm², 39 cm², 40 cm², 41 cm², 42 cm², 43 cm², 44 cm², 45 cm², 46 cm², 47 cm², 48 cm², 49 cm², 50 cm², 51 cm², 52 cm², 53 cm², 54 cm², 55 cm², 56 cm², 57 cm², 58 cm², 59 cm², 60 cm², 61 cm², 62 cm², 63 cm², 64 cm², 65 cm², 66 cm², 67 cm², 68 cm², 69 cm², 70 cm², 71 cm², 72 cm², 73 cm², 74 cm², 75 cm², 76 cm², 77 cm², 78 cm², 79 cm², 80 cm², 81 cm², 82 cm², 83 cm², 84 cm², 85 cm², 86 cm², 87 cm², 88 cm², 89 cm², 90 cm², 91 cm², 92 cm², 93 cm², 94 cm², 95 cm², 96 cm², 97 cm², 98 cm², 99 cm², 100 cm², 101 cm², 102 cm², 103 cm², 104 cm², 105 cm², 106 cm², 107 cm², 108 cm², 109 cm², 110 cm², 111 cm², 112 cm², 113 cm², 114 cm², 115 cm², 116 cm², 117 cm², 118 cm², 119 cm², 120 cm², 121 cm², 122 cm², 123 cm², 124 cm², 125 cm², 126 cm², 127 cm², 128 cm², 129 cm², 130 cm², 131 cm², 132 cm², 133 cm², 134 cm², 135 cm², 136 cm², 137 cm², 138 cm², 139 cm², 140 cm², 141 cm², 142 cm², 143 cm², 144 cm², 145 cm², 146 cm², 147 cm², 148 cm², 149 cm², 150 cm², 151 cm², 152 cm², 153 cm², 154 cm², 155 cm², 156 cm², 157 cm², 158 cm², 159 cm², or 160 cm².

The pod is sized to receive from approximately 2 grams to approximately 150 grams, or between approximately 7.5 grams and approximately 35 grams, of a substantially soluble nutritional powder or liquid concentrate through the open upper end, after which the lid is hermetically sealed to the flange. For example, the pod may receive approximately 2.0 g, 2.5 g, 3.0 g, 3.5 g, 4.0 g, 4.5 g, 5.0 g, 5.5 g, 6.0 g, 6.5 g, 7.0 g, 7.5 g, 8.0 g, 8.5 g, 9.0 g, 9.5 g, 10 g, 10.5 g, 11 g, 11.5 g, 12 g, 12.5 g, 13 g, 13.5 g, 14 g, 14.5 g, 15 g, 15.5 g, 16 g, 16.5 g, 17 g, 17.5 g, 18 g, 18.5 g, 19 g, 19.5 g, 20 g, 20.5 g, 21 g, 21.5 g, 22 g, 22.5 g, 23 g, 23.5 g, 24 g, 24.5 g, 25 g, 25.5 g, 26 g, 26.5 g, 27 g, 27.5 g, 28 g, 28.5 g, 29 g, 29.5 g, 30 g, 30.5 g, 31 g, 31.5 g, 32 g, 32.5 g, 33 g, 33.5 g, 34 g, 34.5 g, 35 g, 35.5 g, 36 g, 36.5 g, 37 g, 37.5 g, 38 g, 38.5 g, 39 g, 39.5 g, 40 g, 40.5 g, 41 g, 41.5 g, 42 g, 42.5 g, 43 g, 43.5 g, 44 g, 44.5 g, 45 g, 45.5 g, 46 g, 46.5 g, 47 g, 47.5 g, 48 g, 48.5 g, 49 g, 49.5 g, 50 g, 50.5 g, 51.0 g, 51.5 g, 52.0 g, 52.5 g, 53.0 g, 53.5 g, 54.0 g, 54.5 g, 55.0 g, 55.5 g, 56.0 g, 56.5 g, 57.0 g, 57.5 g, 58.0 g, 58.5 g, 59.0 g, 59.5 g, 60.0 g, 60.5 g, 61.0 g, 61.5 g, 62.0 g, 62.5 g, 63.0 g, 63.5 g, 64.0 g, 64.5 g, 65.0 g, 65.5 g, 66.0 g, 66.5 g, 67.0 g, 67.5 g, 68.0 g, 68.5 g, 69.0 g, 69.5 g, 70.0 g, 70.5 g, 71.0 g, 71.5 g, 72.0 g, 72.5 g, 73.0 g, 73.5 g, 74.0 g, 74.5 g, 75.0 g, 75.5 g, 76.0 g, 76.5 g, 77.0 g, 77.5 g, 78.0 g, 78.5 g, 79.0 g, 79.5 g, 80.0 g, 80.5 g, 81.0 g, 81.5 g, 82.0 g, 82.5 g, 83.0 g, 83.5 g, 84.0 g, 84.5 g, 85.0 g, 85.5 g, 86.0 g, 86.5 g, 87.0 g, 87.5 g, 88.0 g, 88.5 g, 89.0 g, 89.5 g, 90.0 g, 90.5 g, 91.0 g, 91.5 g, 92.0 g, 92.5 g, 93.0 g, 93.5 g, 94.0 g, 94.5 g, 95.0 g, 95.5 g, 96.0 g, 96.5 g, 97.0 g, 97.5 g, 98.0 g, 98.5 g, 99.0 g, 99.5 g, 100.0 g, 100.5 g, 101.0 g, 101.5 g, 102.0 g, 102.5 g, 103.0 g, 103.5 g, 104.0 g, 104.5 g, 105.0 g, 105.5 g, 106.0 g, 106.5 g, 107.0 g, 107.5 g, 108.0 g, 108.5 g, 109.0 g, 109.5 g, 110 g, 110.5 g, 111 g, 111.5 g, 112 g, 112.5 g, 113 g, 113.5 g, 114 g, 114.5 g, 115 g, 115.5 g, 116 g, 116.5 g, 117 g, 117.5 g, 118 g, 118.5 g, 119 g, 119.5 g, 120 g, 120.5 g, 121 g, 121.5 g, 122 g, 122.5 g, 123 g, 123.5 g, 124 g, 124.5 g, 125 g, 125.5 g, 126 g, 126.5 g, 127 g, 127.5 g, 128 g, 128.5 g, 129 g, 129.5 g, 130 g, 130.5 g, 131 g, 131.5 g, 132 g, 132.5 g, 133 g, 133.5 g, 134 g, 134.5 g, 135 g, 135.5 g, 136 g, 136.5 g, 137 g, 137.5 g, 138 g, 138.5 g, 139 g, 139.5 g, 140 g, 140.5 g, 141 g, 141.5 g, 142 g, 142.5 g, 143 g, 143.5 g, 144 g, 144.5 g, 145 g, 145.5 g, 146 g, 146.5 g, 147 g, 147.5 g, 148 g, 148.5 g, 149 g, 149.5 g, or 150 g of the substantially soluble nutritional powder or liquid concentrate. The substantially soluble nutritional powder or liquid concentrate may occupy about 60% to about 90% of the volume of the pod, e.g., about 60%, 65%, 70%, 75%, 80%, 85% or 90% of the volume of the pod.

The container body is molded or otherwise constructed of a food-safe plastic material, such as polypropylene or polyethylene. The lid can be made of a polymer film, metal foil, or any other material suitable for affixing to the flange. At least one of the lid and the container body is configured to receive an injector or similar device through which water, air, or other fluids may be introduced to facilitate mixing and reconstitution within the enclosed volume. The introduced fluid(s) may be pre-filtered or alternatively pass through a filtration unit disposed within the container. An outlet member integrally formed as part of or movably coupled to the container body is positioned for dispensing from the pod, with the assistance of the introduced fluid(s), a nutritional product incorporating the powder or liquid concentrate. The dispensed product volume can range from approximately 5 mL to approximately 1000 mL, for example from approximately 20 mL to approximately 750 mL, from approximately 50 mL to approximately 500 mL, and is preferably between approximately 70 mL and approximately 250 mL. For example, the dispensed product volume may be approximately 5 mL, 10 mL, 15 mL, 20 mL, 25 mL, 30 mL, 35 mL, 40 mL, 45 mL, 50 mL, 55 mL, 60 mL, 65 mL, 70 mL, 75 mL, 80 mL, 85 mL, 90 mL, 95 mL, 100 mL, 105 mL, 110 mL, 115 mL, 120 mL, 125 mL, 130 mL, 135 mL, 140 mL, 145 mL, 150 mL, 155 mL, 160 mL, 165 mL, 170 mL, 175 mL, 180 mL, 185 mL, 190 mL, 195 mL, 200 mL, 205 mL, 210 mL, 215 mL, 220 mL, 225 mL, 230 mL, 235 mL, 240 mL, 245 mL, 250 mL, 255 mL, 260 mL, 265 mL, 270 mL, 275 mL, 280 mL, 290 mL, 300 mL, 305 mL, 310 mL, 315 mL, 320 mL, 325 mL, 330 mL, 335 mL, 340 mL, 345 mL, 350 mL, 355 mL, 360 mL, 365 mL, 370 mL, 375 mL, 380 mL, 385 mL, 390 mL, 395 mL, 400 mL, 405 mL, 410 mL, 415 mL, 420 mL, 425 mL, 430 mL, 435 mL, 440 mL, 445 mL, 450 mL, 455 mL, 460 mL, 465 mL, 470 mL, 475 mL, 480 mL, 490 mL, 500 mL, 505 mL, 510 mL, 515 mL, 520 mL, 525 mL, 530 mL, 535 mL, 540 mL, 545 mL, 550 mL, 555 mL, 560 mL, 565 mL, 570 mL, 575 mL, 580 mL, 585 mL, 590 mL, 595 mL, 600 mL, 605 mL, 610 mL, 615 mL, 620 mL, 625 mL, 630 mL, 635 mL, 640 mL, 645 mL, 650 mL, 655 mL, 660 mL, 665 mL, 670 mL, 675 mL, 680 mL, 690 mL, 700 mL, 705 mL, 710 mL, 715 mL, 720 mL, 725 mL, 730 mL, 735 mL, 740 mL, 745 mL, 750 mL, 755 mL, 760 mL, 765 mL, 770 mL, 775 mL, 780 mL, 785 mL, 790 mL, 795 mL, 800 mL, 805 mL, 810 mL, 815 mL, 820 mL, 825 mL, 830 mL, 835 mL, 840 mL, 845 mL, 850 mL, 855 mL, 860 mL, 865 mL, 870 mL, 875 mL, 880 mL, 890 mL, 900 mL, 905 mL, 910 mL, 915 mL, 920 mL, 925 mL, 930 mL, 935 mL, 940 mL, 945 mL, 950 mL, 955 mL, 960 mL, 965 mL, 970 mL, 975 mL, 980 mL, 985 mL, 990 mL, 995 mL, or 1000 mL. The temperature of the dispensed nutritional product is product dependent and can range from approximately 5° C. to approximately 60° C., or from approximately 25° C. to about 50° C. For example, the temperature may be approximately 5° C., 6° C., 7° C., 8° C., 9° C., 10° C., 11° C., 12° C., 13° C., 14° C., 15° C., 16° C., 17° C., 18° C., 19° C., 20° C., 21° C., 22° C., 23° C., 24° C., 25° C., 26° C., 27° C., 28° C., 29° C., 30° C., 31° C., 32° C., 33° C., 34° C., 35° C., 36° C., 37° C., 38° C., 39° C., 40° C., 41° C., 42° C., 43° C., 44° C., 45° C., 46° C., 47° C., 48° C., 49° C., 50° C., 51° C., 52° C., 53° C., 54° C., 55° C., 56° C., 57° C., 58° C., 59° C., or 60° C.

c. Nutritional Formula

As discussed above, the nutrient delivery system may comprise a nutritional powder that is within a pod. The nutrient delivery system delivers water at a particular temperature to the nutritional powder within the pod, and provides a nutritional formula. The nutritional formula is delivered from the pod to a receptacle such as a cup or baby bottle. The physical characteristics that are important for the overall function of the nutritional formula include the powder reconstitution characteristics (e.g., wettability), viscosity, foaming, emulsion stability, amino acid profile, mineral delivery, antioxidant capacity, shelf-life stability, odor, flavor, and digestibility.

The nutritional powder, as described above, includes protein. The protein may bind a mineral, for example, such as, but not limited to, zinc and iron, such that upon ingestion of the nutritional formula by the subject, the mineral is delivered to the subject. The protein may also lend the nutritional formula improved digestibility relative to a nutritional formula that does not contain the protein in the amounts described above. In particular, digestibility may be improved when the protein has a degree of hydrolysis of about 0 to about 60. A degree of hydrolysis of about 0 to about 60 may also increase the solubility of the protein in the nutritional formula, which in turn, may increase the emulsion capacity of and mineral delivery by the nutritional formula. This degree of hydrolysis of about 0 to about 60 may not introduce detrimental features into the nutritional formula such as compromised sensory quality and decreased protein functionality.

Additionally, as described above in more detail, the protein may be a source of one or more isoflavones, one or more phytosterols, one or more polyphenols, or any combination thereof. The one or more isoflavones may provide antioxidant activity, cholesterol lowering activity, radical scavenging, and/or cytoprotection. The one or more phytosterols may reduce serum or plasma total cholesterol and/or low density lipoprotein (LDL) levels in the subject after ingestion and digestion of the nutritional formula by the subject. The one or more phytosterols may exhibit one or more anti-tumor properties in the subject after ingestion and digestion of the nutritional formula.

As described above in more detail, an additional source of the one or more isoflavones, the one or more phytosterols, and the one or more polyphenols may be a fat such as oil and thus, the nutritional powder may also include oil as described above in more detail.

(1) Viscosity

The nutritional formula may comprise a viscosity of about 0.8 to about 30 cPs. Viscosity is the measurement of resistance to gradual deformation by shear or tensile stress. The nutritional formula's viscosity may be dependent on the components that are comprised within the nutritional composition. The viscosity of the nutritional formula is important on the overall flow performance of the nutritional formula through the nutrient delivery system. The viscosity of the nutritional formula may be measured by a rheometer, which may be used to measure how a liquid, slurry, or suspension flows in response to applied forces. The rheometer may be a shear/rotational rheometer or an extensional rheometer. The shear/rotational rheometer may be a pipe/capillary rheometer, cone and plate rheometer, or linear shear rheometer. The extensional rheometer may be an acoustic rheometer, falling plate rheometer, or capillary/contraction flow rheometer. The viscosity of the nutritional formula may be about 0.8 to 30 cPs, about 0.8 to 10 cPs, about 1 to 9 cPs, or about 2 to 6 cPs. The viscosity of the nutritional formula may be less than 1 cPs, less than 2 cPs, less than 3 cPs, less than 4 cPs, less than 5 cPs, less than 6 cPs, less than 7 cPs, less than 8 cPs, less than 9 cPs, less than 10 cPs, less than 11 cPs, less than 12 cPs, less than 13 cPs, less than 14 cPs, less than 15 cPs, less than 16 cPs, less than 17 cPs, less than 18 cPs, less than 19 cPs, less than 20 cPs, less than 21 cPs, less than 22 cPs, less than 23 cPs, less than 24 cPs, less than 25 cPs, less than 26 cPs, less than 27 cPs, less than 28 cPs, less than 29 cPs, less than 30 cps, about 0.8 cPs, about 0.9 cPs, about 1 cPs, about 2 cPs, about 3 cPs, about 4 cPs, about 5 cPs, about 6 cPs, about 7 cPs, about 8 cPs, about 9 cPs, about 10 cPs, about 11 cPs, about 12 cPs, about 13 cPs, about 14 cPs, about 15 cPs, about 16 cPs, about 17 cPs, about 18 cPs, about 19 cPs, about 20 cPs, about 21 cPs, about 22 cPs, about 23 cPs, about 24 cPs, about 25 cPs, about 26 cPs, about 27 cPs, about 28 cPs, about 29 cPs, or about 30 cPs.

(2) Density

The nutritional formula may comprise a density between about 0.90 g/cm³ and about 1.2 g/cm³. The density of the nutritional formula is a function of the amount of entrapped air is present within the formula, among other factor, such as the compounds within the nutritional formula. The density of the nutritional formula is important in determining the flow characteristics of the formula, as well as well as side-effects associated with consumption of the formula (e.g., gassiness). The density of the nutritional formula may be about 0.90 g/cm³, 0.91 g/cm³, 0.92 g/cm³, 0.93 g/cm³, 0.94 g/cm³, 0.95 g/cm³, 0.96 g/cm³, 0.97 g/cm³, 0.98 g/cm³, 0.99 g/cm³, 1.00 g/cm³, 1.01 g/cm³, 1.02 g/cm³, 1.03 g/cm³, 1.04 g/cm³, 1.05 g/cm³, 1.06 g/cm³, 1.07 g/cm³, 1.08 g/cm³, 1.09 g/cm³, 1.10 g/cm³, 1.11 g/cm³, 1.12 g/cm³, 1.13 g/cm³, 1.14 g/cm³, 1.15 g/cm³, 1.16 g/cm³, 1.17 g/cm³, 1.18 g/cm³, 1.19 g/cm³, or 1.20 g/cm³.

(3) Color Scale Values

The nutritional formula may comprise a Hunter Lab “L” value between about 20 and about 100. The Hunter Lab “L” value is a measurement of the lightness of the formula. The lightness of the nutritional formula is dependent on, but not limited to, the wettability, emulsion stability, and emulsion homogeneity. The Hunter Lab “L” value of the nutritional formula can be measured by a spectrophotometer, which allows quantitative measurement of the reflection or transmission properties of the formula as a function of wavelength. The Hunter Lab “L” value of the nutritional formula may be about 20.00, 25.00, 30.00, 35.00, 40.00, 45.00, 50.00, 55.00, 60.00, 65.00, 70.00, 75.00, 80.00, 80.10, 80.15, 80.20, 80.25, 80.30, 80.35, 80.40, 80.45, 80.50, 80.55, 80.60, 80.65, 80.70, 80.75, 80.80, 80.85, 80.90, 80.95, 81.00, 81.10, 81.15, 81.20, 81.25, 81.30, 81.35, 81.40, 81.45, 81.50, 81.55, 81.60, 81.65, 81.70, 81.75, 81.80, 81.85, 81.90, 81.95, 82.00, 82.10, 82.15, 82.20, 82.25, 82.30, 82.35, 82.40, 82.45, 82.50, 82.55, 82.60, 82.65, 82.70, 82.75, 82.80, 82.85, 82.90, 82.95, 83.00, 83.10, 83.15, 83.20, 83.25, 83.30, 83.35, 83.40, 83.45, 83.50, 83.55, 83.60, 83.65, 83.70, 83.75, 83.80, 83.85, 83.90, 83.95, 84.00, 86.00, 88.00, 90.00, 95.00 or 100.00.

The nutritional formula may comprise a Hunter Lab “a” value between about −5.00 and about 1.00. The Hunter Lab “a” value is a measurement of the color-opponent dimension of a formula. The “a” value of the nutritional formula is dependent on, but not limited to, the wettability, emulsion stability, and emulsion homogeneity. The Hunter Lab “a” value of the nutritional formula can be measured by a spectrophotometer, which allows quantitative measurement of the reflection or transmission properties of the formula as a function of wavelength. The Hunter Lab “a” value of the nutritional formula may be about −5.00, −4.50, −4.00, −3.50, −3.00, −2.50, −2.00, −1.50, −1.00, −0.50, −0.10, −0.09, −0.08, −0.07, −0.06, −0.05, −0.04, −0.03, −0.02, −0.01, 0, 0.01, 0.02, 0.03, 0.04, 0.05, 0.06, 0.07, 0.08, 0.09, 0.10, 0.11, 0.12, 0.13, 0.14, 0.15, 0.16, 0.17, 0.18, 0.19, 0.20, 0.22, 0.24, 0.26, 0.28, 0.3, 0.35, 0.40, 0.45, 0.50, 0.55, 0.60, 0.65, 0.70, 0.75, 0.80, 0.85, 0.90, or 1.00.

The nutritional formula may comprise a Hunter Lab “b” value between about 1 and about 30. The Hunter Lab “b” value is a measurement of the color-opponent dimension of a formula. The “b” value of the nutritional formula is dependent on, but not limited to, the wettability, emulsion stability, and emulsion homogeneity. The Hunter Lab “b” value of the nutritional formula can be measured by a spectrophotometer, which allows quantitative measurement of the reflection or transmission properties of the formula as a function of wavelength. The Hunter Lab “b” value of the nutritional formula may be about 1.00, 2.00, 3.00, 4.00, 5.00, 6.00, 7.00, 8.00, 9.00, 10.00, 11.00, 12.00, 13.00, 13.10, 13.20, 13.30, 13.31, 13.32, 13.33, 13.34, 13.35, 13.36, 13.37, 13.38, 13.39, 13.40, 13.41, 13.42, 13.43, 13.44, 13.45, 13.46, 13.47, 13.48, 13.49, 13.50, 13.51, 13.52, 13.53, 13.54, 13.55, 13.56, 13.57, 13.58, 13.59, 13.60, 13.61, 13.62, 13.63, 13.64, 13.65, 13.66, 13.67, 13.68, 13.69, 13.70, 13.71, 13.72, 13.73, 13.74, 13.75, 13.76, 13.77, 13.78, 13.79, 13.80, 13.81, 13.82, 13.83, 13.84, 13.85, 13.86, 13.87, 13.88, 13.89, 13.90, 13.91, 13.92, 13.93, 13.94, 13.95, 13.96, 13.97, 13.98, 13.99, 14.00, 15.00, 16.00, 17.00, 18.00, 19.00, 20.00, 25.00, or 30.00.

(4) Caloric Density

The nutritional formula produced by the nutrient delivery system may comprise a caloric density of about 65 kcal/240 mL to about 800 kcal/240 mL. The nutritional formula, as discussed herein, provides a method to easily and effectively control caloric intake to an individual (e.g., infant). The ability to tightly control caloric intake is important because different individuals have different caloric needs. The nutritional formula produced by the nutrient delivery system may comprise a caloric density of about 65 kcal/240 mL, 70 kcal/240 mL, 75 kcal/240 mL, 80 kcal/240 mL, 85 kcal/240 mL, 90 kcal/240 mL, 95 kcal/240 mL, 100 kcal/240 mL, 105 kcal/240 mL, 110 kcal/240 mL, 115 kcal/240 mL, 120 kcal/240 mL, 125 kcal/240 mL, 130 kcal/240 mL, 135 kcal/240 mL, 140 kcal/240 mL, 145 kcal/240 mL, 150 kcal/240 mL, 155 kcal/240 mL, 160 kcal/240 mL, 165 kcal/240 mL, 170 kcal/240 mL, 175 kcal/240 mL, 180 kcal/240 mL, 185 kcal/240 mL, 190 kcal/240 mL, 195 kcal/240 mL, 200 kcal/240 mL, 205 kcal/240 mL, 210 kcal/240 mL, 215 kcal/240 mL, 220 kcal/240 mL, 225 kcal/240 mL, 230 kcal/240 mL, 235 kcal/240 mL, 240 kcal/240 mL, 245 kcal/240 mL, 250 kcal/240 mL, 255 kcal/240 mL, 260 kcal/240 mL, 265 kcal/240 mL, 270 kcal/240 mL, 275 kcal/240 mL, 280 kcal/240 mL, 285 kcal/240 mL, 290 kcal/240 mL, 295 kcal/240 mL, 300 kcal/240 mL, 305 kcal/240 mL, 310 kcal/240 mL, 315 kcal/240 mL, 320 kcal/240 mL, 325 kcal/240 mL, 330 kcal/240 mL, 335 kcal/240 mL, 340 kcal/240 mL, 345 kcal/240 mL, 350 kcal/240 mL, 355 kcal/240 mL, 360 kcal/240 mL, 365 kcal/240 mL, 370 kcal/240 mL, 375 kcal/240 mL, 380 kcal/240 mL, 385 kcal/240 mL, 390 kcal/240 mL, 395 kcal/240 mL, 400 kcal/240 mL, 405 kcal/240 mL, 410 kcal/240 mL, 415 kcal/240 mL, 420 kcal/240 mL, 425 kcal/240 mL, 430 kcal/240 mL, 435 kcal/240 mL, 440 kcal/240 mL, 445 kcal/240 mL, 450 kcal/240 mL, 455 kcal/240 mL, 460 kcal/240 mL, 465 kcal/240 mL, 470 kcal/240 mL, 475 kcal/240 mL, 480 kcal/240 mL, 485 kcal/240 mL, 490 kcal/240 mL, 495 kcal/240 mL, 500 kcal/240 mL, 550 kcal/240 mL, 600 kcal/240 mL, 650 kcal/240 mL, 700 kcal/240 mL, 750 kcal/240 mL, or 800 kcal/240 mL.

(5) Dispersibility

The nutritional formula may comprise a qualitative dispersibility of about 1 to about 4. Dispersibility is way of determining the degree of firmness and solubility of particles within a product. Dispersibility is important in determining flow characteristics of the nutritional formula. Dispersibility is measured as how well the product will pass through the nipple of an infant bottle. For example, in a qualitative assay, an 8 ounce bottle may be prepared and shaken for 10 seconds. The product is then passed through an 80 mesh sieve and scored based on the number of remaining particles. The nutritional formula may comprise a dispersibility of about 1.0, 1.5, 2.0, 2.5, 3.0, 3.5, or 4.0. In a quantitative assay, the product is passed through an 80 mesh sieve as described above, and the total number of particles present on the sieve is measured using a mm stick and/or ruler. The size of the particles are then stratified into groups consisting of less than 1 mm, 1 mm, 2 mm, 3 mm, 4 mm, 5 mm and greater than 5 mm.

(6) Foaming

The nutritional formula may comprise a foaming volume of about 1 mL to about 70 mL, about 1 mL to about 30 mL, or about 1 mL to about 20 mL. Foaming of the nutritional formula can be attributed to the presence of entrapped air after the nutrient delivery system provides the nutritional formula, which is dependent on at least the compounds within the nutritional powder. Decreased foaming is a desired property of the nutritional formula because excess foam may increase potential side-effects that can be associated with consumption of the nutritional formula (e.g., gassiness, bloating, etc.). The foaming volume of the nutritional formula may be measured by a graduated cylinder after being provided by the nutrient delivery system. Additionally the foaming value may be measured at variable time points after initial addition to the graduated cylinder (e.g., 1 minute, 2 minutes, 3 minutes, 4 minutes, 5 minutes, 10 minutes, 15 minutes, or 30 minutes after the nutritional formula has been added to the graduated). The foaming volume may be about 1 mL, 2 mL, 3 mL, 4 mL, 5 mL, 6 mL, 7 mL, 8 mL, 9 mL, 10 mL, 11 mL, 12 mL, 13 mL, 14 mL, 15 mL, 16 mL, 17 mL, 18 mL, 19 mL, 20 mL, 21 mL, 22 mL, 23 mL, 24 mL, 25 mL, 26 mL, 27 mL, 28 mL, 29 mL, 30 mL, 31 mL, 32 mL, 33 mL, 34 mL, 35 mL, 36 mL, 37 mL, 38 mL, 39 mL, 40 mL, 41 mL, 42 mL, 43 mL, 44 mL, 45 mL, 46 mL, 47 mL, 48 mL, 49 mL, 50 mL, 51 mL, 52 mL, 53 mL, 54 mL, 55 mL, 56 mL, 57 mL, 58 mL, 59 mL, 60 mL, 61 mL, 62 mL, 63 mL, 64 mL, 65 mL, 66 mL, 67 mL, 68 mL, 69 mL, or 70 mL.

The nutritional formula may comprise a foaming ratio of about 1 to about 15. The foaming ratio of the nutritional formula is investigated by measuring the volume of foam within a graduated cylinder after being provided by the nutrient delivery system and at variable time points after initial addition to the graduated cylinder (e.g., 1 minute, 2 minutes, 3 minutes, 4 minutes, 5 minutes, 10 minutes, 15 minutes, or 30 minutes after the nutritional formula has been added to the graduated cylinder). The ratio of foaming level at time 0 and the variable time points are then measured for the sample. The foaming ratio of the nutritional formula may be about 1.0, 1.2, 1.4, 1.6, 1.8, 2.0, 2.2, 2.4, 2.6, 2.8, 3.0, 3.2, 3.4, 3.6, 3.8, 4.0, 4.2, 4.4, 4.6, 4.8, 5.0, 5.2, 5.4, 5.6, 5.8, 6.0, 6.2, 6.4, 6.6, 6.8, 7.0, 7.2, 7.4, 7.6, 7.8, 8.0, 8.2, 8.4, 8.6, 8.8, 9.0, 9.2, 9.4, 9.6, 9.8, 10, 10.2, 10.4, 10.6, 10.8, 11, 11.2, 11.4, 11.6, 11.8, 12, 12.2, 12.4, 12.6, 12.8, 13, 13.2, 13.4, 13.6, 13.8, 14, 14.2, 14.4, 14.6, 14.8, or 15.

d. Special Properties

The nutrient delivery system comprises the nutritional powder and provides the nutritional formula as described above. The nutritional powder and the nutritional formula may be assayed for various properties for quality assurance. One such property is sensory information, including smell and taste. Another such property is browning, which can provide an unpleasant appearance and which can decrease the value of a nutritional composition. Additional properties are protein digestibility of the nutritional formula and an amount of soluble protein in the nutritional powder.

(1) Sensory Analysis

Sensory tests provide useful information because they relate to the consumer acceptance of the food based on smell and taste. The method is very sensitive and provides information on flavor stability. All samples are evaluated by a trained taste panel to determine bitterness, sweetness, and fishiness of the samples. The sensory analysis is performed using a scale of 0 to 7, with 7 being the strongest sensation/flavor and 0 being the lowest. As such, lower values indicate less bitterness, sweetness and fishiness. The nutritional powder and nutritional formula may be evaluated at various time intervals. The nutritional powder and nutritional formula may also be evaluated for a beany off note.

The nutritional powder may have a bitterness score of less than 7, less than 6.5, less than 6, less than 5.5, less than 5, less than 4.5, less than 4, less than 3.5, less than 3, less than 2.5, less than 2, less than 1.5, less than 1, or less than 0.5. The nutritional powder may have a bitterness score of 7 or less, 6.5 or less, 6 or less, 5.5 or less, 5 or less, 4.5 or less, 4 or less, 3.5 or less, 3 or less, 2.5 or less, 2 or less, 1.5 or less, 1 or less, or 0.5 or less. The nutritional powder may have a bitterness score of 7, 6.5, 6, 5.5, 5, 4.5, 4, 3.5, 3, 2.5, 2, 1.5, 1, 0.5, or 0.

The nutritional formula may have a bitterness score of less than 7, less than 6.5, less than 6, less than 5.5, less than 5, less than 4.5, less than 4, less than 3.5, less than 3, less than 2.5, less than 2, less than 1.5, less than 1, or less than 0.5. The nutritional formula may have a bitterness score of 7 or less, 6.5 or less, 6 or less, 5.5 or less, 5 or less, 4.5 or less, 4 or less, 3.5 or less, 3 or less, 2.5 or less, 2 or less, 1.5 or less, 1 or less, or 0.5 or less. The nutritional formula may have a bitterness score of 7, 6.5, 6, 5.5, 5, 4.5, 4, 3.5, 3, 2.5, 2, 1.5, 1, 0.5, or 0.

The nutritional powder may have a sweetness score of less than 7, less than 6.5, less than 6, less than 5.5, less than 5, less than 4.5, less than 4, less than 3.5, less than 3, less than 2.5, less than 2, less than 1.5, less than 1, or less than 0.5. The nutritional powder may have a sweetness score of 7 or less, 6.5 or less, 6 or less, 5.5 or less, 5 or less, 4.5 or less, 4 or less, 3.5 or less, 3 or less, 2.5 or less, 2 or less, 1.5 or less, 1 or less, or 0.5 or less. The nutritional powder may have a sweetness score of 7, 6.5, 6, 5.5, 5, 4.5, 4, 3.5, 3, 2.5, 2, 1.5, 1, 0.5, or 0.

The nutritional formula may have a sweetness score of less than 7, less than 6.5, less than 6, less than 5.5, less than 5, less than 4.5, less than 4, less than 3.5, less than 3, less than 2.5, less than 2, less than 1.5, less than 1, or less than 0.5. The nutritional formula may have a sweetness score of 7 or less, 6.5 or less, 6 or less, 5.5 or less, 5 or less, 4.5 or less, 4 or less, 3.5 or less, 3 or less, 2.5 or less, 2 or less, 1.5 or less, 1 or less, or 0.5 or less. The nutritional formula may have a sweetness score of 7, 6.5, 6, 5.5, 5, 4.5, 4, 3.5, 3, 2.5, 2, 1.5, 1, 0.5, or 0.

The nutritional powder may have a fishiness score of less than 7, less than 6.5, less than 6, less than 5.5, less than 5, less than 4.5, less than 4, less than 3.5, less than 3, less than 2.5, less than 2, less than 1.5, less than 1, or less than 0.5. The nutritional powder may have a fishiness score of 7 or less, 6.5 or less, 6 or less, 5.5 or less, 5 or less, 4.5 or less, 4 or less, 3.5 or less, 3 or less, 2.5 or less, 2 or less, 1.5 or less, 1 or less, or 0.5 or less. The nutritional powder may have a fishiness score of 7, 6.5, 6, 5.5, 5, 4.5, 4, 3.5, 3, 2.5, 2, 1.5, 1, 0.5, or 0.

The nutritional formula may have a fishiness score of less than 7, less than 6.5, less than 6, less than 5.5, less than 5, less than 4.5, less than 4, less than 3.5, less than 3, less than 2.5, less than 2, less than 1.5, less than 1, or less than 0.5. The nutritional formula may have a fishiness score of 7 or less, 6.5 or less, 6 or less, 5.5 or less, 5 or less, 4.5 or less, 4 or less, 3.5 or less, 3 or less, 2.5 or less, 2 or less, 1.5 or less, 1 or less, or 0.5 or less. The nutritional formula may have a fishiness score of 7, 6.5, 6, 5.5, 5, 4.5, 4, 3.5, 3, 2.5, 2, 1.5, 1, 0.5, or 0.

The one or more isoflavones described above may lend a beany off note to the nutritional powder and/or the nutritional formula.

(2) Browning

The nutritional powder, and the nutritional formula provided by the nutrient delivery system, include a hydrolyzed protein and a masking agent. In some embodiments, the inclusion of a hydrolyzed protein and certain masking agents such as reducing sugars can lead to browning. Browning is the process of becoming brown, especially referring to food. Browning of the nutritional powder of the present invention is undesirable. Browning has an economic cost, causing deterioration of the value of products in the market of food. The nutritional powder and nutritional formulation may therefore include a compound that may inhibit browning, or may include ratios of components that are selected to minimize browning. Examples of methods used to inhibit browning include, but are not limited to, substituting a non-reducing sugar (e.g., sucrose) for a reducing sugar (e.g., lactose), substituting a low DE maltodextrin (e.g., Maltrin 40) for a high DE maltodextrin (e.g., Maltrin 200), substituting a low DH protein ingredient (e.g., DH 10%) for a high DH protein ingredient (e.g., DH 30%), decreasing the concentration of free amino acids, by decreasing the concentration of protein-bound lysine, lowering the pH, substituting sodium ascorbate for ascorbic acid, and/or substituting an iron amino acid chelate for ferrous sulfate.

Foods can turn brown through either enzymatic or non-enzymatic processes. Enzymatic browning is a chemical process, involving polyphenol oxidase, catechol oxidase, and other enzymes that create melanins and benzoquinone from natural phenols, resulting in a brown color. In general, enzymatic browning requires exposure to oxygen, for example the browning that occurs when an apple is cut.

Non-enzymatic browning is a chemical process that produces a brown color in foods without the activity of enzymes. The two main forms of nonenzymatic browning are caramelization and the Maillard reaction. The Maillard reaction is a chemical reaction between an amino acid and a reducing sugar, usually requiring the addition of heat. The sugar interacts with the amino acid, producing a variety of odors and flavors. When protein hydrolysates are the protein source it is preferable to avoid conditions which could lead to the formation of excessive Maillard browning products.

The Maillard reaction is affected by the concentration of the initial reactant species, pH, water content, and presence of substances such as humectants and bisulfite. Some physical factors, such as processing and storage temperature, atmospheric oxygen, and packaging during storage can also affect the Maillard reaction in foods. The deleterious effects of nonenzymatic browning include: decreased nutritional value from protein loss, off-flavor development, undesirable color, decreased solubility, texture changes, destruction of vitamins, and increased acidity.

The rate of deterioration of nutritional powders and/or formulations containing hydrolyzed proteins may be determined under accelerated storage conditions through the use of the Arrhenius equation with extrapolation. The accelerated shelf life testing (ASLT) data may be compared with Maillard browning occurring under normal storage conditions (21° C., 35% RH). The rate of deterioration by browning of the nutritional powder and/or nutritional formula samples may be compared with changes in microbiological, physicochemical, and sensory quality during storage to establish the keeping quality of the nutritional powders and nutritional formulas.

Microbiological and physicochemical changes of the nutritional powder and nutritional formula are determined, in part, by the color change of the nutritional powder and nutritional formula. Determination and quantification of the color change of the nutritional powder may be achieved with Hunter Laboratory values L* (lightness-darkness parameter), a* (redness-greenness parameter), and b* (yellowness-blueness parameter). In particular, L* and a* have been shown to provide optimal sensitivity for detecting changes in samples containing hydrolyzed proteins.

The nutritional powder and nutritional formula may comprise Hunter Lab “L”, “a”, and “b” values. The Hunter Lab “L”, “a”, and “b” values of the nutritional powder can be measured by a spectrophotometer, which allows quantitative measurement of the reflection or transmission properties of the formula as a function of wavelength. The Hunter Lab “L”, “a”, and “b” values of the nutritional powder may be the values as disclosed below for the nutritional formula.

(3) Protein Digestibility

The nutritional powder, and the nutritional formula provided by the nutrient delivery system, include a hydrolyzed protein. In some embodiments, the extent of protein hydrolysis can be determined by performing selected analyses after an in vitro gastrointestinal digestion. For example, a nutritional formula can be treated with one or more digestive enzymes (e.g., pepsin, pancreatin amylase, pancreatin protease and/or pancreatin lipase). The digested formula can be centrifuged (e.g., using high-speed centrifugation), and the supernatant analyzed for its molecular weight profile using HPLC. The pellet can be tested for any insoluble proteins, using acid hydrolysis followed by an analysis of the amino acid profile.

The analysis may indicate that the nutritional formula includes a protein median molecular weight of about 700 Da to about 1100 Da. For example, the protein median molecular weight in the nutritional formula may be about 700 Da, 710 Da, 720 Da, 730 Da, 740 Da, 750 Da, 760 Da, 770 Da, 780 Da, 790 Da, 800 Da, 810 Da, 820 Da, 830 Da, 840 Da, 850 Da, 860 Da, 870 Da, 880 Da, 890 Da, 900 Da, 910 Da, 920 Da, 930 Da, 940 Da, 950 Da, 960 Da, 970 Da, 980 Da, 990 Da, 1000 Da, 1010 Da, 1020 Da, 1030 Da, 1040 Da, 1050 Da, 1060 Da, 1070 Da, 1080 Da, 1090 Da, or 1100 Da.

The analysis may indicate that the nutritional formula includes proteins having a molecular weight of greater than 5000 Da, as a percentage of total protein, of about 3% to about 10%. For example, the percentage of proteins having a molecular weight of greater than 5000 Da may be about 3.0%, 3.1%, 3.2%, 3.3%, 3.4%, 3.5%, 3.6%, 3.7%, 3.8%, 3.9%, 4.0%, 4.1%, 4.2%, 4.3%, 4.4%, 4.5%, 4.6%, 4.7%, 4.8%, 4.9%, 5.0%, 5.1%, 5.2%, 5.3%, 5.4%, 5.5%, 5.6%, 5.7%, 5.8%, 5.9%, 6.0%, 6.1%, 6.2%, 6.3%, 6.4%, 6.5%, 6.6%, 6.7%, 6.8%, 6.9%, 7.0%, 7.1%, 7.2%, 7.3%, 7.4%, 7.5%, 7.6%, 7.7%, 7.8%, 7.9%, 8.0%, 8.1%, 8.2%, 8.3%, 8.4%, 8.5%, 8.6%, 8.7%, 8.8%, 8.9%, 9.0%, 9.1%, 9.2%, 9.3%, 9.4%, 9.5%, 9.6%, 9.7%, 9.8%, 9.9%, or 10% as a percentage of total protein.

The analysis may indicate that the nutritional formula includes insoluble protein in an amount of about 1 mg/L to about 600 mg/L. For example, the nutritional formula many include insoluble proteins in an amount of about 1 mg/L, 2 mg/L, 3 mg/L, 4 mg/L, 5 mg/L, 6 mg/L, 7 mg/L, 8 mg/L, 9 mg/L, 10 mg/L, 20 mg/L, 30 mg/L, 40 mg/L, 50 mg/L, 60 mg/L, 70 mg/L, 80 mg/L, 90 mg/L, 100 mg/L, 110 mg/L, 120 mg/L, 130 mg/L, 140 mg/L, 150 mg/L, 160 mg/L, 170 mg/L, 180 mg/L, 190 mg/L, 200 mg/L, 210 mg/L, 220 mg/L, 230 mg/L, 240 mg/L, 250 mg/L, 260 mg/L, 270 mg/L, 280 mg/L, 290 mg/L, 300 mg/L, 310 mg/L, 320 mg/L, 330 mg/L, 340 mg/L, 350 mg/L, 360 mg/L, 370 mg/L, 380 mg/L, 390 mg/L, 400 mg/L, 410 mg/L, 420 mg/L, 430 mg/L, 440 mg/L, 450 mg/L, 460 mg/L, 470 mg/L, 480 mg/L, 490 mg/L, 500 mg/L, 510 mg/L, 520 mg/L, 530 mg/L, 540 mg/L, 550 mg/L, 560 mg/L, 570 mg/L, 580 mg/L, 590 mg/L, or 600 mg/L.

(4) Soluble Protein

The nutritional powder, and the nutritional formula provided by the nutrient delivery system, include a hydrolyzed protein. The amount of soluble protein in the nutritional powder can be determined by performing an HPLC analysis of centrifugation supernatants. For example, powders can be reconstituted at a standard dilution and centrifuged, before and after dilution with a buffer. The preparations can then be syringe-filtered and then protein content determined using HPLC.

The analysis may indicate that the nutritional powder includes soluble protein, as a percentage of total protein, in an amount of about 20% to about 80%. For example, the nutritional powder may include soluble protein in an amount of about 20%, 21%, 22%, 23%, 24%, 25%, 26%, 27%, 28%, 29%, 30%, 31%, 32%, 33%, 34%, 35%, 36%, 37%, 38%, 39%, 40%, 41%, 42%, 43%, 44%, 45%, 46%, 47%, 48%, 49%, 50%, 51%, 52%, 53%, 54%, 55%, 56%, 57%, 58%, 59%, 60%, 61%, 62%, 63%, 64%, 65%, 66%, 67%, 68%, 69%, 70%, 71%, 72%, 73%, 74%, 75%, 76%, 77%, 78%, 79%, or 80%.

### 3. USE OF THE NUTRIENT DELIVERY SYSTEM

The nutrient delivery system, as described above, provides the nutritional formula. The present invention is also directed to a method of producing the nutritional formula. The method may include providing the pod and the nutritional powder described above. The nutritional powder may be positioned within the pod such that the nutritional powder is fully enclosed by the bottom wall, side wall, and lid of the pod. Accordingly, the nutritional powder and the lid may define therebetween the headspace of the pod. As described above, the headspace may include less than about 10% O₂.

The method also includes introducing the fluid into the pod to produce the nutritional formula. Introducing may include the lid receiving the injector or similar device as described above, through which the fluid is delivered into the pod. The fluid may include water. Additionally, the fluid may be introduced into the pod at a suitable temperature, such as a temperature described herein.

The method may further include expelling the nutritional formula from the pod. Expelling may include passing the nutritional formula through the outlet port of the pod and into a container (e.g., bottle, glass, and so forth) from which the subject consumes the nutritional formula.

In some embodiments, the contents of the pod (i.e., the nutritional powder) are intended to be processed (i.e., reconstituted into a liquid product suitable for oral consumption by a subject) within seconds after a hermetic seal of the pod is broken to allow liquid to flow therein, the content to flow therefrom, or a combination thereof. In such embodiments, the pod will typically be a single-use, disposable container. In other embodiments, the pod is sealable or re-sealable and is capable of re-use. In certain embodiments where the pod is sealable or re-sealable, the contents of the pod (i.e., the nutritional powder) may be stored for a short time (typically hours or days) by the consumer prior to reconstituting into a liquid product and the pod may or may not be hermetically sealed at any point.

In some embodiments, any delay between the time the hermetic seal of the pod is disrupted and the initiation time is less than 1 second. In other embodiments, any delay between the time the hermetic seal of the pod is disrupted and the initiation time is less than 2 seconds. In other embodiments, any delay between the time the hermetic seal of the pod is disrupted and the initiation time is less than 3 seconds. In other embodiments, any delay between the time the hermetic seal of the pod is disrupted and the initiation time is less than 4 seconds. In other embodiments, any delay between the time the hermetic seal of the pod is disrupted and the initiation time is less than 5 seconds. In other embodiments, any delay between the time the hermetic seal of the pod is disrupted and the initiation time is within the range of 1 second to 10 seconds. In some embodiments, a delay between the time the hermetic seal of the pod is disrupted and the initiation time is within the range of 1 second to 30 seconds.

In these embodiments, a subject desirably consumes at least one serving of the infant formula per day, and in some embodiments, may consume two, three, or even more servings per day. Each serving is desirably administered as a single undivided dose, although the serving may also be divided into two or more partial or divided servings to be taken at two or more times during the day. The methods of the present disclosure include continuous day after day administration, as well as periodic or limited administration, although continuous day after day administration is generally desirable.

### 4. METHOD OF MANUFACTURING THE NUTRITIONAL POWDER

The nutritional powders may be prepared by any known or otherwise effective technique suitable for making and formulating nutritional powders, variations of which may depend upon variables such as the selected ingredient combination, packaging and container selection, and so forth. Such techniques and variations are described in the nutritional art or are otherwise well known to those skilled in the nutritional art.

Methods of manufacturing nutritional powders typically involve the initial formation of an aqueous slurry containing carbohydrates, proteins, lipids, stabilizers or other formulation aids, vitamins, minerals, or combinations thereof. The slurry is emulsified, pasteurized, homogenized, and cooled. Various other solutions, mixtures, or other materials may be added to the resulting emulsion before, during, or after further processing. The resulting mixture is then heated and dried into powder form, which may be accomplished by spray drying or other heat-treating methods of forming solid particulates in a powder matrix. Other essential or optional materials may also be added to the powder by dry blending, agglomerating, or otherwise combining the added material to the forming or just formed solid particulates.

If dry blending is used as part of the formulation process, the type and amount of dry blended carbohydrates in a nutritional powder may be analyzed. Analysis may be performed using a microscope, by preparing a microscope slide with a sample of the powder and placing the slide under a standard stereoscopic microscope. The different types of particles are visually analyzed in terms of shape, size, color, and transparency, and measurements are recorded. Each different powder particle and test is extracted using infrared vibrational spectroscopy to confirm its identity.

Alternatively or as a complement to the above-described method, analysis may be done by static image analysis by testing a sample of the powder using an image analysis sensor (e.g., Malvern Morphologi G3). The analyzer provides a quantitative characterization of the different powder shapes and sizes.

Alternatively or as a complement to the above-listed methods, analysis may be done by via Differential Scanning calorimetry (DSC). A sample of powder is evaluated using a Differential Scanning calorimeter (e.g., TA Instruments' Q200). The analyzer provides a heat flow thermogram, which can differentiate 100% spray dried powders from partially or 100% dry blended powders from glass transition peaks.

The quantitative measurements from the static image analysis and DSC can be correlated to the different powder particles identified microscopically to calculate the type and amount of dry blended carbohydrates in the powder.

In one embodiment, a suitable manufacturing process may include the preparation of at least three separate slurries: a protein-in-fat (PIF) slurry, a carbohydrate-mineral (CHO-MIN) slurry, and a protein-in-water (PIW) slurry. The PIF slurry may be formed by heating and mixing the oil (e.g., canola oil, corn oil, soy oil, coconut oil, high oleic safflower oil) and then adding an emulsifier (e.g., lecithin), fat soluble vitamins, and a portion of the total protein (e.g., intact pea protein concentrate, milk protein concentrate, whey protein concentrate, nonfat milk) with continued heat and agitation. The CHO-MN slurry may be formed by adding with heated agitation to water: minerals (e.g., potassium citrate, dipotassium phosphate, sodium citrate), trace and ultra trace minerals (TM/UTM premix), thickening or suspending agent. The resulting CHO-MN slurry may be held for 10 minutes with continued heat and agitation before adding additional minerals (e.g., potassium chloride, magnesium carbonate, potassium iodide), and/or carbohydrates (e.g., HMOs, lactose, fructooligosaccharide, sucrose, corn syrup). The PIW slurry may then be formed by mixing with heat and agitation of the remaining protein, if any.

The resulting slurries are then blended together with heated agitation and the pH may be adjusted to the desired range, such as, from 6.6 to 7.5 (including 6.6 to 7), after which the nutritional emulsion is subjected to high-temperature short-time (“HTST”) processing (i.e., about 165° F. (74° C.) for about 16 seconds) or an ultra high temperature (UHT) processing step (i.e., about 292° F. (144° C.) for about 5 seconds). The nutritional emulsion is heat treated, emulsified, homogenized, and cooled during the HTST or UHT process. Water soluble vitamins and ascorbic acid are added (if applicable), the pH is again adjusted (if necessary). The batch is evaporated, heat treated and spray dried. After drying, the powder may be transported to storage hoppers. The base powder may be dry blended with the remaining ingredients to form the nutritional powder. The nutritional powder is then packaged in appropriate containers (i.e., pods, packages containing one or more pods, or kits containing one or more pods) for distribution. Those of skill in the art will understand that standard intermediate manufacturing steps, such as bulk storage, packing in large bags or drums, transport to other locations, etc., may be incorporated as part of this process.

In some embodiments, the nutritional emulsion is dried to form a nutritional powder using any methods known in the art. By way of example, nutritional powders can be manufactured by preparing at least two slurries, which are then mixed, heat treated, standardized, heat treated a second time, evaporated to remove water, and spray dried or dry blended to form a reconstitutable nutritional powder.

One exemplary method of preparing a spray dried nutritional powder suitable for use in the nutritional powder pods disclosed herein comprises forming and homogenizing an aqueous slurry or liquid comprising predigested fat, and optionally protein, carbohydrate, and other sources of fat, and then spray drying the slurry or liquid to produce a spray dried nutritional powder. The method may further comprise the step of spray drying, dry mixing, or otherwise adding additional nutritional ingredients, including any one or more of the ingredients described herein, to the spray dried nutritional powder.

Generally, when the nutritional powder for use in the nutritional powder pod is a spray dried nutritional powder or a dry blended nutritional powder, it may be prepared by any suitable known techniques. For example, the spray drying may include any spray drying technique that is suitable for use in the production of nutritional powders. Many different spray drying methods and techniques are known for use in the nutrition field, all of which are suitable for use in the manufacture of the spray dried nutritional powders herein. Following drying, the finished powder may be packaged into nutritional powder pods.

In other embodiments, the preparation of the nutritional powder comprises an extruded powder. Milling can also be included as a step in preparing the nutritional powder.

In some embodiments, the ingredients of the nutritional powder may be extruded as part of the process of making the nutritional powder. In certain embodiments, the ingredients are incorporated in the extruder hopper in the form of a dry feed or powder premix. The dry nutritional ingredients enter the extruder just after the point of entry of water. In certain embodiments, the water comprises from about 1% to about 80% by weight of the total weight of the water and dry ingredients. The amount of water added to the nutritional composition may be adjusted within the aforementioned ranges based on the desired physical properties of the extrudate. In certain embodiments, the nutritional ingredients may be premixed with water to form a thick emulsion, which is then fed into the extruder hopper in the form of a viscous liquid or sludge. The term “extrudate” refers to all or a portion of a nutritional composition that exits an extruder.

In some embodiments, the extruder used to produce the nutritional powder or extrudate operates in a continuous format. Generally, any extruder known for use in food processing may be utilized. In certain embodiments, extrusion is performed via a screw extruder. Said screw extruder may be a twin screw extruder or a single screw extruder. The extruder screws may consist of shear elements, mixing elements, conveying elements, kneading elements, emulsifying elements, disc elements, or a combination of the above in any interchangeable order. The barrels of the extruder may be steam heated or electrically heated. In certain embodiments, extrusion takes place at a temperature between about 20° C. to about 99° C., from about 30° C. to about 150° C., or from about 70° C. to about 100° C. In certain embodiments, the ingredients are processed in the extruder for about 5 seconds to about 240 seconds or for about 30 seconds to about 180 seconds.

In some embodiments disclosed herein, the extrudate is dried following extrusion so as to remove most or all of the water contained therein. In such embodiments, any conventional drying methods may be used to remove the desired amount of water from the nutritional powder. For example, the nutritional powder extrudate may be dried using a vacuum, convective hot air, a tray dryer, infrared, or any combination of the above. In some embodiments, the nutritional powder extrudate may be further ground or milled to a desired particle size following drying. In some embodiments, additional protein and carbohydrate ingredients may be added to the final nutritional powder in the form of dry ingredients or a dry blend.

In some embodiments, in order to increase or enhance the particle porosity of the nutritional powder, a pressurized gas may be introduced into the nutritional emulsion at a suitable time during the manufacturing process. This pressurized gas may dissolve into the nutritional emulsion during the blending stages if these stages are similarly conducted under pressure. During the spray-drying or extrusion stages, though, the pressure may be reduced, allowing the depressurized gas to bubble out of the particles of nutritional powder that are being formed at this stage. The exiting gas bubbles may leave a greater number of open pores or expanded open pores in the nutritional powder particles.

In some embodiments, after the nutritional powder is packaged into the pod, the pod is sealed and then stored under ambient conditions or under refrigeration for up to 36 months or longer, more typically from about 6 months to about 24 months. In some embodiments, a package is provided containing a plurality of nutritional powder pods. In some embodiments, a package containing a plurality of nutritional powder pods is prepared and stored.

The present invention has multiple aspects, illustrated by the following non-limiting examples.

### 5. EXAMPLES

The compositions used for the following examples are illustrated in Table 3. Composition 1 is further described in Table 4a, while Composition 4 is described in Table 4b.

TABLE 3

| | |
|---|---|
| 1 | Control (milk-based, milk and whey protein) |
| 2 | Milk- and soy-based, milk and whey protein, |
| | and hydrolyzed soy protein (5% DH) |
| 3 | Milk- and soy-based, milk and whey protein, |
| | and soy protein |
| 4 | Soy-based, hydrolyzed soy protein (5% DH) |

TABLE 4a
Amount of ingredient per 1000 lbs product

| | | |
|---|---|---|
| Lactose | 119.72 | lb |
| Non-Fat Dry Milk | 76.59 | lb |
| Whey Protein Concentrate | 44.34 | lb |
| High Oleic Safflower Oil | 42.88 | lb |
| Soy Oil | 32.53 | lb |
| Coconut Oil | 29.70 | lb |
| GOS | 26.16 | lb |
| Potassium Citrate | 2.58 | lb |
| Calcium Carbonate | 1.41 | lb |
| ARA | 1.08 | lb |
| Nucleotide/Choline Premix | 422.48 | g |
| DHA | 238.21 | g |
| Ascorbic Acid | 224.73 | g |
| Vitamin/Mineral Premix | 197.76 | g |
| Lecithin | 188.77 | g |
| Choline Chloride | 179.78 | g |
| Ascorbyl Palmitate | 92.14 | g |
| Vitamin A, D, E, and K premix | 86.74 | g |
| Ferrous Sulfate | 85.40 | g |
| Mixed Carotenoids | 80.00 | g |
| Sodium Chloride | 76.41 | g |
| Magnesium Chloride | 67.42 | g |
| Mixed Tocopherols | 40.90 | g |
| Tricalcium Phosphate | 30.56 | g |
| Potassium Phosphate | 26.97 | g |
| Potassium Chloride | 4.49 | g |
| L-Carnitine | 1.39 | g |
| Riboflavin | 561.81 | mg |

TABLE 4b
Amount of ingredient per 1000 lbs product

| | | |
|---|---|---|
| Corn Syrup | 507.80 | lb |
| Soy Protein Isolate | 146.50 | lb |
| High Oleic Safflower Oil | 114.53 | lb |
| Sucrose | 99.02 | lb |
| Soy Oil | 83.80 | lb |
| Coconut Oil | 77.20 | lb |
| FOS | 16.23 | lb |
| Potassium Citrate | 15.39 | lb |
| Tricalcium Phosphate | 11.65 | lb |
| Calcium Phosphate Dibasic | 6.81 | lb |
| Sodium Chloride | 3.37 | lb |
| ARA | 2.86 | lb |
| Magnesium Chloride | 2.60 | lb |
| L-Methionine | 1.68 | lb |
| Ascorbic Acid | 1.59 | lb |
| Vitamin/Mineral/Taurine Premix | 1.43 | lb |
| DHA | 1.09 | lb |
| Choline Chloride | 230.20 | g |
| Mixed Carotenoid Premix | 225.51 | g |
| Vitamin ADEK Premix | 168.98 | g |
| Ascorbyl Palmitate | 162.24 | g |
| Ferrous Sulfate | 138.37 | g |
| Tocopherol-2 Antioxidant | 71.22 | g |
| Potassium Chloride | 58.98 | g |
| L-Carnitine | 48.98 | g |
| Potassium Iodide | 459.18 | mg |

### Example 1

### Characterization of the Nutritional Powder

The nutritional powder described above was evaluated with regards to the size, surface area and shape of the particles comprising the powder, the porosity, thermal properties, bulk density, flowability, free fat content, and the wettability of the powder.

Particle Size and Shape.

A study was conducted to evaluate the size of the nutritional powder particles, as well as their shape. Following the production of the nutritional powder, samples of said powder were collected and analyzed using laser diffraction. From this analysis, the particle size of the nutritional powder was provided as a distribution of the average particle size. Results are summarized in Table 5.

TABLE 5

| | | | 50% of | |
|---|---|---|---|---|
| | | 10% of | Particles | 90% of |
| | Mean Particle | Particles | Larger or | Particles |
| Compo- | Size | Larger than | Smaller than | Smaller than |
| sition | (μm) | (μm) | (μm) | (μm) |
| 1 | 92 | 15 | 81 | 182 |
| 2 | 59 | 7 | 51 | 123 |
| 3 | 63 | 8 | 55 | 129 |
| 4 | 52 | 14 | 47 | 96 |

The size and shape of the particles may further be examined via image analysis, for example, confocal microscopy and transmission electron microscopy. The particle shape and morphology are also assessed for aspect ratio via the aforementioned techniques. For example, the Malvern Morphologi G3 can be used to measure the size and shape of particles by the technique of static image analysis. There are three essential stages in the measurement process; sample preparation and dispersion (this step is critical to getting good results); spatial separation of individual particles and agglomerates. The Morphologi G3 has an integrated dry powder disperser which makes preparing dry powder samples easy and reproducible. The applied dispersion energy can be precisely controlled, enabling the measurement process to be optimized for a range of material types. Dispersion is achieved without explosively shocking the particles, avoiding damage to fragile particles while ensuring strongly agglomerated materials are dispersed. Effective dispersion of fibers can also be achieved. The instrument captures images of individual particles by scanning the sample underneath the microscope optics, while keeping the particles in focus. The instrument can illuminate the sample from below or above, while accurately controlling the light levels. Additionally, polarizing optics can be used to study birefringent materials.

In summary, these studies determined the size and shape of the nutritional powder particles, which in turn, provides information regarding the wettability and flow properties of the nutritional formula described above. These results demonstrate particle size(s) and shape(s) that provide improved wettability and flow properties relative to a nutritional powder that does not have the same particle size and shape as the nutritional powder disclosed herein.

Particle Surface Area.

In addition to the above examination of the size and shape of the nutritional powder particles, the surface area of the nutritional powder particles is investigated. Samples of the nutritional powder are analyzed via image analysis, for example, confocal microscopy and transmission electron microscopy to yield surface are of said particles. Alternatively, the surface area of the nutritional powder particles may be analyzed according to a Brunauer-Emmett-Teller (BET) multilayer gas adsorption method. In accordance with such methods, “adsorption” is the accumulation of atoms or molecules on the surface of a material. This adsorption is usually described through isotherms, as in, the amount of adsorbate on the adsorbent as a function of its pressure at constant temperature. This accumulation process creates a film of the adsorbate (the molecules or atoms being accumulated) on the surface of the adsorbent. Thus, the BET theory aims to explain the physical adsorption of gas molecules on a solid surface, and serves as the basis for an analysis technique or the measurement of the surface area of a material. Exemplary BET methods include, but are not limited, to those similar to or according to ISO-9277 (Determination of the specific surface area of solid by gas adsorption-BET method). The BET method may be performed on a surface area and porosity analyzer using Krypton (Micromeretics TriStar II 3020).

In summary, these studies determine the surface area of the nutritional powder particles, which provides information regarding the wettability and flowability of the nutritional powder. It is expected that these results demonstrate a particle surface area that provides improved wettability and flowability relative to a nutritional powder that does not have the same particle surface area as the nutritional powder disclosed herein.

Thermal Properties.

Studies were performed to investigate the thermal properties of the nutritional powder. Samples of the nutritional powder were transferred to a differential scanning calorimeter and examined for thermal properties over a temperature range of 0° C. to 120° C. The results are provided in Table 6.

TABLE 6

| Composition | Glass Transition Temperature (° C.) |
|---|---|
| 1 | 52 |
| 2 | 76 |
| 3 | 68 |
| 4 | 78 |

In summary, these studies determined the thermal properties of the nutritional powder, such as the glass transition temperature and melting temperature, which are useful as a comparison for a new product at a standard moisture range.

Porosity.

A study is conducted to examine the porosity of the particles comprised within the nutritional powder. Following the production of the nutritional powder, a sample is analyzed via a non-wetting based method on a porosimeter. Specifically, the method involves the intrusion of a non-wetting liquid (e.g., mercury) at high pressure into the powder. The pore size is based on the external pressure needed to force the liquid into a pore against the opposing force of the liquid's surface tension. The volume of the open pores and interstitial void are then divided by the envelope powder volume. Values for porosity can be provided in units of % (i.e. from 0-100%). Measurement of skim milk powder provides values of 40-75%. One exemplary spray dried infant formula may produce a value of about 57%.

In summary, these studies determine the porosity of the nutritional powder, which in turn, provides information regarding the wettability and flow properties of the nutritional powder and formula. It is expected that these results demonstrate a porosity that provides improved wettability and flow properties relative to a nutritional powder that does not have the same porosity as the nutritional powder disclosed herein.

Wettability.

The wettability of the nutritional powder was also examined. Wettability is defined as the period of time required for 1 teaspoon of powder to settle below the surface of water contained in a glass beaker. Wettability is designed to indirectly measure a powder's hydration characteristics. For example, a small amount of powder is dispersed on the surface of a small beaker of water. Particles which absorb water poorly will remain on top of the water for longer periods of time.

The method is as follows: 100 mL of tap water was added at the appropriate temperature to a glass beaker. The timing device was zeroed. One level teaspoon (˜2.0 grams) of powder was scooped. Holding the scoop over the center top of the beaker, the scoop was turned over and the powder was dropped into the tap water and the timer was started. When all the powder had sunk below the water surface, the timer was stopped. Time was recorded in seconds.

The wettability data indicates improved overall flow performance of the nutritional formula. The results are provided in Table 7.

TABLE 7

| Composition | Wettability (seconds) |
|---|---|
| 1 | 6 |
| 2 | greater than 120 |
| 3 | greater than 120 |
| 4 | greater than 120 |

Flowability.

A study is conducted to evaluate the flowability of the nutritional powder. After the nutritional powder is produced, a sample is transferred to a Brookfield powder flow tester. This instrument provides a flow factor and flow index of the nutritional powder sample.

Alternatively, the flowability index can be calculated by dividing the vibrated bulk density (VBD) by the loose bulk density (LBD), which were determined as described below. These results are summarized in Table 8.

TABLE 8

| Composition | Flowability Index (VBD/LBD) |
|---|---|
| 1 | 1.2 |
| 2 | 1.3 |
| 3 | 1.3 |
| 4 | 1.3 |

Bulk Density.

A study was conducted to investigate the density of the nutritional powder. Samples of the nutritional powder were measured for their bulk densities by specifically examining both loose bulk density and vibrated bulk density. The study was conducted as follows: a calibrated vibrated bulk density cylinder was obtained. The bottom section was labeled with the cylinder's volume. The tare weight of the bottom section of the cylinder was recorded. The top on the cylinder was placed and filled to near overflowing with the sample to be analyzed. A powder funnel may be used to simplify this task. While holding the cylinder over a waste can, the top section was removed. A spatula or the top section of the cylinder was used to strike off the excess sample so that it was smooth and flush with the top of the bottom section. A dry cloth was used to remove any powder clinging to the outside of the bottom section. The bottom section (Gross weight) was weighed.

The vibrated bulk density was calculated by following the sample preparation described in the loose bulk density. Then the cylinder was placed on the vibrated bulk density apparatus making sure it rested against the stop pins. The cylinder was clamped into place. The timer was set and preset for repeatable one minute cycles. This ensured a similar vibration cycle for all samples. After making sure that the vibrator apparatus was set at an amplitude of 5, the vibration cycle was started. When completed, the cylinder was unclamped and removed. While holding it over a waste can, the top section was removed. A spatula or the top section of the cylinder was used to strike off the excess sample so that it was smooth and flush with the top of the bottom section. A dry cloth was used to remove any powder clinging to the outside of the bottom section. The bottom section was weighed.

In summary, both loose and vibrated bulk densities provided information on the nutritional powder, and may be important in the reconstitution of said powder. These results demonstrate powder bulk densities that provide improved wettability and reconstitution characteristics relative to a nutritional powder that does not have the same bulk density as the nutritional powder disclosed herein. The results are provided in Table 9.

TABLE 9

| | Loose Bulk Density LBD | Vibrated Bulk Density VBD |
|---|---|---|
| Composition | (g/cc) | (g/cc) |
| 1 | 0.40 | 0.50 |
| 2 | 0.27 | 0.36 |
| 3 | 0.34 | 0.44 |
| 4 | 0.36 | 0.47 |

Free Fat Content.

A study was performed to analyze the free fat content of the nutritional powder. The determination of fat free content was performed by stirring 2.00 g of nutritional powder in 80 mL of hexane (or another non-polar solvent such as petroleum ether) for 10 minutes, filtering the suspension through Whatman No. 41 paper into a tared beaker, evaporating the solvent at 80° C., and measuring the non-volatile residue gravimetrically.

These results demonstrate a fat free content that provides improved flowability relative to a nutritional powder that does not have the same fat free content as the nutritional powder disclosed herein. The results are provided in Table 10.

TABLE 10

| Composition | Free Fat (%, w/w, of nutritional powder) |
|---|---|
| 1 | 0.37 |
| 2 | 0.89 |
| 3 | 0.49 |
| 4 | 1.91 |

Reconstitution.

Generally, a nutritional powder reconstitution test was used to evaluate how thoroughly the nutritional powder was reconstituted under the operating conditions of a nutrient delivery system, and to determine a corresponding reconstitution rate.

Generally, according to this test, same size portions (e.g., portions of 2-5 g samples) were taken from the same batch of the nutritional powder to be tested. These portions were weighed both before and after drying (various type of drying can be utilized as long as each portion was dried using the same drying method, e.g., conventional drying techniques such as convection or IR can be utilized) to determine the initial moisture content of each portion (i.e., the weight lost to drying). The average initial moisture content (by weight) was determined by averaging the results from the multiple portions.

The weight of a resealable nutritional powder pod was measured both with and without a test sample of the nutritional powder enclosed therein to determine the initial weight of the sample of nutritional powder within the pod. Example amounts of the test samples of the nutritional powder were in the range from 2-150 grams.

The test system was configured to accommodate and operate under the operating conditions of a nutrient delivery system, as follows. The pressure within the pod, as well as the temperature of the water that contacts the nutritional powder and the amount of water flowing through the pod were controlled and measurable. For this test, the pod containing the test sample of the nutritional powder was inserted into the test system, and the system was set to deliver a certain amount of water (e.g., about 25-500 mL) at a certain temperature (e.g., in the range of 5-50° C.) under a certain pressure (e.g., 0.5-15 bar, or approximately 7-217 psia) into and through the pod. Under this test, the ratio of powder weight (grams) to water weight (grams) (where the density of water was taken to be 1 g/mL) was lower than 1:1 (e.g., 1:1.1, 1:1.2, 1:1.3, 1:2, 1:3, 1:5, etc.). In other words, relatively less powder (in grams) was used as compared to the amount (in grams) of water. A sufficiently large collection bottle was placed under the dispenser of the test system to receive the homogeneous liquid product output. The test system was started, and the homogeneous liquid product was collected in the collection bottle. It was intended that the test system may be a working nutrient delivery system operating under the above-specified conditions or a model system configured to simulate a nutrient delivery system and operating under the above-specified conditions.

Rate of Reconstitution:

The rate of reconstitution is determined using the general test method and system described above, except that once the test system is started, aliquots are taken from the collection bottle or sample cups every 5 seconds until the product is fully dispensed. The total weight of reconstituted solids for each aliquot is determined in the same manner described above. The rate of reconstitution is determined by plotting, for each aliquot of liquid product collected, the weight of total reconstituted solids versus the collection time, thereby resulting in a “gram/ml·second” value.

In another embodiment, the reconstitution rate is determined by first turning on the microwave to warm up for 45 minutes. Funnel and tubing are set-up on the pod exit port of the nutrient delivery system, and 12 sample cups were labeled 1-12 accordingly. The nutrient delivery system is started at a water flow rate of 15 mL/second, and collection of the nutritional formula samples commenced as soon as formula entered the cup and is collected for 5 seconds. After 5 seconds, the tubing extending from the exit port is moved to the next cup (e.g., sample cup 2). This is continued until all of the nutritional formula had been dispensed from the nutrient delivery system.

Following completion of the nutrient delivery system run, an empty sample cup is tared, and each sample is weighed and recorded. Sample pads are placed in a microwave balance, and are tared (e.g., wait until the screen shows 0). A sample cup is taken and stirred for 5 seconds with a clean, unused syringe. Next, the syringe is filled with the sample and dispensed back into the cup. The syringe is filled again, and filled to a volume of 2 mL, except for samples 1-4, which are filled with 1 mL of sample. Next, the sample pads are removed from the microwave, and on the fuzzy side of one of the pads, sample is dispensed slowly from the syringe in a circular motion onto the center of the pad and moving outward. The other pad is placed on top of the aforementioned pad (fuzzy side down), and the two pads are pressed together. The pads are placed back into the microwave onto the balance, the microwave door closed, and the start button pressed to begin the process, which beeps and starts printing upon completion of the test. The percentage of total solids is recorded, and this is done for each sample.

All of the sample weights (g) are added up together to get the total weight. The sample weight is multiplied by the total solids (%) to get the sample total solids (g). Next, the sample solid total is multiplied by 1000 to convert the sample total solids to milligrams. Finally, the sample solids total (mg) is divided by the total weight (g) by the sample time (sec) to get the total solids (mg) per total weight (g) per sample time (sec). The results are provided in Table 11.

TABLE 11

| | Reconstitution Rate (mg/g-sec) | | | |
|---|---|---|---|---|
| | | | | Conclusion of |
| Composition | Start of Run | 15 seconds | 30 seconds | Run |
| 1 | 10 | 2.0 | 1.2 | 0.3 |
| 2 | 12 | 0.3 | 0.5 | 0.1 |
| 3 | 10 | 0.5 | 0.0 | 0.0 |
| 4 | 19 | 0.6 | 0.4 | 0.1 |

Reconstituted Yield:

The total solids in the final liquid product is measured using any standard drying technique (e.g., via a forced air oven or microwave drying technique) to remove the water from the final liquid product.

Next, the theoretical total solids content is determined according to the calculation below using an assumption that 100% of nutritional powder from the pod is delivered in the final liquid product.

Theoretical total solids=(total initial weight in grams of the powder sample in the model pod−average initial moisture in grams)/(water delivered in grams+total initial weight in grams of the powder sample in the model pod).

Finally, the reconstituted yield, which is the amount of reconstituted powder in the final liquid product is determined by dividing the final liquid product total solids by the theoretical solids (i.e., reconstituted yield=final liquid product total solids/theoretical total solids). The reconstituted yield is reported as a number (e.g., 0.XX or as a percentage, e.g., XX %).

In another embodiment, reconstitution yield was determined by running the nutrient delivery system with a water flow rate of 120 mL over 5 seconds and allowing the pod to remain within the system. One large sample cup was labeled with the run number, and a collection beaker or funnel was placed under the exit valve with the tubing set-up. Next, the accumulator was filled with approximately 120 mL of water and the nutrient delivery system was run again, with the original pod remaining within. The rinse water sample was collected within the sample cup. Similar to above in the reconstitution rate analysis, an empty sample cup was tared on a balance, and the rinse water sample weighed. In addition and like recited above, the steps used to determine total solids via microwave/pad analysis were used for the rinse water sample; however, 5 ml of sample was used relative to the smaller volumes listed above.

Then the percentage of total solids of the rinse water was multiplied by the grams of rinse water to get the grams of total solids of the rinse water. Next, the grams of total solids of the rinse water were divided by the percentage of total solids of the powder to get the grams of powder remaining in the pod. The grams of powder remaining in the pod were divided by the grams of powder put into the pod to get the ratio of powder remaining in the pod relative to powder put in the pod. Finally, the ratio of powder remaining in the pod relative to powder put in the pod was subtracted from 1 and multiplied by 100 to get the percentage of powder reconstituted. The results are provided in Table 12.

TABLE 12

Reconstitution

| Composition | Time (seconds) | Yield (%) |
|---|---|---|
| 1 | 40 | 98.5 |
| 2 | 45 | 99.4 |
| 3 | 35 | 98.5 |
| 4 | 40 | 99.6 |

Spectral Properties.

A study is conducted to evaluate the spectral properties of the nutritional powder. The spectral characterization is assessed by transferring a sample of the nutritional powder to a spectrophotometer and measuring the Hunter L, a and b values. These values are dependent on the wettability, emulsion stability, and emulsion homogeneity of the nutritional formula, and indicate the lightness and color-opponent dimension of the nutritional formula.

Determination of Soluble Protein.

A study was performed to analyze the soluble protein content of the nutritional powder as a percent of total protein. The soluble protein content was analyzed by reconstituting the powders at a standard dilution, and then centrifuging before and after dilution in a buffer such as 0.05M KH₂PO₄, pH 2.9, or such as 0.05M NaH₂PO₄, 0.15M NaCl, pH 7.5. The preparations were then syringe-filtered through a 0.45 μm membrane prior to protein determination by reversed phase HPLC or by size exclusion HPLC. The soluble protein concentrations were reported as a percentage of total protein. The results of these studies are shown in Table 13.

TABLE 13

| Composition | Soluble Protein (% of Total Protein) |
|---|---|
| 1 | 51 |
| 2 | 50 |
| 3 | 46 |
| 4 | 53 |

### Example 2

### Characterization of the Nutritional Formula

The nutritional formula described above was evaluated with regards to foaming, gas entrapment/entrainment or density, viscosity, spectral properties, dispersibility and emulsion stability.

Dispersibility.

A study was conducted to investigate the dispersibility of the nutritional formula. Following the production of the nutritional formula by a mechanical shaker, a sample was removed from and immediately poured through an 80 mesh screen. The receiving flask was filled approximately ¼ full with tap water to dislodge any particles that may remain in the flask, and poured through the screen. The screen was not rinsed with tap water. The particles remaining on the screen were rated using scaled photographs. If one lump that is 0.5 inch or greater remains on the screen, repeat the test. Each sample was tested in duplicate, and the average reported as the final result. Because the precision of the method is limited by the capability of the subjective rating, duplicate measurement was required. Results are presented in Table 14.

TABLE 14

Hydration/Solubility

| Composition | Dispersibility Subjective | 80 Mesh |
|---|---|---|
| 1 | 2 | 1 |
| 2 | 3.5 | 4 |
| 3 | 2.5 | 4 |
| 4 | 5 | 1 |

In an additional experiment, the dispersibility of the nutritional formula was measured by the “80 Mesh Determination of Infant Formulas,” which describes the firmness and solubility of particles from the gel, sediment, and creaming within a product. This evaluation attempts to identify what product defects may lead to a clogged nipple.

This experiment employed either a 3″ U.S. Standard 80 mesh sieve, a 5″ U.S. Standard 80 mesh sieve, or a 8″ U.S. Standard 80 mesh sieve. The 5″ or 8″ sieve was used for samples in containers 11 oz. or greater. The 3″ sieve was used for samples in containers 8 oz. or smaller.

A flow of tap water was adjusted to a temperature of 110° F. The sieve was held over the sink and the sample (nutritional formula) was poured through the sieve. The sample container was then filled with water to rinse and poured through the sieve again. The water flow was fanned with an empty hand and the sieve rinsed for 20 seconds for samples that were a concentrated liquid, and rinsed for 3 seconds for sample that were ready-to-feed samples. The remaining particles on the screen were given a value of 1-6 using the following scale: 1—No particles; 2—First evidence of very small particles to a slight amount of small particles with a maximum size of approximately 1.0 mm; 3—Slight amount of small particles with a few moderate size particles; 4—Moderate amount of medium sized particles with a moderate amount of small particles; 5—A heavy amount of varying sized particles covering most of the sieve screen; 6—An excessive amount of any sized particles which cover the entire sieve screen and may plug the screen openings.

In another embodiment, the dispersibility of the nutritional formula was measured using a mesh sieve. For example, the nutritional formula was provided by the nutrient delivery system and poured through an 8 inch, 80 mesh sieve. Next, 100 mL of slightly warm water was added to the sample container and gently swirled. The residual rinse was also passed through the 80 mesh sieve, ensuring that the pour was distributed thoroughly over the area of the sieve. The total number of particles present on the sieve were measured using a mm stick and/or ruler. The size of the particles was stratified into groups consisting of less than 1 mm, 1 mm, 2 mm, 3 mm, 4 mm, 5 mm and greater than 5 mm.

In another embodiment, dispersibility of the nutritional formula may be assessed after the nutritional powder is reconstituted via hand shaking. First, a tape was placed along a bench and/or table, which was used to mark the distance of the shake. The amount of powder was weighed to provide approximately an 8 oz serving, and the water bath was set to approximately 105° F. to 110° F. An amount of 210 mL of heated water was placed into an Avent baby bottle, and the preweighed powder was placed into the baby bottle. The baby bottle was capped, and the Metronome application was set to 242. Next, the baby bottle was held horizontally beside one end of the tape, a stop watch was started, and the baby bottle vigorously moved back and forth horizontally along the distance of the tape for 10 seconds. This distance and time roughly corresponds to a 40 count by Metronome beat. After this period of bottle shaking, the bottle cap was immediately removed and the contents poured through an 80 mesh sieve. The baby bottle was rinsed slightly, in order to remove any foam or clumps, and the rinse fluid poured through an 80 mesh sieve. Similar to above, the number and size of particles covering the surface of the sieve were measured and recorded. The size of the particles was stratified into groups consisting of less than 1 mm, 1 mm, 2 mm, 3 mm, 4 mm, 5 mm and greater than 5 mm.

The dispersibility indicates an improved flow formula relative to a nutritional formula lacking one or more of the components in the amounts described above. The results are provided in Table 15.

TABLE 15

| | | | | Hand Consumer | | |
|---|---|---|---|---|---|---|
| | Appliance Testing | | | Shake Testing | | |
| | Dispersibility - Quantitative | | | Dispersibility - Quantitative | | |
| Composition | ≦1 mm | 2-4 mm | ≧5 mm | ≦1 mm | 2-4 mm | ≧5 mm |
| 1 | 7 | 4 | 0 | 4 | 5 | 1 |
| 2 | 0 | 10 | 16 | 7 | 9 | 0 |
| 3 | 39 | 45 | 4 | 49 | 16 | 0 |
| 4 | 137 | 74 | 15 | 95 | 68 | 12 |

Foaming.

A study was conducted to evaluate the foaming of the nutritional formula described above. As the nutrient delivery system provides the nutritional formula at a water flow rate of 5 mL/second, the nutritional formula was captured within a graduated cylinder. The total volume of foam and liquid (mL) in the cylinder was measured at 0 minutes, 15 minutes and 30 minutes after being dispensed from the nutrient delivery system. Foaming is indicated by a number of different parameters, such as: total foam volume measured at the aforementioned listed intervals, and foaming ratio of the initial volume divided by the volume at the variable time points listed above. The foam ratio describes the foam dissipation over a variable time interval for a sample.

In another embodiment, the foaming procedure was performed by providing the nutritional formula from the nutrient delivery system, and immediately pouring the nutritional formula slowly down the side of a slightly tilted 250 mL graduated cylinder. Near the end of the pour, the container used to capture the nutritional formula was swirled and any remaining foam was transferred into the 250 mL graduated cylinder. The cylinder was set upright to determine where the layer of foam begins and ends. A flashlight may be used if necessary. The divisions on the cylinder that encompass the foam layer were counted and recorded, which was referred to as the initial time point. The foam layer was observed again at 15 minutes and 30 minutes, and the amount of foam at each time point was recorded in the manner as described above. It should be noted that as the foam dissipates there may be pockets of foam and/or bubbles clinging to the side of the cylinder. Only foam that was dense and was part of the bulk layer was counted towards the foam volume.

In another embodiment, foaming procedure was performed by providing the nutritional formula by reconstituting the nutritional powder via hand shaking. First, a tape was placed along a bench and/or table, which was used to mark the distance of the shake. The amount of powder was weighed to provide an 8 oz serving, and the water bath was set to approximately 105° F. to 110° F. An amount of 210 mL of heated water was placed into an Avent baby bottle, and the preweighed powder was placed into the baby bottle. The baby bottle was capped, and the Metronome application was set to 242. Next, the baby bottle was held horizontally beside one end of the tape, a stop watch was started, and the baby bottle vigorously moved back and forth horizontally along the distance of the tape for 10 seconds. This distance and time roughly corresponds to a 40 count by Metronome beat. After this period of bottle shaking, the bottle cap was immediately removed and the contents were immediately poured slowly down the side of a slightly tilted 250 mL graduated cylinder. Near the end of the pour, the container used to capture the nutritional formula was swirled and any remaining foam was transferred into the 250 mL graduated cylinder. The cylinder was set upright to determine where the layer of foam begins and ends. A flashlight may be used if necessary. The divisions on the cylinder that encompass the foam layer were counted and recorded, which was referred to as the initial time point. The foam layer was observed again at 15 minutes and 30 minutes, and the amount of foam at each time point was recorded in the manner as described above. It should be noted that as the foam dissipates there may be pockets of foam and/or bubbles clinging to the side of the cylinder. Only foam that was dense and was part of the bulk layer was counted towards the foam volume.

The nutritional formula displays reduced foaming relative to a nutritional formula lacking one or more of the components in the amounts described above. This reduced foaming, in turn, provides a decrease in negative side effects associated with foaming, e.g., gassiness, thereby providing an improved overall quality in the experience of consuming the nutritional formula described herein. The results are provided in Tables 16 and 17.

TABLE 16

| | Appliance Testing - Foam | | | | |
|---|---|---|---|---|---|
| | | | 30 | | Foamability |
| | Initial | 15 minutes | minutes | Entrained | (Ratio of |
| Composition | (mL) | (mL) | (mL) | Air (%) | Foam to Air) |
| 1 | 16 | 14 | 14 | 5 | 3 |
| 2 | 20 | 20 | 16 | 8 | 3 |
| 3 | 22 | 18 | 16 | 7 | 3 |
| 4 | 18 | 18 | 17 | 4 | 4 |

TABLE 17

| | Hand Consumer Shake Testing - Foam | | | | |
|---|---|---|---|---|---|
| | | | 30 | | Foamability |
| | Initial | 15 minutes | minutes | Entrained | (Ratio of |
| Composition | (mL) | (mL) | (mL) | Air (%) | Foam to Air) |
| 1 | 60 | 48 | 46 | 20 | 3 |
| 2 | 54 | 50 | 48 | 21 | 3 |
| 3 | 56 | 47 | 46 | 18 | 3 |
| 4 | 38 | 32 | 18 | 18 | 2 |

Gas Entrapment/Density.

A study was conducted to evaluate and compare the density of the nutritional formula. Specifically, once the nutritional formula was prepared using a mechanical shaker, and the density was assessed using an automated density meter (Mettler Toledo DE51). The results are presented in Tables 16 and 17.

In some embodiments, in order to determine if entrapped air is responsible for any difference in formula density (relative to a nutritional formula lacking one or more of the components in the amounts described above), a subset of samples may be transferred to a Buchner flask, with a stir bar, and sealed with a rubber stopper. The samples are placed under vacuum (˜25 in. Hg) for approximately 2 hours to remove air from product. Density measurements, as described above, are then repeated for degassed samples. Alternatively, samples may be degassed via centrifugation.

In another embodiment, entrapped/entrained air was measured using a PAPEC Squeezer. A compression piston full was removed to the end of a sample tube, and rotated one revolution. The sample, which was prepared using the nutrient delivery system using a water flow rate of 5 mL/second, was poured into the tube and the tube filled up to the beginning of the threaded area at the top of the tube, which was approximately 240 mL. The screw on the cap was replaced, and the bleed valve was confirmed to be open (e.g., arrows are pointing up and down). Next, the tube was slightly tilted with the brass bleed valve at the top, and the compression piston turned clockwise to dispel the air pocket. When bubbles appeared out of the bleed valve, the bleed valve was stopped and closed (e.g., arrows are horizontal). The compression piston was rotated clockwise, while counting the turns (e.g., 1 turn=360°) and fraction of turns, until the fluid rises to the back score mark on the pressure indicating tube. The number of turns was recorded, including the fraction of turns. Finally, the percentage of entrained air was calculated using the following formula:

Entrapped/Entrained Air=(total turns including fraction of turns)−0.5*2.2 (1)

The entrained air measurements provide information regarding the flow characteristics of the nutritional formula as well as information regarding any side effects that may be associated with consumption of the nutritional formula. The nutritional formula has an air entrainment that promotes positive side effects and negates negative side effects arising from the consumption of nutritional formulas that lack one or more of the components in the amounts described above.

Viscosity.

A study is conducted to investigate the viscosity of the nutritional formula. The nutritional formula is provided by a mechanical shaker. The viscosity is assessed by transferring a sample of the nutritional formula to a rheometer and measuring the viscosity of said formula.

In summary, the viscosity provides information regarding the overall flow performance of the nutritional formula. The measured viscosity indicates an improved flow performance of the nutritional formula relative to a nutritional formula lacking one or more of the components in the amounts described above.

Spectral Properties.

A study is conducted to evaluate the spectral properties of the nutritional formula. Once the nutritional formula is provided by a mechanical shaker, the spectral properties are assessed by transferring a sample of the nutritional formula to a spectrophotometer and measuring the Hunter L, a and b values. These values are dependent on the wettability, emulsion stability, and emulsion homogeneity of the nutritional formula, and indicate the lightness and color-opponent dimension of the nutritional formula.

The Hunter L, a, and b values of the nutritional formula are improved relative to a nutritional formula lacking one or more of the components in the amounts described above.

Emulsion stability.

A study is conducted to evaluate the stability of the emulsions within the nutritional formula. The nutritional formula is provided by a mechanical shaker, hand shaking, or a nutrient delivery system.

Specifically, the nutritional formula is analyzed for emulsion size using laser diffraction, wherein a refractive index of 1.462 is used for the dispersed phase and 1.332 is used for the continuous phase (water). Emulsion particle size within the nutritional formula is provided as a distribution of the average particle size. Particle size of the emulsion is measured at variable time points post production of the nutritional formula.

It is expected that the nutritional formula exhibits an improved emulsion stability relative to a nutritional formula lacking one or more of the components in the amounts described above.

Digestible Protein.

A study was conducted to evaluate the digestibility of the proteins, by determining protein digestion indicators after a gastrointestinal digestion procedure. The digestion indicators were evaluated by first adjusting the pH of a nutritional formula (e.g., about 40 mL) to pH 4.5 using an acid (e.g., HCl). To this solution was added USP pepsin (e.g., 1.00 mL of a 56 mg/mL solution), and the mixture was stirred at room temperature for about one hour. Then a solution of USP pancreatin amylase/protease and USP pancreatin lipase (e.g., 4.00 mL of 6.94 mg/mL solutions in water) was added, and the mixture was stirred at room temperature for about two hours. The digests were then centrifuged (e.g., at about 31,000×g, at about 20° C., for about 4 hours). The supernatant was then analyzed by HPLC to determine its molecular weight profile. The pellet was tested for insoluble protein using acid hydrolysis and amino acid profile analysis. The digestible protein, as a percentage of total protein, was determined, in which the digested protein was the protein in the supernatant (i.e., not in the centrifugation pellet). Specifically, digestible protein (% of total proteins)=[(total protein−insoluble protein)/total protein]×100%. Additionally, the total protein was 10.6 g per 100 g of nutritional powder. The results of these studies are shown in Tables 18 and 19.

TABLE 18

| | | Digested | |
|---|---|---|---|
| | Digested Protein | Protein >5000 | Insoluble Protein |
| | MW Median | Daltons (% of | after Digestion (g |
| Composition | (Daltons) | total protein) | per 100 g powder) |
| 1 | 1792 | 23.1% | 0.35 |
| 2 | 1576 | 14.5% | 0.37 |
| 3 | 1496 | 12.3% | 0.23 |
| 4 | 1155 | 6.1% | 2.5 |

TABLE 19

| Composition | Digestible Protein (% of Total Protein) |
|---|---|
| 1 | 97% |
| 2 | 97% |
| 3 | 98% |
| 4 | 81% |

Iron Solubility.

A study is conducted to evaluate the soluble iron in the nutritional formula. Specifically, a colorimetric determination of iron in the supernatant obtained after simulated gastric (i.e., pepsin) and intestinal (i.e., pancreatin) digestions is performed.

For the simulated digestions, the pH of a nutritional formula (e.g., about 40 mL) is adjusted to pH 4.5 using an acid (e.g., HCl) or the nutritional formula may be diluted in USP simulated gastric fluid. To this suspension is added USP pepsin (e.g., 1.00 mL of a 56 mg/mL solution), and the mixture is stirred at room temperature for about one hour. Then the pH is adjusted to 7.5 with 0.5M NaHCO₃, a solution of USP pancreatin amylase/protease and USP pancreatin lipase (e.g., 4.00 mL of 6.94 mg/mL solutions in water) is added, and the mixture is stirred at room temperature for about two hours. The digests are then centrifuged (e.g., at about 31,000×g, at about 20° C., for about 4 hours).

The supernatant iron is then determined by colorimetric assay using a complexing agent sold under the name FERROZINE. A 2 ml aliquot of the supernatant is pipetted into a 1-dram vial and to this is added 1.00 ml freshly prepared Test Buffer (i.e., 0.60 M Na acetate, pH4.5, containing hydroxylamine hydrochloride at 8.0% (w/v). A 2.00 ml aliquot of a reagent blank supernatant is diluted in the same manner in order to quantify the soluble iron contribution from reagents.

Additionally, a series of iron standard solutions are prepared in Milli-Q Plus water from a ferrous sulfate heptahydrate reference material. A 1.00 ml aliquot of each iron standard solution is pipetted into a respective 1-dram vial, and to each vial, 1.00 ml test buffer is added.

Into each 1-dram vial, that is the sample digest, digest reagent blank, Milli-Q Plus water blank, and iron standard solutions, 50 μl of freshly prepared colorimetric solution (at 0.85%, w/v) of the complexing agent sold under the name FERROZINE (i.e., 8.5 mg of 3-(2-pyridyl)-5,6-diphenyl-1,2,4-triazine-4′,4″-disulfonic acid, monosodium salt, dissolved in 1.00 ml of Test Buffer) is added. Thirty minutes after addition of the colorimetric solution, the visible light absorbance at 562 nm, vs. Milli-Q Plus water, is measured with a spectrophotometer. A calibration curve of absorbance v. iron concentration is plotted and the iron concentration in the sample digest is calculated (after subtraction of the reagent blank absorbance contribution) by linear regression from the calibration curve. The iron concentration determined for the sample digest is the soluble iron concentration.

It is expected that the nutritional formula exhibits an improved iron solubility relative to a nutritional formula lacking one or more of the components in the amounts described above.

Zinc Solubility.

A study is conducted to evaluate the soluble zinc in the nutritional formula. Specifically, determination of zinc in the supernatant obtained after simulated gastric (i.e., pepsin) and intestinal (i.e., pancreatin) digestions is performed.

For the simulated digestions, the pH of a nutritional formula (e.g., about 40 mL) is adjusted to pH 4.5 using an acid (e.g., HCl) or the nutritional formula may be diluted in USP simulated gastric fluid. To this suspension is added USP pepsin (e.g., 1.00 mL of a 56 mg/mL solution), and the mixture is stirred at room temperature for about one hour. Then the pH is adjusted to 7.5 with 0.5M NaHCO₃, a solution of USP pancreatin amylase/protease and USP pancreatin lipase (e.g., 4.00 mL of 6.94 mg/mL solutions in water) is added, and the mixture is stirred at room temperature for about two hours. The digests are then centrifuged (e.g., at about 31,000×g, at about 20° C., for about 4 hours).

The supernatant zinc is then determined by Atomic Absorption (AA) Spectroscopy or by Inductively Coupled Plasma (ICP) Spectroscopy. An aliquot of a reagent blank supernatant is also prepared in order to quantify the soluble zinc concentration from reagents. Additionally, a series of zinc standard solutions are prepared.

A calibration curve is plotted using the measurements from the zinc standard solutions and the zinc concentration in the sample digest is calculated by linear regression from the calibration curve. The zinc concentration determined for the sample digest is the soluble zinc concentration.

It is expected that the nutritional formula exhibits an improved zinc solubility relative to a nutritional formula lacking one or more of the components in the amounts described above.

Other Properties.

The following additional properties were measured and results are summarized in Table 20: water activity, and moisture (%).

TABLE 20

| Composition | Water Activity | Moisture (%) |
|---|---|---|
| 1 | 0.20 | 2.8 |
| 2 | 0.12 | 1.6 |
| 3 | 0.14 | 1.9 |
| 4 | 0.11 | 1.6 |

It is understood that the foregoing detailed description and accompanying examples are merely illustrative and are not to be taken as limitations upon the scope of the invention, which is defined solely by the appended claims and their equivalents.

Various changes and modifications to the disclosed embodiments will be apparent to those skilled in the art. Such changes and modifications, including without limitation those relating to the chemical structures, substituents, derivatives, intermediates, syntheses, compositions, formulations, or methods of use of the invention, may be made without departing from the spirit and scope thereof.

1. A nutrient delivery system comprising
(a) a pod and
(b) an nutritional powder comprising
(i) about 10 micrograms to about 2000 micrograms of one or more isoflavones per gram of the nutritional powder;
(ii) about 1 milligram to about 1000 milligrams of one or more phytosterols per 100 gram of the nutritional powder; and
(iii) about 0.0 milligrams to about 10.0 milligrams of one or more polyphenols per gram of the nutritional powder,
wherein the nutrient delivery system provides a nutritional formula that delivers zinc, iron, or a combination thereof to an infant upon ingestion of the nutritional formula by the infant.

2. The system of claim 1, wherein the one or more isoflavones are selected from the group consisting of: daidzein, daidzin, malonyl-daidzin, acetyl-daidzin, genistein, genistin, malonyl-genistein, glycitein, glycitin, malonyl-glycitin, acetyl-glycitin, and any combination thereof.

3. The system of claim 2, wherein the one or more isoflavones comprises about 5% to about 50% daidzein, about 1% to about 50% glycitein, about 10% to about 90% genistein, or any combination thereof.

4. The system of claim 1, wherein the one or more phytosterols are selected from the group consisting of: β-sitosterol, campesterol, stigmasterol, brassicasterol, δ5-avenasterol, and any combination thereof.

5. The system of claim 4, wherein the one or more phytosterols comprises about 10% to about 80% β-sitosterol, about 5% to about 50% campesterol, about 5% to about 50% stigmasterol, about 1% to about 30% brassicasterol, about 1% to about 30% δ5-avenasterol, or any combination thereof.

6. The system of claim 1, wherein the one or more polyphenols are selected from the group consisting of: soy protein isoflavones, cocoa powder polyphenols, green tea catechins, plum polyphenols, and any combination thereof.

7. The system of claim 1, wherein a source of the one or more isoflavones, one or more phytosterols, and one or more polyphenols is protein selected from the group consisting of: pea protein, soy protein, rice protein, hemp protein, potato protein, and any combination thereof.

8. (canceled)

9. (canceled)

10. (canceled)

11. (canceled)

12. (canceled)

13. (canceled)

14. (canceled)

15. The system of claim 7, wherein the protein is pea protein and wherein the nutritional formula delivers about 1 mg/100 kcal to about 5 mg/100 kcal iron to the infant.

16. The system of claim 7, wherein the protein is rice protein and wherein the nutritional formula delivers about 0.5 mg/100 kcal to about 5 mg/100 kcal zinc to the infant.

17. The system of claim 7, wherein the source further comprises an oil selected from the group consisting of: canola oil, soybean oil, vegetable oil, safflower oil, sunflower oil, palm oil, and any combination thereof.

18. (canceled)

19. The system of claim 1, wherein the nutritional powder is located within the pod.

20. The system of claim 19, wherein the nutritional powder is located within the pod such that a headspace between the nutritional powder and a lid of the pod includes less than about 10% oxygen (O₂).

21. The system of claim 1, wherein the nutritional formula is a synthetic formula for ingestion by the infant.

22. A pod comprising
(a) a container body and a lid; and
(b) a nutritional powder comprising
(i) about 1 wt. % to about 85 wt. % protein by weight of the nutritional powder, wherein the protein is selected from the group consisting of pea protein, soy protein, rice protein, hemp protein, potato protein, and any combination thereof,
wherein the nutritional powder and the lid define therebetween a headspace of the pod, and
wherein the headspace includes less than about 10% oxygen (O₂).

23. The pod of claim 22, wherein the protein is pea protein and wherein the pea protein binds about 1 mg to about 200 mg iron per gram pea protein.

24. The pod of claim 22, wherein the protein is rice protein and wherein the rice protein binds about 1 mg to about 170 mg zinc per gram rice protein.

25. (canceled)

26. (canceled)

27. The pod of claim 22, wherein the protein is a source of one or more isoflavones, one or more phytosterols, one or more polyphenols, or any combination thereof.

28. (canceled)

29. (canceled)

30. (canceled)

31. The pod of claim 22, wherein the container body comprises a bottom wall and a side wall, and wherein the nutritional powder is positioned within the pod such that the nutritional powder is fully enclosed by the bottom wall, side wall, and lid.

32. A method for producing a synthetic formula for consumption by an infant, the method comprising:
(a) providing the pod of claim 22;
(b) introducing a fluid into the pod, thereby producing the synthetic formula; and
(c) expelling the synthetic formula from the pod.

33. The method of claim 32, wherein the fluid comprises water.
